(19) United States
(12) Patent Application Publication
(10) Pub. No.: US 2010/0231670 A1
(43) Pub. Date: Sep. 16, 2010

(54) SET FOR INK JET RECORDING, AND INK JET RECORDING METHOD

(75) Inventors: Yoshimitsu Arai, Fujinomiya-shi (JP); Ryoichi Nakano, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 12/161,767

(22) PCT Filed: Jan. 10, 2007
(86) PCT No.: PCT/JP2007/050540

§ 371 Date: Jul. 22, 2008

(30) Foreign Application Priority Data
Feb. 2, 2006 (JP) 2006-026262

(51) Int. Cl. B41J 2/17; B41M 5/00; B41M 5/50; B41M 5/52; C09D 11/02

(52) U.S. Cl. 347/100; 428/32.1; 428/32.34; 428/32.35; 428/32.3; 428/32.32

(57) ABSTRACT

A set for ink jet recording comprising an ink jet recording medium containing a water-soluble aluminum compound and a sulfoxide compound in an ink receiving layer on a support, and an ink containing a coloring matter represented by the following formula (I), and an ink jet recording method using the same:

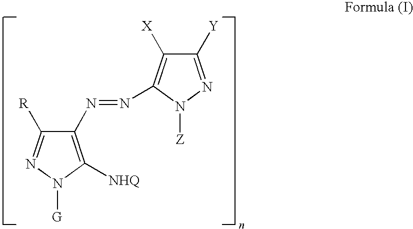

wherein G is a heterocyclic group; n is an integer of 1 to 3; when n is 1, R, X, Y, Z, Q and G each represent a monovalent group; when n is 2, R, X, Y, Z, Q and G each represent a monovalent or divalent substituent, and at least one of them is a divalent substituent; and, when n is 3, R, X, Y, Z, Q and G each represent a monovalent, divalent or trivalent substituent, and at least two of them are a divalent substituent, or at least one of them represents a trivalent substituent.

### TECHNICAL FIELD

The invention relates to a set for ink jet recording which can form an image excellent in ozone resistance, and an ink jet recording method using the same.

### BACKGROUND ART

In recent years, materials for forming, in particular, color images are predominantly used as image recording materials, and, specifically, ink jet recording materials, heat-sensitive transfer-type image recording materials, recording materials using an electrophotographic method, transfer-method silver halide photosensitive materials, printing ink, and recording pens are frequently utilized.

In these color image recording materials, in order to reproduce or record a full color image, three primary color coloring matters (dyes or pigments) are used according to the subtractive mixture method of color stimuli; however, under current circumstances, there is no fast coloring matter which has an absorption property capable of realizing a preferable color reproducing region and can stand various use conditions, and improvements are strongly desired.

Since material costs are low, high speed recording is possible, noise when recording is low, and color recording is easy, the ink jet recording method has been rapidly spreading, and is further being developed.

As ink jet recording methods, a continuous method exists by which droplets are continuously flown, and an on-demand method exists by which droplets are flown according to an image information signal and, as a discharging method therefor, a method of discharging droplets by applying pressure with a piezoelectric element, a method of discharging droplets by generating air bubbles in an ink with heat, a method of using ultrasound, and a method of suction-discharging droplets with an electrostatic force exist. Further, as an ink for ink jet recording, an aqueous ink, an oil-based ink, a solid (melt-type) ink or the like are used.

A coloring agent used in such an ink jet recording ink is required to have better solubility or dispersity in a solvent, allow for high concentration recording, have a better hue, remain fast with respect to light, heat, or active gases (oxidizing gases such as NOx, ozone and the like, or SOx and the like.) in the environment, have excellent fastness with respect to water or chemicals, have better fixability on an image receiving material and be difficult to blur, be excellent in retainability as an ink, have no toxicity, have high purity and, further, to be available at low cost. However, it is extremely difficult to find a coloring agent which satisfies these requirements at a high level. Particularly, it is strongly desired that a coloring agent has a better hue of the three primary colors, remains fast with respect to light, humidity and heat, and remains fast with respect to an oxidizing gas such as ozone in the environment upon printing on an image receiving material having an ink receiving layer.

Conventionally, as a magenta dye, an azo dye using phenol, naphthol or aniline as a coupling component has been widely used. An azo dye having a better hue is known (for example, see Japanese Patent Application Laid-Open (JP-A) No. 11-209673 and Japanese Patent No. 3020660); however, the dye has a problem in that it is inferior in light fastness. As a dye for improving this, a dye having a better hue and improved light fastness has been recently disclosed (see JP-A No. 2001-335714). However, the dyes disclosed in these patents are all extremely insufficient in fastness with respect to an oxidizing gas such as ozone.

As a cyan dye, a phthalocyanine dye and a triphenylmethane dye are representative examples. Representative examples of a phthalocyanine-based dye which is most widely utilized are C.I. Direct Blue 86, C.I. Direct Blue 87, and C.I. Direct Blue 199, which have the characteristic that they are excellent in light resistance as compared with magenta and yellow dyes; however, discoloration or fading due to oxidizing gases such as nitrogen oxide gas and ozone, which are often raised now as environmental issues, is remarkable.

Hitherto, there have been reports of phthalocyanine-based dyes to which ozone gas resistance is imparted (see JP-A No. 3-103484, JP-A No. 4-39365, and JP-A No. 2000-303009); however, these are all extremely insufficient in terms of the effect of improving oxidizing gas fastness, and further improvement is desired.

On the other hand, while a triphenylmethane-based dye, a representative example of which is Acid Blue 9, is better in a hue, it is remarkably inferior in light resistance and ozone gas resistance.

As a yellow dye, an azobenzene-based dye, representative examples of which are Direct Yellow 86, and Direct Yellow 120, a pyrazoloneazo dye such as Acid Yellow 17, and a heterocyclic azo dye such as a pyridoneazo dye have been used. In addition, a quinophtharone-based dye has been frequently proposed. However, in these dyes which are conventionally known, dyes which are better in hue and which, in particularly, tail off on the long wavelength side of an absorption spectrum, such as a quinophtharone dye, are not fast with respect to ozone and light in many cases, an azobenzene-based dye is fast, but is worse in terms of tailing off on the long wavelength side, and thus, currently there are no dyes which have both hue and fastness.

In order to obtain a full color image which is excellent in color reproductivity and is fast, dyes constituting an image are required to have the following requirements:

Respective dyes of the three primary colors have excellent absorbing property

An optimal combination of dyes of three primary colors which realize a wide color reproducing region is achieved

Respective dyes of the three primary colors have high fastness

Deterioration in fastness due to interaction between dyes is not generated

Fastnesses of the dyes of the three primary colors are balanced

However, regarding fastness and, particularly, fastness with respect to an oxidizing gas such as ozone which is now a major issue in ink jet printing, since there is no reported example regarding dye properties such as what structure or physical property works effectively with respect to ozone fastness, guidelines for selecting dyes have not been provided. Further, it is further extremely difficult to select a dye which has also fastness to light.

On the other hand, some ink receiving layers of an ink jet recording medium contain fine particles and a water-soluble resin. In this ink receiving layer, a porous structure is obtained by containing fine particles and, thereby, ink absorbing performance is improved. However, this has a problem in ozone resistance due to its porous nature.

Use of a sulfur-based additive to improve ozone resistance has been already reported (for example, see JP-A No. 2002-86904, JP-A No. 2002-36717, JP-A No. 2001-260519, and JP-A No. 7-314882). However, while ozone resistance is excellent as compared with a case where it is not used, it is not necessarily at a satisfactory level.

Further, as a technique of improving ozone resistance of an ink jet recording medium, JP-A No. 2005-7849, for example, discloses a method of making an ink receiving layer of an ink jet recording medium containing a sulfoxide compound, and a water-soluble polyvalent metal salt.

However, a sufficient effect is not exerted in some cases, depending on the dye used.

### DISCLOSURE OF THE INVENTION

### Problems to be Solved by the Invention

The invention was done in view of the aforementioned circumstances, and an object of the invention is to provide a set for ink jet recording which can form an image excellent in ozone resistance, and an ink jet recording method using the same.

### Means for Solving the Problem

<1> A set for ink jet recording, having an ink jet recording medium containing a water-soluble aluminum compound and a sulfoxide compound in an ink receiving layer on a support, and an ink containing a coloring matter represented by the following formula (I).

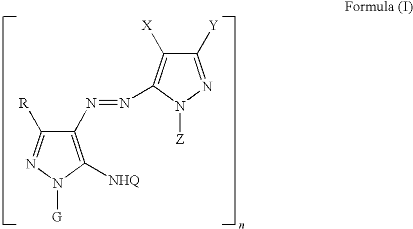

(wherein G represents a heterocyclic group, n represents an integer of 1 to 3, when n is 1, R, X, Y, Z, Q and G represent a monovalent group, when n is 2, R, X, Y, Z, Q and G represent a monovalent or divalent substituent, and at least one of them represents a divalent substituent and, when n is 3, R, X, Y, Z, Q and G represent a monovalent, divalent or trivalent substituent, and at least two of them represent a divalent substituent, or at least one of them represents a trivalent substituent)

<2> The set for ink jet recording according to <1>, wherein n in the coloring matter represented by the formula (I) is 2.
<3> The set for ink jet recording according to <1>, wherein X of the coloring matter represented by the formula (I) is a cyano group, or an alkylsulfonyl group having a carbon number of 1 to 12.
<4> The set for ink jet recording according to <1>, wherein the coloring matter represented by the formula (I) is a coloring matter represented by the following formula (1).

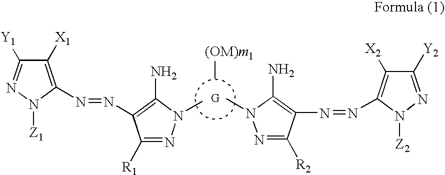

(wherein R₁, R₂, X₁, X₂, Y₁, Y₂, Zᵢ and Z₂ represent a monovalent group, G represents an atom group constituting a 5- to 8-membered nitrogen-containing heterocycle, M represents a hydrogen atom or a cation, and m₁ represents an integer of 0 to 3)

<5> The set for ink jet recording according to <4>, wherein the coloring matter represented by the formula (1) is a coloring matter represented by the following formula (1-1).

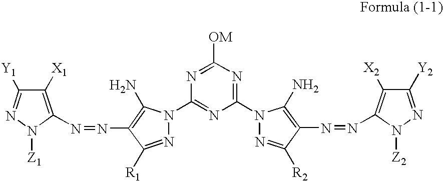

(wherein R₁, R₂, Y₁ and Y₂ represent a monovalent group, X₁ and X₂ each independently represent an electron-withdrawing group having a Hammettσp value of 0.20 or more, Z₁ and Z₂ each independently represent a hydrogen atom, a substituted or unsubstituted alkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, and M represents a hydrogen atom or a cation)

<6> The set for ink jet recording according to <1>, wherein the water-soluble aluminum compound is polyaluminum chloride.
<7> The set for ink jet recording according to <1>, wherein a content of the water-soluble aluminum compound is 0.1 to 20 g/m².
<8> The set for ink jet recording according to <1>, wherein the sulfoxide compound has one or more structures represented by the following formula (S1) in a molecule.

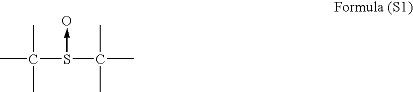

<9> The set for ink jet recording according to <1>, wherein the sulfoxide compound has one or more structures represented by the following formula (S2) in a molecule.

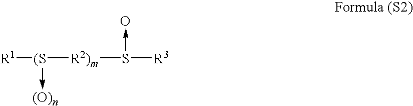

[in the formula (S2), R¹ and R³ each independently represent a substituted or unsubstituted alkyl group, a substituted or unsubstituted aryl group, a substituted or unsubstituted heterocyclic group, or a polymer residue consisting of them, R¹ and R³ may be the same or different, or may be connected to each other to form a ring, R² represents a substituted or unsubstituted di- to hexa-valent connecting group, R¹ and R², or R² and R³ may be connected to each other to form a ring, m represents an integer of 0 or 1 or more, and n represents 0 or 1]
<10> The set for ink jet recording according to <1>, wherein a content of the sulfoxide compound is 0.01 to 20 g/m².
<11> The set for ink jet recording according to <1>, wherein the ink receiving layer further contains a water-soluble resin.
<12> The set for ink jet recording according to <1>, wherein the ink receiving layer further contains a fine particle selected from an organic fine particle, a silica fine particle, an alumina fine particle, and a pseudoboehmite-type aluminum hydroxide fine particle.
<13> The set for ink jet recording according to <1>, wherein the ink receiving layer further contains a cationic polymer.
<14> The set for ink jet recording according to <1>, wherein the ink receiving layer contains a latex having a volume average particle diameter of 0.1 μm or less.
<15> The set for ink jet recording according to <1>, wherein the ink receiving layer further contains a mordant.
<16> The set for ink jet recording according to <1>, wherein the ink receiving layer further contains an organic solvent having a boiling point of 230° C. or higher.
<17> The set for ink jet recording according to <1>, wherein the ink receiving layer has a pore diameter of 0.005 to 0.30 μm as expressed by a median diameter.
<18>The set for ink jet recording according to <1>, wherein the ink receiving layer has a pore diameter of 18 to 40 ml/cm².
<19> An ink jet recording method, comprising forming an image using a set for ink jet recording as defined in <1>.

### EFFECT OF THE INVENTION

According to the invention, a set for ink jet recording which can form an image excellent in ozone resistance can be provided. In addition, according to the invention, an ink jet recording method, which can form an image excellent in ozone resistance using the set for ink jet recording, can be provided.

### BEST MODE FOR CARRYING OUT THE INVENTION

The set for ink jet recording of the invention comprises an ink jet recording medium containing a water-soluble aluminum compound and a sulfoxide compound in an ink receiving layer on a support, and an ink containing a coloring matter represented by the formula (I).

By having an ink jet recording medium containing a water-soluble aluminum compound and a sulfoxide compound, and an ink containing a coloring matter represented by the formula (I), the set for ink jet recording of the invention can be made excellent in ozone resistance.

An ink, and an ink jet recording medium which are a constituent element of the set for ink jet recording of the invention will be explained in detail below.

### [Ink]

An ink in the invention contains at least a coloring matter represented by the following formula (I) and, if necessary, other additives may be added to the ink.

### (Coloring Matter Represented by the Formula (I))

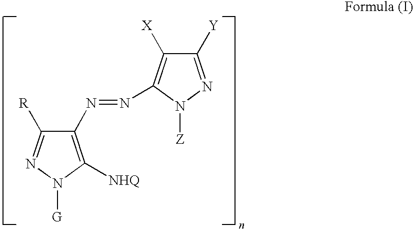

The formula (I) will be explained in detail below.

In the formula (I), G represents a heterocyclic group, and n represents an integer of 1 to 3. And, when m is 1, R, X, Y, Z, Q and G represent a monovalent group. And, when n is 2, R, X, Y, Z, Q and G represent a monovalent or divalent substituent, and at least one of them represents a divalent substituent. And, when n is 3, R, X, Y, Z, Q and G represent a monovalent, divalent or trivalent substituent, and at least two of them represent a divalent substituent, or at least one of them represents a trivalent substituent.

The formula (I) will be explained in more detail below.

In the formula (I), a preferable example of G is a 5- to 8-membered heterocyclic group, among these, a 5- or 6-membered substituted or unsubstituted aromatic or non-aromatic heterocyclic group is preferable, and they may be further fused. Further preferable is a 5- or 6-membered aromatic heterocyclic group having a carbon number of 3 to 30.

Examples of the heterocyclic group represented by G include, as expressed without limiting a substitution position, pyridine, pyrazine, pyridazine, pyrimidine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isooxazole, benzisooxazole, pyrrolidine, piperidine, piperazine, imidazolidine, thiazoline, and sulfolane.

When the heterocyclic group is a group which can further have a substituent, it may further have the following substituents.

Examples include a straight or branched alkyl group having a carbon number of 1 to 12, a straight or branched aralkyl group having a carbon number of 7 to 18, a straight or branched alkenyl group having a carbon number of 2 to 12, a straight or branched alkynyl group having a carbon number of 2 to 12, a straight or branched cycloalkyl group having a carbon number of 3 to 12, a straight or branched cycloalkenyl group having a carbon number of 3 to 12 (above respective groups are preferably have a branched chain from a viewpoint that they improve dye solubility and ink stability, and groups having an asymmetric carbon are particularly preferable; e.g. methyl, ethyl, propyl, isopropyl, sec-butyl, t-butyl, 2-ethylhexyl, 2-methylsulfonylethyl, 3-phenoxypropyl, trifluoromethyl, cyclopentyl), a halogen atom (e.g. chlorine atom, bromine atom), an aryl group (e.g. phenyl, 4-t-butylphenyl, 2,4-di-t-amylphenyl), a heterocyclic group (e.g. imidazolyl, pyrazolyl, triazolyl, 2-furyl, 2-thiophenyl, 2-pyrimidinyl, 2-benzothiazolyl), a cyano group, a hydroxy group, a nitro group, a carboxy group, an amino group, an alkyloxy group (e.g. methoxy, ethoxy, 2-methoxyethoxy, 2-methylsulfonylethoxy), an aryloxy group (e.g. phenoxy, 2-methylphenoxy, 4-t-butylphenoxy, 2-nitrophenoxy, 3-t-butyloxycarbonylphenoxy, 3-methoxycarbonylphenyloxy), an acylamino group (e.g. acetamido, benzamido, 4-(3-t-butyl-4-hydroxyphenoxy)butanamido), an alkylamino group (e.g. methylamino, butylamino, diethylamino, methylbutylamino), an arylamino group (e.g. phenylamino, 2-chloroanilino), an ureido group (e.g. phenylureido, methylureido, N,N-dibutylureido), a sulfamoylamino group (e.g. N,N-dipropylsulfamoylamino), an alkylthio group (e.g. methylthio, octylthio, 2-phenoxyethylthio), an arylthio group (e.g. phenylthio, 2-butoxy-5-t-octylphenylthio, 2-carboxyphenylthio), an alkyloxycarbonylamino group (e.g. methoxycarbonylamino), an alkylsulfonylamino group and an arylsulfonylamino group (e.g. methylsulfonylamino, phenylsulfonylamino, p-toluenesulfonylamino), a carbamoyl group (e.g. N-ethylcarbamoyl, N,N-dibutylcarbamoyl), a sulfamoyl group (e.g. N-ethylsulfamoyl, N,N-dipropylsulfamoyl, N-phenylsulfamoyl), a sulfonyl group (e.g. methylsulfonyl, octylsulfonyl, phenylsulfonyl, p-toluenesulfonyl), an alkyloxycarbonyl group (e.g. methoxycarbonyl, butyloxycarbonyl), a heterocyclic oxy group (e.g. 1-phenyltetrazole-5-oxy, 2-tetrahydropyranyloxy), an azo group (e.g. phenylazo, 4-methoxyphenylazo, 4-pivaloylaminophenylazo, 2-hydroxy-4-propanoylphenylazo), an acyloxy group (e.g. acetoxy), a carbamoyloxy group (e.g. N-methylcarbamoyloxy, N-phenylcarbamoyloxy), a silyloxy group (e.g. triemthylsilyloxy, dibutylmethylsilyloxy), an aryloxycarbonylamino group (e.g. phenoxycarbonylamino), an imido group (e.g. N-succinimido, N-phthalimido), a heterocyclic thio group (e.g. 2-benzothiazolylthio, 2,4-di-phenoxy-1,3,5-triazole-6-thio, 2-pyridylthio), a sulfinyl group (e.g. 3-phenoxypropylsulfinyl), a phosphonyl group (e.g. phenoxyphosphonyl, octyloxyphosphonyl, phenylphosphonyl), an aryloxycarbonyl group (e.g. phenoxycarbonyl), an acyl group (e.g. acetyl, 3-phenylpropanoyl, benzoyl), and an ionic hydrophilic group (e.g. carboxyl group, sulfo group, phosphono group and quaternary ammonium group).

In the formula (I), examples of a preferable substituent of Q, R, X, Y and Z will be explained in detail.

When Q, R, X, Y and Z represent a monovalent group, a monovalent group represents a hydrogen atom, or a monovalent substituent. A monovalent substituent will be explained in more detail. Examples of this monovalent substituent include a halogen atom, an alkyl group, a cycloalkyl group, an aralkyl group, an alkenyl group, an alkynyl group, an aryl group, a heterocyclic group, a cyano group, a hydroxyl group, a nitro group, an alkoxy group, an acyloxy group, a silyloxy group, a heterocyclic oxy group, an acyloxy group, a carbamoyloxy group, an alkoxycarbonyloxy group, an aryloxycarbonyloxy group, an amino group (alkylamino group, arylamino group), an acylamino group (amido group), an aminocarbonylamino group (ureido group), an alkoxycarbonylamino group, an aryloxycarbonylamino group, a sulfamoylamino group, an alkylsulfonylamino group, an arylsulfonylamino group, an alkylthio group, an arylthio group, a heterocyclic thio group, a sulfamoyl group, an alkylsulfinyl group, an arylsulfinyl group, an alkylsulfonyl group, an arylsulfonyl group, an acyl group, an aryloxycarbonyl group, an alkoxycarbonyl group, a carbamoyl group, a phosphino group, a phosphinyl group, a phosphinyloxy group, a phosphinylamino group, a silyl group, an azo group and an imido group, and each group may further have a substituent.

Among them, particularly preferably are a hydrogen atom, a halogen atom, an alkyl group, an aryl group, a heterocyclic group, a cyano group, an alkoxy group, an amido group, an ureido group, an alkylsulfonylamino group, an arylsulfonylamino group, a sulfamoyl group, an alkylsulfonyl group, an arylsulfonyl group, a carbamoyl group, and an alkoxycarbonyl group. Particularly, a hydrogen atom, a halogen atom, an alkyl group, an aryl group, a cyano group, an alkylsulfonyl group, an arylsulfonyl group, and a heterocyclic group are preferable. A hydrogen atom, an alkyl group, an aryl group, a cyano group, and an alkylsulfonyl group are most preferable.

The Q, R, X, Y and Z will be explained in more detail below.

A halogen atom represented by Q, R, X, Y or Z represents a chlorine atom, a bromine atom, or an iodine atom. Among these, a chlorine atom and a bromine atom are preferable, and a chlorine atom is particularly preferable.

An alkyl group represented by Q, R, X, Y or Z includes a substituted or unsubstituted alkyl group. As the substituted or unsubstituted alkyl group, an alkyl group having a carbon number of 1 to 30 is preferable. Examples of a substituent include the same substituents as those exemplified when G is a group which can further have a substituent. Among these, a hydroxy group, an alkoxy group, a cyano group, a halogen atom, a sulfo atom (which may be in a form of a salt) and a carboxyl group (which may be in a form of a salt) are preferable. Examples of the alkyl group include methyl, ethyl, butyl, t-butyl, n-octyl, eicosyl, 2-chloroethyl, hydroxyethyl, cyanoethyl or 4-sulfobutyl.

A cycloalkyl group represented by Q, R, X, Y and Z includes a substituted or unsubstituted cycloalkyl group. As a substituted or unsubstituted cycloalkyl group, a cycloalkyl group having a carbon number of 5 to 30 is preferable. Examples of a substituent include the same substituents as those exemplified when G is a group which can further have a substituent. Examples of the cycloalkyl group include cyclohexyl, cyclopentyl, and 4-n-dodecylcyclohexyl.

An aralkyl group represented by Q, R, X, Y or Z includes a substituted or unsubstituted aralkyl group. As a substituted or unsubstituted aralkyl group, an aralkyl group having a carbon number of 7 to 30 is preferable. Examples of a substituent include the same substituents as those exemplified when G is a group which can further have a substituent. Examples of the aralkyl group include benzyl and 2-phenethyl.

An alkenyl group represented by Q, R, X, Y or Z represents a straight, branched or cyclic substituted or unsubstituted alkenyl group. Examples include preferably a substituted or unsubstituted alkenyl group having a carbon number of 2 to 30, such as vinyl, allyl, prenyl, geranyl, oleyl, 2-cyclopenten-1-yl, and 2-cyclohexene-1-yl.

An alkynyl group represented by Q, R, X, Y or Z is a substituted or unsubstituted alkynyl group having a carbon number of 2 to 30, and examples include ethynyl and propargyl.

An aryl group represented by Q, R, X, Y or Z is a substituted or unsubstituted aryl group having a carbon number of 6 to 30, such as phenyl, p-tolyl, naphthyl, m-chlorophenyl, and o-hexadecanoylaminophenyl. Examples of a substituent include the same substituents as those exemplified when G is a group which can further have a substituent.

A heterocyclic group represented by Q, R, X, Y and Z is a monovalent group obtained by removing one hydrogen atom from a 5- or 6-membered substituted or unsubstituted aromatic or non-aromatic heterocyclic compound, and those groups may be further fused. Further preferable is a 5- or 6-membered aromatic heterocyclic group having a carbon number of 3 to 30. Examples of a substituent include the same substituents as those exemplified when G is a group which can further have a substituent. Examples of the heterocyclic group include, as expressed without limiting a substitution position, pyridine, pyrazine, pyridazine, pyrimidine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isooxazole, benzisooxazole, pyrrolidine, piperidine, piperazine, imidazolidine, and thiazoline.

An alkoxy group represented by Q, R, X, Y or Z includes a substituted or unsubstituted alkoxy group. As a substituted or unsubstituted alkoxy group, an alkoxy group having a carbon number of 1 to 30 is preferable. Examples of a substituent include the same substituents as those exemplified when G is a group which can further have a substituent. Examples of the alkoxy group include methoxy, ethoxy, isopropoxy, n-octyloxy, methoxyethoxy, hydroxyethoxy and 3-carboxypropoxy.

An aryloxy group represented by Q, R, X, Y or Z is preferably a substituted or unsubstituted aryloxy group having a carbon number of 6 to 30. Examples of a substituent include the same substituents as those exemplified when G is a group which can further have a substituent. Examples of the aryloxy group include phenoxy, 2-methylphenoxy, 4-t-butylphenoxy, 3-nitrophenoxy, and 2-tetradecanoylaminophenoxy.

A silyloxy group represented by Q, R, X, Y or Z is preferably a silyloxy group having a carbon number of 3 to 20, and examples include trimethylsilyloxy, and t-butyldimethylsilyloxy.

A heterocyclic oxy group represented by Q, R, X, Y or Z is preferably a substituted or unsubstituted heterocyclic oxy group having a carbon number of 2 to 30. Examples of a substituent include the same substituents as those exemplified when G is a group which can further have a substituent. Examples of the heterocyclic oxy group include 1-phenyltetrazole-5-oxy, and 2-tetrahydropyranyloxy.

An acyloxy group represented by Q, R, X, Y or Z is preferably a formyloxy group, a substituted or unsubstituted alkylcarbonyloxy group having a carbon number of 2 to 30, or a substituted or unsubstituted arylcarbonyloxy group having a carbon number of 6 to 30, and examples of a substituent include the same substituents as those exemplified when G is a group which can further have a substituent. Examples of the acyloxy group include formyloxy, acetyloxy, pyvaloyloxy, stearoyloxy, benzoyloxy, and p-methoxyphenylcarbonyloxy.

A carbamoyloxy group represented by Q, R, X, Y or Z is preferably a substituted or unsubstituted carbamoyloxy group having a carbon number of 1 to 30, and examples of a substituent include the same substituents as those exemplified when G is a group which can further have a substituent.

Examples of the carbamoyloxy group include N,N-dimethylcarbamoyloxy, N,N-diethylcarbamoyloxy, morpholinocarbonyloxy, N,N-di-n-octylaminocarbonyloxy, and N-n-octylcarbamoyloxy.

An alkoxycarbonyloxy group represented by Q, R, X, Y or Z is preferably a substituted or unsubstituted alkoxycarbonyloxy group having a carbon number of 2 to 30, and examples of a substituent include the same substituents as those exemplified when G is a group which can further have a substituent. Examples of the alkoxycarbonyloxy group include methoxycarbonyloxy, ethoxycarbonyloxy, t-butoxycarbonyloxy, and n-octylcarbonyloxy.

An aryloxycarbonyloxy group represented by Q, R, X, Y and Z is preferably a substituted or unsubstituted aryloxycarbonyloxy group having a carbon number of 7 to 30, and examples of a substituent include the same substituents as those exemplified when G is a group which can further have a substituent. Examples of the aryloxycarbonyloxy group include phenoxycarbonyloxy, p-methoxyphenoxycarbonyloxy, and p-n-hexadecyloxyphenoxycarbonyloxy.

An amino group represented by Q, R, X, Y or Z is preferably a substituted or unsubstituted alkylamino group having a carbon number of 1 to 30, or a substituted or unsubstituted arylamino group having a carbon number of 6 to 30, and examples of a substituent include the same substituents as those exemplified when G is a group which can further have a substituent. Examples of the amino group include amino, methylamino, dimethylamino, anilino, N-methyl-anilino, diphenylamino, hydroxyethylamino, carboxyethylamino, sulfoethylamino, and 3,5-dicarboxyanilino.

An acylamino group represented by Q, R, X, Y or Z is preferably a formylamino group, a substituted or unsubstituted alkylcarbonylamino group having a carbon number of 1 to 30, or a substituted or unsubstituted arylcarbonylamino group having a carbon number of 6 to 30, and examples of a substituent include the same substituents as those exemplified when G is a group which can further have a substituent. Examples of the acylamino group include formylamino, acetylamino, pyvaloylamino, lauroylamino, benzoylamino, and 3,4,5-tri-n-octyloxyphenylcarbonylamino.

An aminocarbonylamino group represented by Q, R, X, Y or Z is preferably a substituted or unsubstituted aminocarbonylamino group having a carbon number of 1 to 30, and examples of a substituent include the same substituents as those exemplified when G is a group which can further have a substituent. Examples of the aminocarbonylamino group include carbamoylamino, N,N-dimethylaminocarbonylamino, N,N-diethylaminocarbonylamino, and morpholinocarbonylamino.

An alkoxycarbonylamino group represented by Q, R, X, Y or Z is preferably a substituted or unsubstituted alkoxycarbonylamino of a carbon number of 2 to 30, and examples of a substituent include the same substituents as those exemplified when G is a group which can further have a substituent. Examples of the alkoxycarbonylamino group include methoxycarbonylamino, ethoxycarbonylamino, t-butoxycarbonylamino, n-octadecyloxycarbonylamino, and N-methyl-methoxycarbonylamino.

An aryloxycarbonylamino group represented by Q, R, X, Y or Z is preferably a substituted or unsubstituted aryloxycarbonylamino group having a carbon number of 7 to 30, and examples of a substituent include the same substituents as those exemplified when G is a group which can further have a substituent. Examples of the aryloxycarbonylamino group include phenoxycarbonylamino, p-chlorophenoxycarbonylamino, and m-n-octyloxyphenoxycarbonylamino.

A sulfamoylamino group represented by Q, R, X, Y or Z is preferably a substituted or unsubstituted sulfamoylamino group having a carbon number of 0 to 30, and examples of a substituent include the same substituents as those exemplified when G is a group which can further have a substituent. Examples of the sulfamoylamino group include sulfamoylamino, N,N-dimethylaminosulfonylamino, and N-n-octylaminosulfonylamino.

Examples of an alkyl and arylsulfonylamino group represented by Q, R, X, Y or Z is preferably a substituted or unsubstituted alkylsulfonylamino group having a carbon number of 1 to 30, or a substituted or unsubstituted arylsulfonylamino group having a carbon number of 6 to 30, and examples of a substituent include the same substituents as those exemplified when G is a group which can further have a substituent. Examples of the alkylsulfonylamino group and arylsulfonylamino group include methylsulfonylamino, butylsulfonylamino, phenylsulfonylamino, 2,3,5-trichlorophenylsulfonylamino, and p-methylphenylsulfonylamino.

An alkylthio group represented by Q, R, X, Y or Z is preferably a substituted or unsubstituted alkylthio group having a carbon number of 1 to 30, and examples of a substituent include the same substituents as those exemplified when G is a group which can further have a substituent. Examples of the alkylthio group include methylthio, ethylthio, and n-hexyldecylthio.

An arylthio group represented by Q, R, X, Y or Z is preferably a substituted or unsubstituted arylthio group having a carbon number of 6 to 30, and examples of a substituent include the same substituents as those exemplified when G is a group which can further have a substituent. Examples of the arylthio group include phenylthio, p-chlorophenylthio, and m-methoxyphenylthio.

A heterocyclic thio group represented by Q, R, X, Y or Z is preferably a substituted or unsubstituted heterocyclic thio group having a carbon number of 2 to 30, and examples of a substituent include the same substituents as those exemplified when G is a group which can further have a substituent. Examples of the heterocyclic thio group include 2-benzothiazolylthio, and 1-phenyltetrazol-5-ylthio.

A sulfamoyl group represented by Q, R, X, Y or Z is preferably a substituted or unsubstituted sulfamoyl group having a carbon number of 0 to 30, and examples of a substituent include the same substituents as those exemplified when G is a group which can further have a substituent. Examples of the sulfamoyl group include N-ethylsulfamoyl, N-(3-dodecyloxypropyl)sulfamoyl, N,N-dimethylsulfamoyl, N-acetylsulfamoyl, N-benzoylsulfamoyl, and N—(N′-phenylcarbamoyl)sulfamoyl.

An alkyl or arylsulfinyl group represented by Q, R, X, Y or Z is preferably a substituted or unsubstituted alkylsulfinyl group having a carbon number of 1 to 30, or a substituted or unsubstituted arylsulfinyl group having a carbon number of 6 to 30, and examples of a substituent include the same substituents as those exemplified when G is a group which can further have a substituent. Examples of the alkyl or arylsulfinyl group include methylsulfinyl, ethylsulfinyl, phenylsulfinyl, and p-methylphenylsulfinyl.

An alkyl or arylsulfonyl group represented by Q, R, X, Y or Z is preferably a substituted or unsubstituted alkylsulfonyl group having a carbon number of 1 to 30, or a substituted or unsubstituted arylsulfonyl group having a carbon number of 6 to 30, and examples of a substituent include the same substituents as those exemplified when G is a group which can further have a substituent. Examples of the alkyl or arylsulfonyl group include methylsulfonyl, ethylsulfonyl, phenylsulfonyl, and p-toluenesulfonyl.

An acyl group represented by Q, R, X, Y or Z is preferably a formyl group, a substituted or unsubstituted alkylcarbonyl group having a carbon number of 2 to 30, a substituted or unsubstituted arylcarbonyl group having a carbon number of 7 to 30, or a substituted or unsubstituted heterocyclic carbonyl group having a carbon number of 4 to 30, which is bound to a carbonyl group with a carbon atom, and examples of a substituent include the same substituents as those exemplified when G is a group which can further have a substituent. Examples of the acyl group include acetyl, pivaloyl, 2-chloroacetyl, stearoyl, benzoyl, p-n-octyloxyphenylcarbonyl, 2-pyridylcarbonyl, and 2-furylcarbonyl.

An aryloxycarbonyl group represented by Q, R, X, Y or Z is preferably a substituted or unsubstituted aryloxycarbonyl group having a carbon number of 7 to 30, and examples of a substituent include the same substituents as those exemplified when G is a group which can further have a substituent. Examples of the aryloxycarbonyl group include phenoxycarbonyl, o-chlorophenoxycabronyl, m-nitrophenoxycarboonyl, and p-t-butylphenoxycarbonyl.

An alkoxycarbonyl group represented by Q, R, X, Y or Z is preferably a substituted or unsubstituted alkoxycarbonyl group having a carbon number of 2 to 30, and examples of a substituent include the same substituents as those exemplified when G is a group which can further have a substituent. Examples of the alkoxycarbonyl group include methoxycarbonyl, ethoxycarbonyl, t-butoxycarbonyl, and n-octadecyloxycarbonyl.

A carbamoyl group represented by Q, R, X, Y or Z is preferably a substituted or unsubstituted carbamoyl group having a carbon number of 1 to 30, and examples of a substituent include the same substituents as those exemplified when G is a group which can further have a substituent. Examples of the carbamoyl group include carbamoyl, N-methylcarbamoyl, N,N-dimethylcarbamoyl, N,N-di-n-octylcarbamoyl, and N-(methylsulfonyl)carbamoyl.

A phosphino group represented by Q, R, X, Y or Z is preferably a substituted or unsubstituted phosphino group having a carbon number of 2 to 30, and examples of a substituent include the same substituents as those exemplified when G is a group which can further have a substituent. Examples of the phosphino group include dimethylphosphino, diphenylphosphino, and methylphenoxyphosphino.

A phosphinyl group represented by Q, R, X, Y or Z is preferably a substituted or unsubstituted phosphinyl group having a carbon number of 2 to 30, and examples of a substituent include the same substituents as those exemplified when G is a group which can further have a substituent. Examples of the phosphinyl group include phosphinyl, dioctyloxyphosphinyl, diethoxyphosphinyl.

A phosphinyloxy group represented by Q, R, X, Y or Z is preferably a substituted or unsubstituted phosphinyloxy group having a carbon number of 2 to 30, and examples of a substituent include the same substituents as those exemplified when G is a group which can further have a substituent. Examples of the phosphinyloxy group include diphenoxyphosphinyloxy, and dioctyloxyphosphinyloxy.

A phosphinylamino group represented by Q, R, X, Y or Z is preferably a substituted or unsubstituted phosphinylamino group having a carbon number of 2 to 30, and examples of a substituent include the same substituents as those exemplified when G is a group which can further have a substituent. Examples of the phosphinylamino group include dimethoxyphosphinylamino, and dimethylaminophosphinylamino.

A silyl group represented by Q, R, X, Y or Z is preferably a substituted or unsubstituted silyl group having a carbon number of 3 to 30, and examples of a substituent include the same substituents as those exemplified when G is a group which can further have a substituent. Examples of the silyl group include trimethylsilyl, t-butyldimethylsilyl, and phenyldimethylsilyl.

Examples of an azo group represented by Q, R, X, Y or Z include phenylazo, 4-methoxyphenylazo, 4-pyvaloylaminophenylazo, and 2-hydroxy-4-propanoylphenylazo.

Examples of an imido group represented by Q, R, X, Y or Z include N-succinimido, and N-phthalimido.

When Q, R, X, Y or Z represents a divalent group, a divalent group is preferably an alkylene group (e.g. methylene, ethylene, propylene, butylene, pentylene), an alkenylene group (e.g. ethenylene, propenylene), an alkynylene group (e.g. ethynylene, propynylene), an arylene group (e.g. phenylene, naphthylene), a divalent heterocyclic group (e.g. 6-chloro-1,3,5-triazin-2,4-diyl group, pyrimidin-2,4-diyl group, pyrimidin-4,6-diyl group, quinoxalin-2,3-diyl group, pyridazin-3,6-diyl), —O—, —CO—, —NR′—(R′ is hydrogen atom, alkyl group or aryl group), —S—, —SO₂—, —SO— or a combination thereof (e.g. —NHCH₂CH₂NH—, —NHCONH— etc.).

An alkylene, an alkynylene group, an alkynylene group, an arylene group, a divalent heterocyclic group, and an alkyl group or an aryl group of R may have a substituent.

Examples of a substituent have the same meaning as that of substituents explained for G.

The alkyl group and aryl group of R′ have the same meaning as that of an example of the substituent of G.

Further preferable are an alkylene group having a carbon number of 10 or less, an alkenylene group having a carbon number of 10 or less, an alkynylene group having a carbon number of 10 or less, an arylene group having a carbon number of 6 or more and 10 or less, a divalent heterocyclic group, —S—, —SO—, —SO₂— and a combination thereof (e.g. —SCH₂CH₂S—, —SCH₂CH₂CH₂S— etc.).

A total carbon number of a divalent connecting group is preferably 0 to 50, more preferably 0 to 30, most preferably 0 to 10.

When Q, R, X, Y or Z represents a trivalent group, a trivalent group is preferably a trivalent hydrocarbon group, a trivalent heterocyclic group, >N— or a combination of this and a divalent group (e.g. >NCH₂CH₂NH—, >NCONH— etc.).

A total carbon number of a trivalent connecting group is preferably 0 to 50, more preferably 0 to 30, most preferably 0 to 10.

In the formula (I), preferable examples n include 1 or 2, and 2 is particularly preferable.

In the formula (I), a preferable example of a substituent of X is an electron-withdrawing group. Particularly, an electron-withdrawing group having a Hammett substituent constant σp value of 0.20 or more is preferable, and an electron-withdrawing group having a σp value of 0.30 or more is more preferable. An upper limit is an electron-withdrawing group of 1.0 or less.

Examples of X which is an electron-withdrawing group having a σp value of 0.20 or more include an acyl group, an acyloxy group, a carbamoyl group, an alkyloxycarbonyl group, an aryloxycarbonyl group, a cyano group, a nitro group, a dialkylphosphono group, a diarylphosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, a halogenated alkyl group, a halogenated alkoxy group, a halogenated aryloxy group, a halogenated alkylamino group, and a halogenated alkylthio group, as well as an aryl group, a heterocyclic group, a halogen atom, an azo group, and a selenocyanate group which are substituted with other electron-withdrawing group having a σp value of 0.20 or more.

Preferable examples of X include an acyl group having a carbon number of 2 to 12, an acyloxy group having a carbon number of 2 to 12, a carbamoyl group having a carbon number of 1 to 12, an alkyloxycarbonyl group having a carbon number of 2 to 12, an aryloxycarbonyl group having a carbon number of 7 to 18, a cyano group, a nitro group, an alkylsulfinyl group having a carbon number of 1 to 12, an arylsulfinyl group having a carbon number of 6 to 18, an alkylsulfonyl group having a carbon number of 1 to 12, an arylsulfonyl group having a carbon number of 6 to 18, a sulfamoyl group having a carbon number of 0 to 12, a halogenated alkyl group having a carbon number of 1 to 12, a halogenated alkyloxy group having a carbon number of 1 to 12, a halogenated alkylthio group having a carbon number of 1 to 12, a halogenated aryloxy group having a carbon number of 7 to 18, an aryl group having a carbon number of 7 to 18 substituted with other 2 or more electron-withdrawing groups having a σp value of 0.20 or more, and a 5- to 8-membered heterocyclic group having a carbon number of 1 to 18 having a nitrogen atom, an oxygen atom or a sulfur atom.

Further preferable are a cyano group, an alkylsulfonyl group having a carbon number of 1 to 12, an arylsulfonyl group having a carbon number of 6 to 18, and a sulfamoyl group having a carbon number of 0 to 12.

X is particularly preferably a cyano group, an alkylsulfonyl group having a carbon number of 1 to 12, or a sulfamoyl group having a carbon number of 0 to 12, and most preferably a cyano group, or an alkylsulfonyl group having a carbon number of 1 to 12.

In the formula (I), a preferable example of a substituent of Z represents a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

An example of a detailed substituent represented by Z has the same meaning as a corresponding substituent example explained for an example of the heterocyclic group represented by G, and a preferable example is the same thereto.

A particularly preferable substituent represented by Z is a substituted aryl group, or a substituted heterocyclic group and, among these, a substituted aryl group is particularly preferable.

An example of a preferable substituent of Q in the formula (I) is preferably a hydrogen atom, a substituted or unsubstituted alkyl group, a substituted or unsubstituted acyl group, a substituted or unsubstituted alkylsulfonyl group, or a substituted or unsubstituted arylsulfonyl group, particularly preferably a hydrogen atom, a substituted or unsubstituted alkyl group, or a substituted or unsubstituted acyl group and, among these, a hydrogen atom is particularly preferable.

In the formula (I), R is preferably a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 and, among these, a straight alkyl group or a branched alkyl group of a total carbon atom number of C1-C8 is preferable, a secondary or tertiary alkyl group is particularly preferable, and a t-butyl group is most preferable.

In the formula (I), Y is preferably a hydrogen atom, a substituted or unsubstituted alkyl group of a total carbon atom number of C1-C12, a substituted or unsubstituted aryl group of a total carbon atom number of C6-C18, or a substituted or unsubstituted heterocyclic group of a total carbon atom number of C4-C12 and, among these, a hydrogen atom, a straight alkyl group or a branched alkyl group of a total carbon atom number of C1-C8 is preferable, a hydrogen atom, or a C1-C8 alkyl group is particularly preferable, and a hydrogen atom is most preferable.

Regarding a combination of preferable substituents of a coloring matter represented by the formula (I) of the invention, a compound in which at least one of various substituents is the aforementioned preferable group is preferable, a compound in which more various substituents are the aforementioned preferable groups is more preferable, and a compound in which all substituents are the aforementioned preferable groups is most preferable.

A particularly preferable combination as a coloring matter represented by the formula (I) of the invention include the following (a) to (g).

(a) G is preferably a 5- to 8-membered nitrogen-containing heterocycle, particularly preferably a S-triazine ring, a pyrimidine ring, a pyridazine ring, a pyrazine ring, a pyridine ring, an imidazole ring, a pyrazole ring, or a pyrrole ring and, among these, a S-triazine ring, a pyrimidine ring, a pyridazine ring, or a pyrazine ring is preferable, and a S-triazine ring is most preferable.

(b) R is preferably a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 and, among these, a straight alkyl group or a branched alkyl group of a total carbon atom number of C1-C8 is preferable, a secondary or tertiary alkyl group is particularly preferable, and a t-butyl group is most preferable.

(c) X is particularly preferably a cyano group, an alkylsulfonyl group having a carbon number of 1 to 12, an arylsulfonyl group having a carbon number of 6 to 18, or a sulfamoyl group having a carbon number of 0 to 12 and, among these, a cyano group, or an alkylsulfonyl group having a carbon number of 1 to 12 is preferable, and a cyano group is most preferable.

(d) Y is preferably a hydrogen atom, a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 and, among these, a hydrogen atom, or a straight alkyl group or a branched alkyl group of a total carbon atom number of C1-C8 is preferable, a hydrogen atom or a C1-C8 alkyl group is particularly preferable, and a hydrogen atom is most preferable.

(e) Z is preferably a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, and a particularly preferable substituent is a substituted aryl group, or a substituted heterocyclic group and, among these, a substituted aryl group is particularly preferable.

(f) Q is preferably a hydrogen atom, a substituted or unsubstituted alkyl group, a substituted or unsubstituted acyl group, a substituted or unsubstituted alkylsulfonyl group, or a substituted or unsubstituted arylsulfonyl group, particularly preferably a hydrogen atom, a substituted or unsubstituted alkyl group, or a substituted or unsubstituted acyl group and, among these, a hydrogen atom is particularly preferable.

(g) And, n represents an integer of 1 to 3, preferably 1 or 2, particularly most preferably 2.

A coloring matter represented by the formula (I) is a novel compound.

Of an azo coloring matter represented by the formula (I), more preferable is a coloring matter represented by the following formula (1), further preferable is a coloring matter represented by the following formula (1-1).

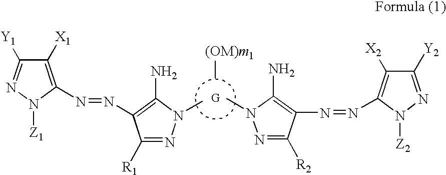

The formula (1) will be explained in detail below.

In the formula (I), R₁, R₂, X₁, X₂, Y₁, Y₂, Zᵢ and Z₂ represent a monovalent group.

A monovalent group represents a hydrogen atom or a monovalent substituent. Examples of the monovalent substituent have the same meaning as that of an example of a monovalent substituent of R, X, Y and Z in the formula (I), and preferable examples are the same. And, m₁ represents an integer of 0 to 3.

The R₁, R₂, X₁, X₂, Y₁, Y₂, Z₁ and Z₂ will be explained in more detail below.

Examples of a substituent of R₁ and R₂ each have independently the same meaning as that of an example of R in the formula (I), and a preferable example is the same.

Examples of a substituent of Y₁ and Y₂ each independently have the same meaning as that of an example of Y in the formula (I), and a preferable example is the same.

Examples of a substituent of Z₁ and Z₂ each have independently the same meaning as that of an example of Z in the formula (I), and a preferable example is the same.

The G and m₁ will be explained in more detail below.

G represents an atom group constituting a 5- to 8-membered nitrogen-containing heterocycle.

Preferable examples of a 5- to 8-membered nitrogen-containing heterocycle represented by G include a S-triazine ring, a pyrimidine ring, a pyridazine ring, a pyrazine ring, a pyridine ring, an imidazole ring, a pyrazole ring, and a pyrrole ring and, among these, a S-triazine ring, a pyrimidine ring, a pyridazine ring, or a pyrazine ring is more preferable, and a S-triazine ring is most preferable.

And, mᵢ represents an integer of 0 to 3 and, when a —OM group may replace at a structure of a preferable example of a 5- to 8-membered nitrogen-containing heterocycle represented by G, 0 to 2 is preferable and, among these, 0 or 1 is preferable, and m₁=1 is particularly most preferable.

The M will be explained in more detail below.

M represents a hydrogen atom or a cation.

Examples of a cation represented by M include an alkali metal ion, ammonium and a quaternary ammonium cation, preferably Li, Na, K, NH₄ and NR₄. R is an alkyl group or an aryl group, and is the same as the aforementioned example of an alkyl group or an aryl group represented by R or Y. Among them, a preferable example of a cation of M is Li, Na, K or NH₄, and Li, Na or K is particularly preferable.

As a combination of preferable substituents of a coloring matter represented by the formula (1) of the invention, a compound in which at least one of various substituents is the aforementioned preferable group is preferable, a compound in which more various substituents are the aforementioned preferable groups is more preferable, and a compound in which all substituents are the aforementioned preferable groups is most preferable.

A particularly preferable combination as a coloring matter represented by the formula (1) of the invention includes the following (a) to (f):

(a) R₁ and R₂ may be the same or different, a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 is preferable and, among these, a straight alkyl group or a branched alkyl group of a total carbon atom number of C1-C8 is preferable, a secondary or tertiary alkyl group is particularly preferable, and a t-butyl group is most preferable.

(b) X₁ and X₂ may be the same or different, an electron-withdrawing group having a Hammett substituent constant σp value of 0.20 or more is preferable, an electron-withdrawing group of 0.30 or more is further preferable, and an electron-withdrawing group of 1.0 or less is an upper limit. Among them, a cyano group, an alkylsulfonyl group having a carbon number of 1 to 12, an arylsulfonyl group having a carbon number of 6 to 18, or a sulfamoyl group having a carbon number of 0 to 12 is preferable, and a cyano group or an alkylsulfonyl group having a carbon number of 1 to 12 is most preferable.

(c) Y₁ and Y₂ may be the same or different, a hydrogen atom, a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 is preferable, a hydrogen atom, or a substituted or unsubstituted alkyl group is further preferable and, among these, a hydrogen atom is most preferable.

(d) Z₁ and Z₂ may be the same or different, a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 is preferable, a substituted or unsubstituted aryl group, or a substituted or unsubstituted heterocyclic group is further preferable and, particulary, a substituted aryl group is most preferable.

(e) G represents an atom group constituting a 5- to 8-membered nitrogen-containing heterocycle, preferable examples of a 5- to 8-membered nitrogen-containing heterocycle include a S-triazine ring, a pyrimidine ring, a pyridazine ring, a pyrazine ring, a pyridine ring, an imidazole ring, a pyrazole ring, and a pyrrole ring and, among these, a S-triazine ring, a pyrimidine ring, a pyridazine ring, or a pyrazine ring is more preferable, and a S-triazine ring is most preferable.

(f) And, mᵢ represents an integer of 0 to 3 and, when a —OM group can replace at a structure of a preferable example of a 5- to 8-membered nitrogen-containing heterocycle represented by G, 0 to 2 is preferable and, among these, 0 or 1 is preferable and, particularly, m₁=1 is most preferable.

(g) M is preferably a hydrogen atom or a cation, particularly preferably a hydrogen atom, an alkali metal ion, ammonium or a quaternary ammonium cation, further preferably Li, La, K, or NH₄.

The formula (1-1) will be explained in detail below.

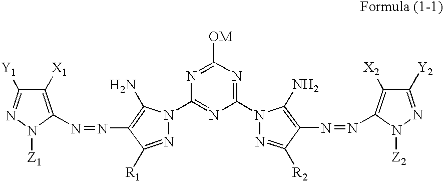

R₁, R₂, Y₁ and Y₂ represent a monovalent group, and X₁ and X₂ each independently represent an electron-withdrawing group having a Hammett σp value of 0.20 or more. Z₁ and Z₂ each independently represent a hydrogen atom, a substituted or unsubstituted alkyl group, a substituted or unsubstituted alkenyl group, a substituted or unsubstituted alkinyl group, a substituted or unsubstituted aralkyl group, a substituted or unsubstituted aryl group, or a substituted or unsubstituted heterocyclic group. M represents a hydrogen atom or a cation.

R₁, R₂, X₁, X₂, Y₁, Y₂, Z₁, Z₂ and M will be explained in detail below.

Examples of a substituent of R₁, R₂, Yᵢ and Y₂ are the same as the aforementioned examples of a substituent of R_{I}, R₂, Y₁ and Y₂ explained in the formula (1), and a preferable example is the same.

Examples of a substituent of X₁ and X₂ are the same as the aforementioned examples of a substituent of X₁ and X₂ explained in the formula (1), and a preferable example is the same.

Examples of a substituent of Z₁ and Z₂ are the same as the aforementioned examples of a substituent of Z₁ and Z₂ explained in the formula (1), and a preferable example is the same.

Examples of M are the same as the aforementioned examples of M explained in the formula (1), and a preferable example is the same.

Regarding a combination of preferable substituents of a coloring matter represented by the formula (1-1) of the invention, a compound in which at least one of various substituents is preferable, a compound in which more various substituents are the aforementioned preferable groups is more preferable, and a compound in which all substituents are the aforementioned preferable groups is most preferable.

A particularly preferable combination as the coloring matter represented by the formula (1-1) of the invention includes the following (a) to (e).

(a) R₁ and R₂ may be the same or different, a substituting or unsubstituted alkyl group having a total carbon number of C1-C12, a substituted or unsubstituted aryl group having a total carbon number of C6-C18, or a substituted or unsubstituted heterocyclic group having a total carbon number of C4-C12 heterocyclic group is preferable and, among these, a straight alkyl group or a branched alkyl group of a total carbon atom number of C1-C8 is preferable, a secondary or tertiary alkyl group is particularly preferable, and a t-butyl group is most preferable.

(b) X₁ and X₂ may be the same or different, an electron-withdrawing group having a Hammett substituent constant σp value of 0.20 or more is preferable, an electron-withdrawing group of 0.30 or more is further preferable, and an upper limit is an electron-withdrawing group of 1.0 or less. Among them, a cyano group, an alkylsulfonyl group having a carbon number of 1 to 12, an arylsulfonyl group having a carbon number of 6 to 18, or a sulfamoyl group having a carbon number of 0 to 12 is preferable, and a cyano group, or an alkylsulfonyl group having a carbon number of 1 to 12 is most preferable.

(c) Y₁ and Y₂ may be the same or different, a hydrogen atom, a substituted or unsubstituted alkyl group having a total carbon number of C1-C12, a substituted or unsubstituted aryl group having a total carbon number of C6-C18, or a substituted or unsubstituted heterocyclic group having a total carbon number of C4-C12 is preferable, a hydrogen atom, or a substituted or unsubstituted alkyl group is further preferable and, among these, a hydrogen atom is most preferable.

(d) Z₁ and Z₂ may be the same or different, a substituted or unsubstituted alkyl group having a total carbon number of C1-C12, a substituted or unsubstituted aryl group having a total carbon number of C6-C18, a substituted or unsubstituted heterocyclic group having a total carbon number of C4-C12 is preferable, a substituted or unsubstituted aryl group, or a substituted or unsubstituted heterocyclic group is further preferable, and a substituted aryl group is particularly preferable.

(e) M is preferably a hydrogen atom or a cation, particularly preferably a hydrogen atom, an alkali metal ion, ammonium or a quaternary ammonium cation, further preferably Li, Na, K, or NH₄.

In the invention, when a compound represented by the formula (I), (1) or (1-1) needs hydrophilicity, it is preferable that the compound has two or more ionic hydrophilic groups in a molecule, it is further preferable that the compound has 2 to 10 ionic hydrophilic groups in a molecule, and it is particularly preferable that the compound has 3 to 6 ionic hydrophilic groups in a molecule.

When water is not used as a medium, it is not necessary that the compound has an ionic hydrophilic group.

As an ionic hydrophilic group, any group may be used as far as it is an ionic dissociating group. Specific examples include a sulfo group, a carboxyl group (including a salt thereof), a hydroxy group (which may be a salt), a phosphono group (which may be a salt) and quaternary ammonium.

Preferable are a sulfo group, a carboxyl group, and a hydroxy group (including a salt thereof).

When an ionic hydrophilic group is a salt, preferable examples of a counter cation include an alkali metal (e.g. lithium sodium, potassium), ammonium, and an organic cation (e.g. pyridinium, tetramethylammonium, guanidium) and, among these, an alkali metal is preferable and, particularly, in the case of a sulfo group, a lithium salt is preferable and, in the case of a carboxyl group, a sodium salt and/or a potassium salt is preferable.

When a coloring matter represented by the formula (I), (1) or (1-1) is a water-soluble coloring matter, from a viewpoint of a color reproductivity, the coloring matter has a maximum absorption wavelength (λmax) of preferably 380 to 490 nm, further preferably 400 to 480 nm, particularly preferable 420 to 460 nm in H₂O.

Examples of the coloring matter represented by the formula (I) (1) or (1-1) (exemplified coloring matters DYE-1 to 26) will be shown below, however a coloring matter used in the invention is not limited to the following examples.

In addition, a structure of the following examples is shown in a form of a free acid, however it is needless to say that the coloring matter may be used as an arbitrary salt.

Examples of a preferable counter cation include an alkali metal (e.g. lithium, sodium, potassium), ammonium, and an organic cation (e.g. pyridinium, tetramethylammonium, guanidium).

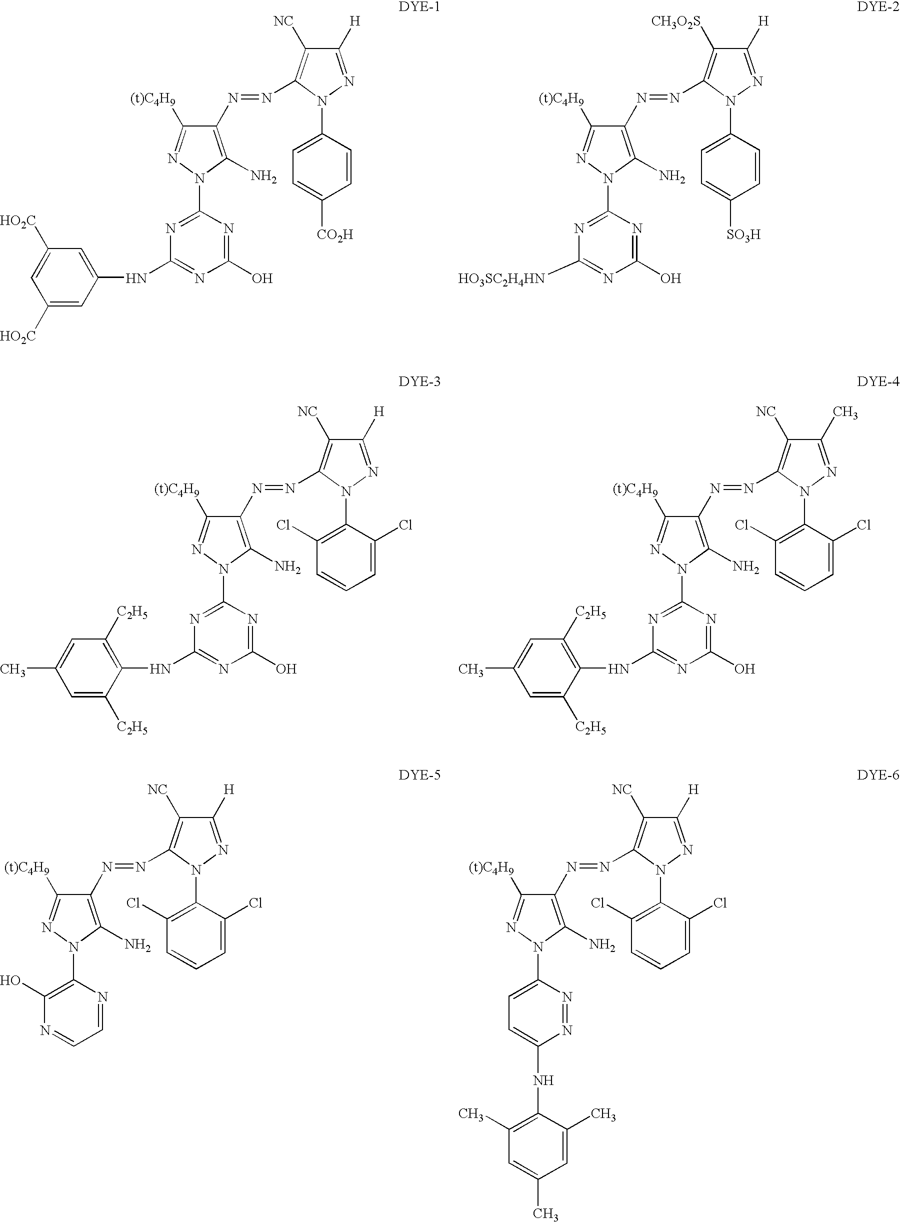

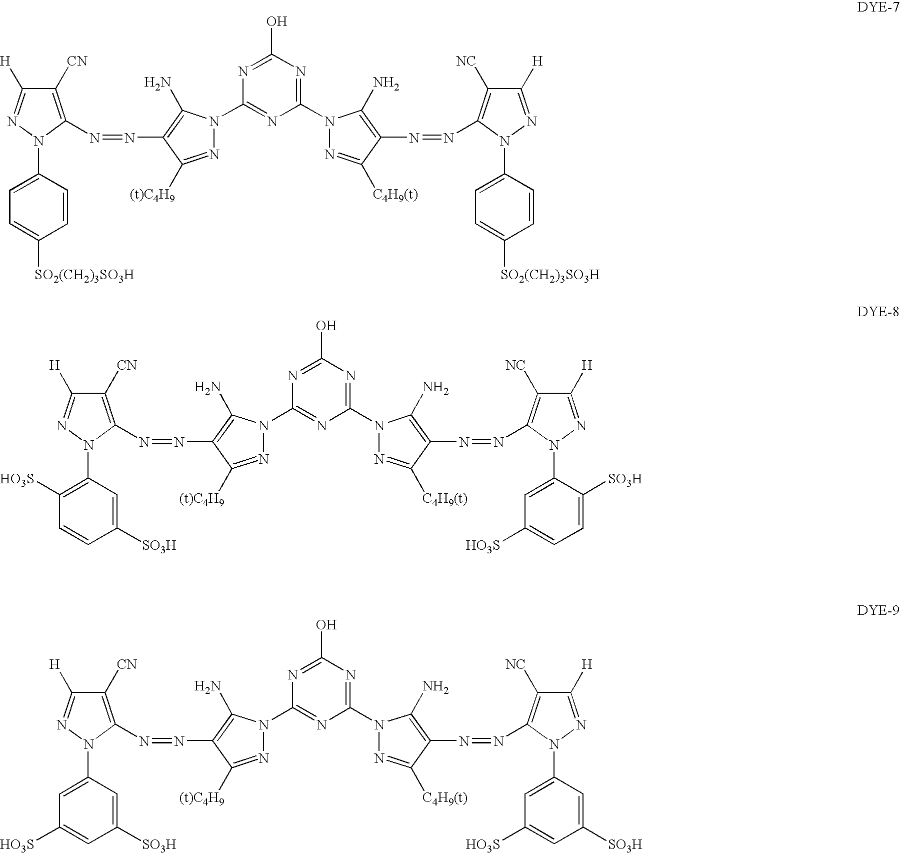

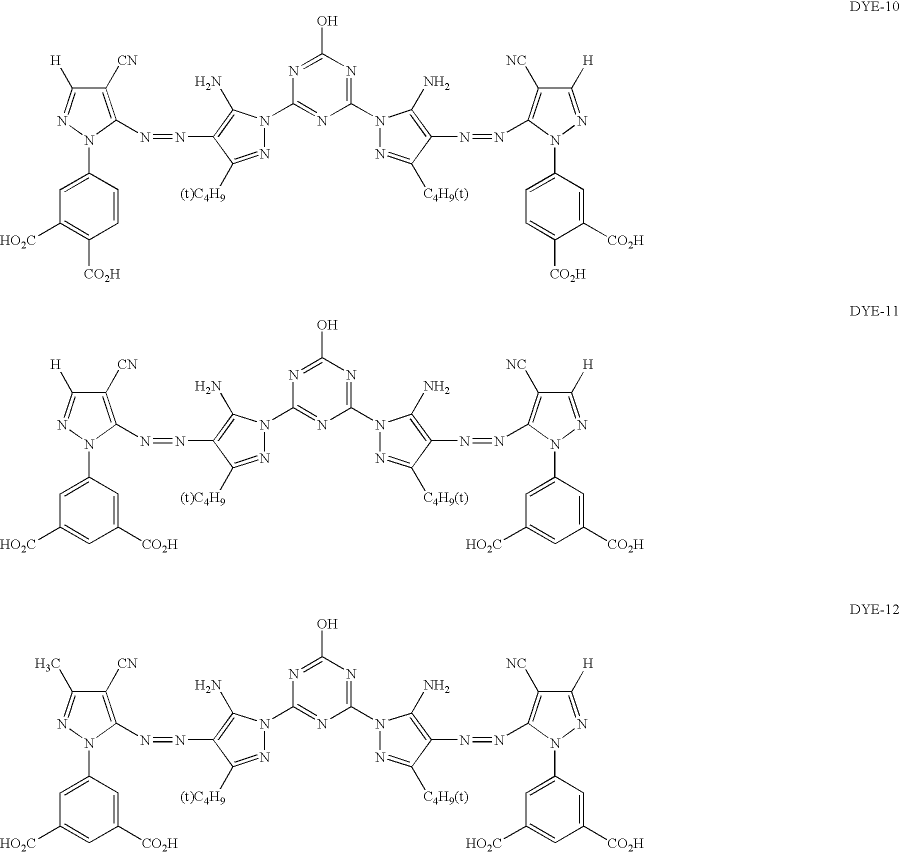

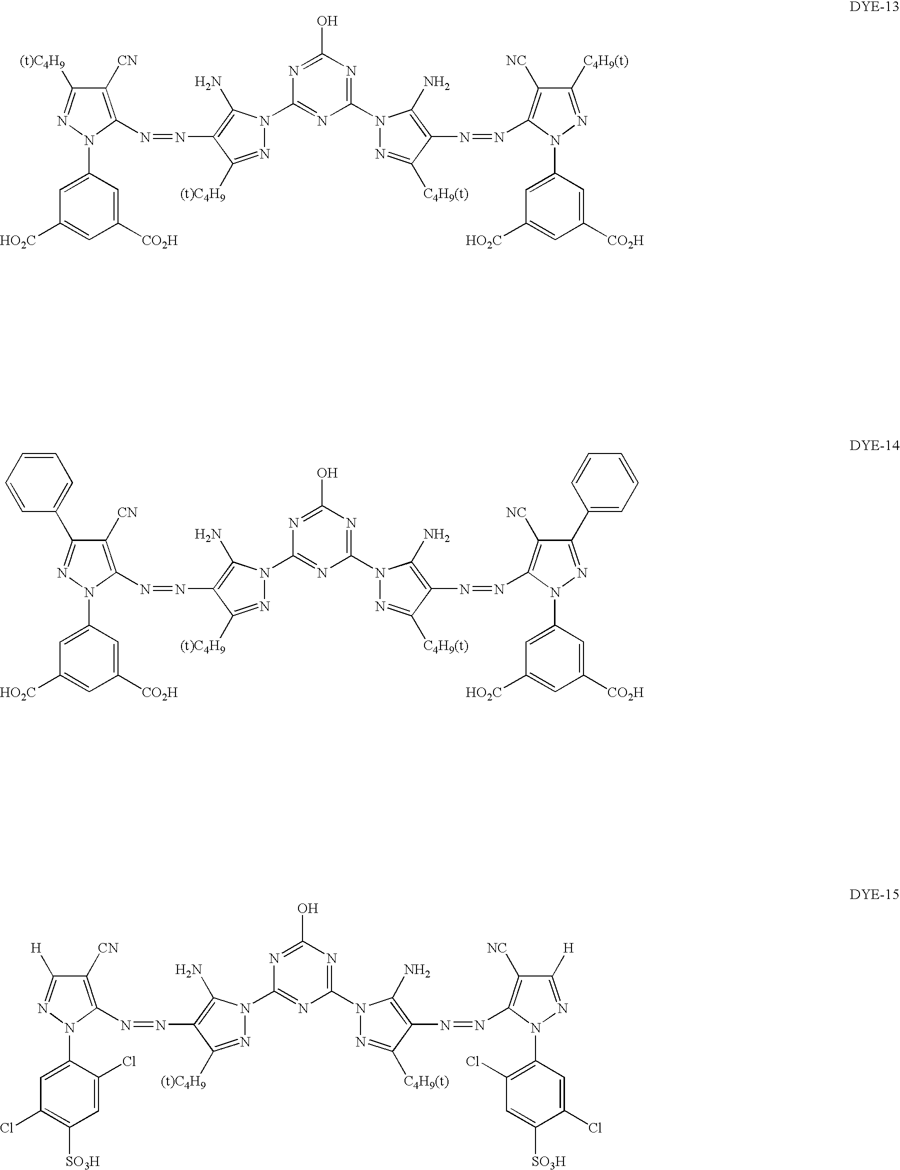

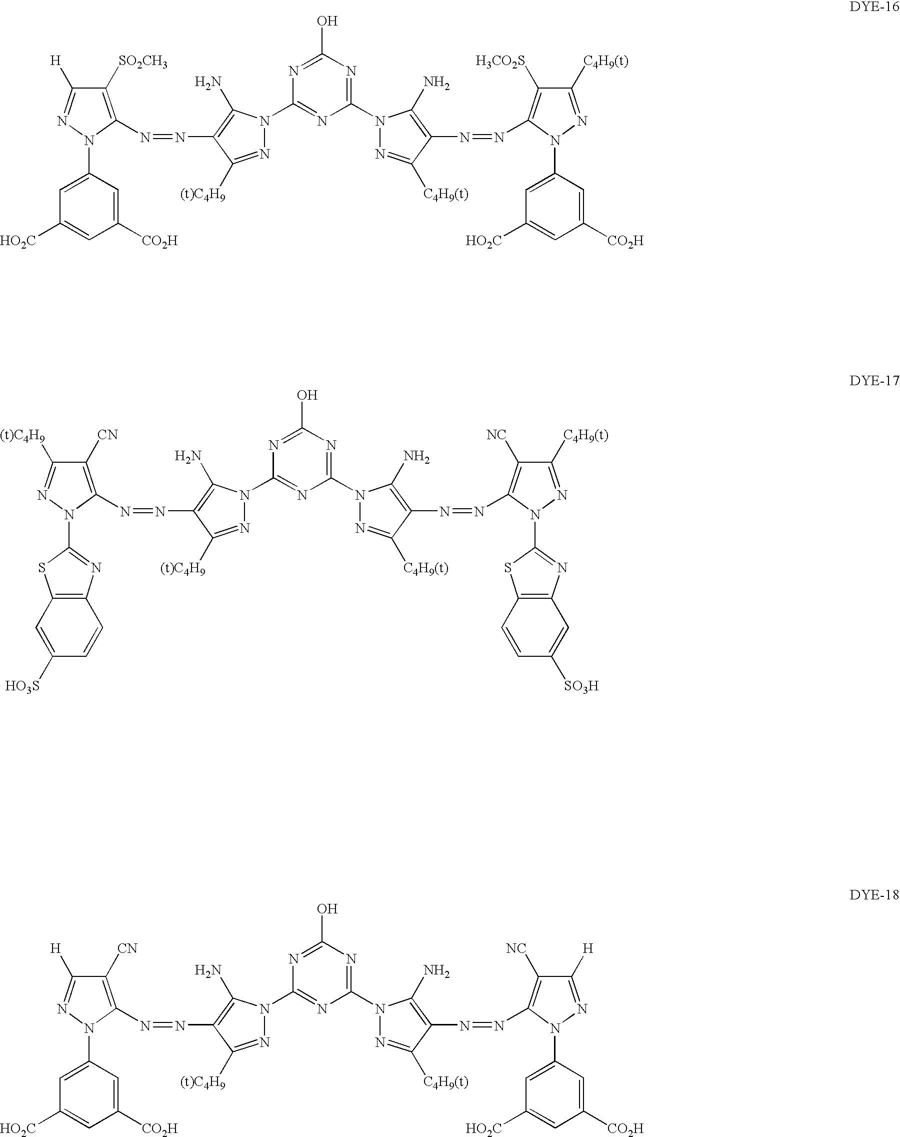

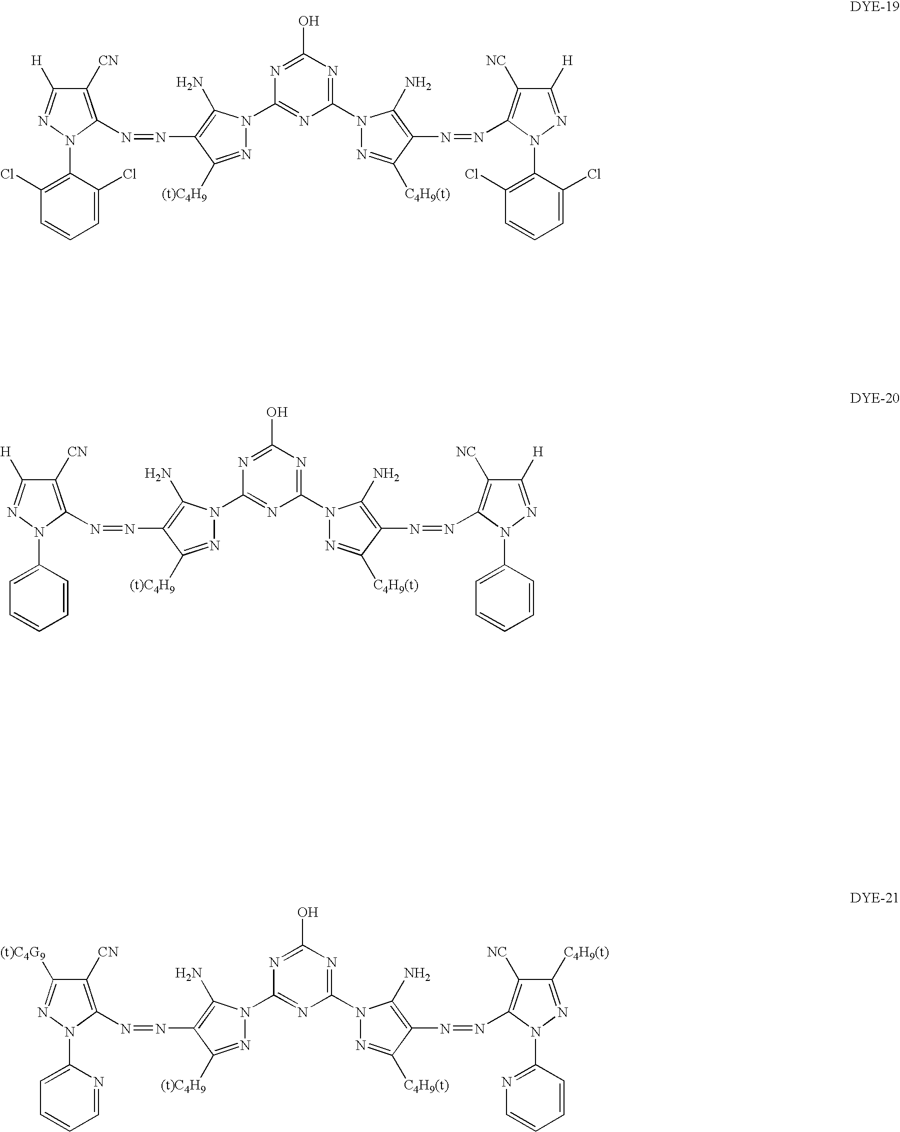

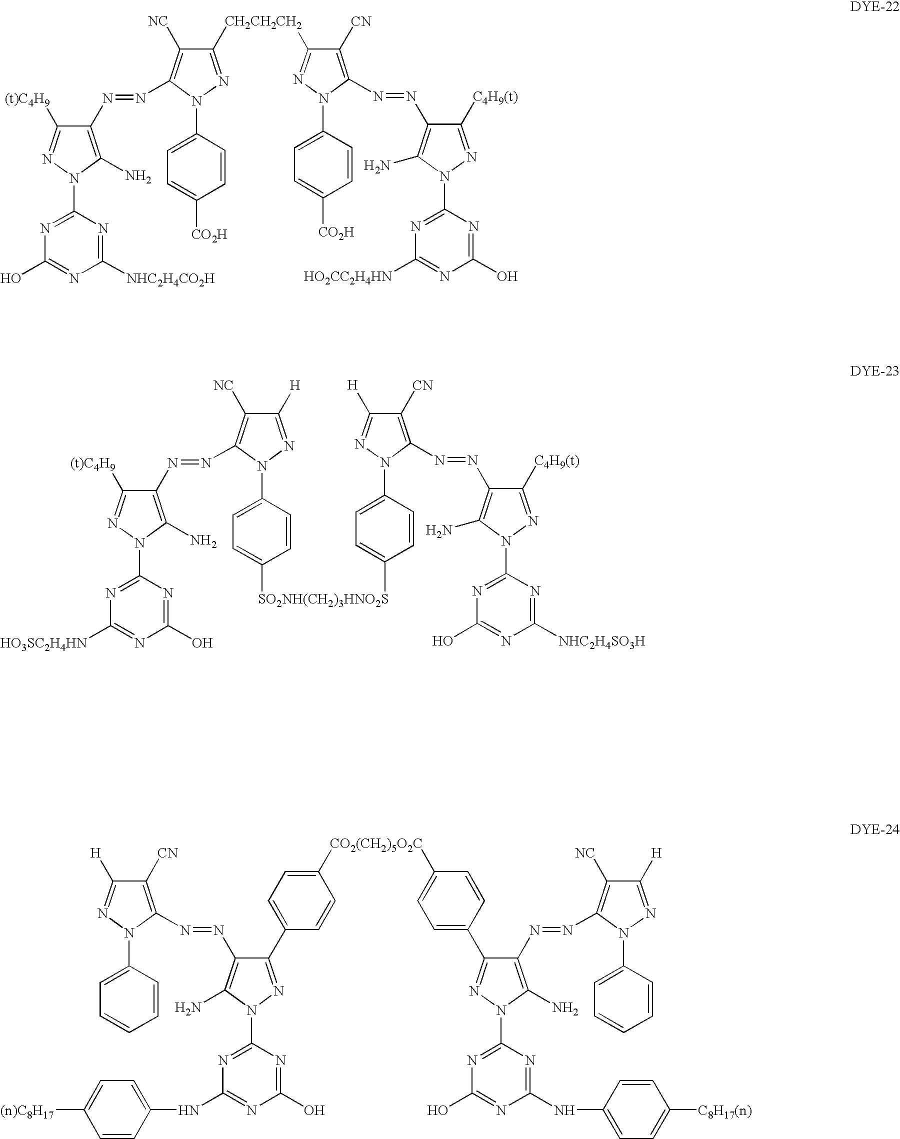

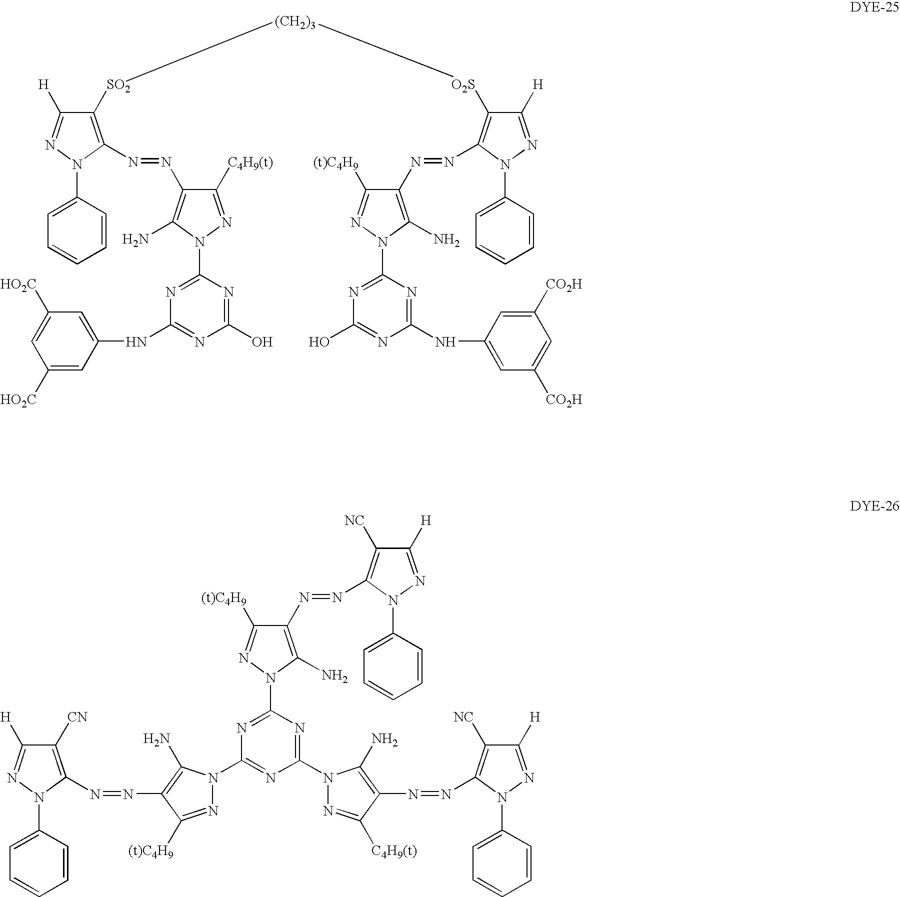

A coloring matter represented by the formula (I) can be synthesized by the following synthesis method. In addition, a method of synthesizing an intermediate of a coloring matter represented by the formula (I) will be also described.

### 1) Synthesis of Coupling Component:

As a coupling component (a coloring matter intermediate which reacts with a diazonium salt to derive an azo dye) used upon synthesis of a coloring matter represented by the formula (I), a compound represented by the following formula (2) is preferable.

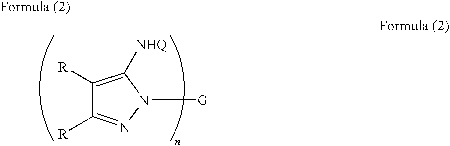

In the formula (2), substituents R, G and Q each have independently the same meaning as that of R, G and Q in the formula (I), and a preferable example is the same.

In the formula (2), n represents an integer of 1 to 3.

P represents a hydrogen atom or a leaving group. A leaving group means a group which is eliminated in a chemical reaction, and represents, for example, a group which is eliminated in a coupling reaction with a diazonium salt, or a group which easily causes an addition elimination reaction with an oxidized entity of a phenylene diamine derivative. Preferable examples of P include a hydrogen atom, a halogen atom, an alkyloxy group, an aryloxy group, an alkylthio group, and an arylthio group. Among them, a hydrogen atom and a halogen atom are preferable, and a hydrogen atom is most preferable.

Further preferable examples of a coupling component represented by the formula (2) include a compound represented by the following formula (3), or a salt or hydrate thereof.

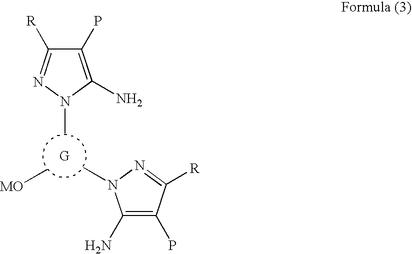

Substituents R, G and P in the formula (3) each have the same meaning as that of R, G and P in the formula (2), and a preferable example is the same.

M in the formula (3) represents a hydrogen atom or a cation. When M represents a cation, M has the same meaning as that of M in the formula (1), and a preferable example is the same.

Particularly preferable examples of a coupling component represented by the formula (3) include a compound represented by the following formula (4), and a salt or hydrate thereof.

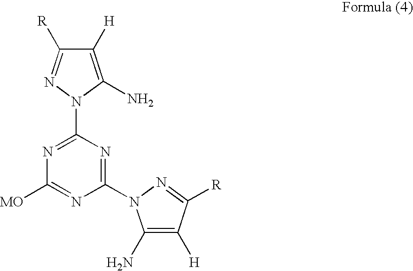

Substituents Rs in the formula (4) each have independently the same meaning as that of R in the formula (2), and a preferable example is the same.

M in the formula (4) has the same meaning as that of M in the formula (3), and a preferable example is the same.

A method of synthesizing a coupling component represented by the formula (3) will be explained below.

A compound represented by the formula (3) can be obtained, for example, according to the following steps.

The method is a method of synthesizing a compound represented by the formula (3); (hereinafter, referred to as 5-aminopyrazole compound) by (a) a step of acting a base on a mixture of an organic compound (a) having a halogen atom which is eliminable to hydrazine, and water, (b) a step of mixing the reaction solution obtained in the (a) step with hydrazine to obtain a hydrazine derivative, and (c) a step of reacting the hydrazine derivative obtained in the (b) with an acylacetonitrile compound under the presence of an acid and an organic solvent.

Examples of the organic compound (a) include cyanuric chloride, 2-chloropyrimidine, 2,4-dichloropyrimidine, 2,4,6-trichloropyrimidine, 3-chloropyridazine, 3,5-dichloropyridazine, 5-chloropyrazole, and 2-chloroimiazole. Cyanuric chloride, 2,4,6-trichloropyrimidine, 3,5-dichloropyridazine, and 2-chloroimidazole are preferable and, among these, cyanuric chloride, and 2,4,6-trichloropyrimidine are preferable and, particularly, cyanuric chloride is most preferable.

First, as a (a) step, a base is acted on a mixture of an organic compound (a) and water. In the invention, as a preferable reaction solvent for producing a hydrazine derivative, water can be used like this. An amount of water to be used is preferably 0.5 to 50-fold mass, more preferably 1 to 20-fold mass based on an organic compound (a).

In the invention, an organic compound (a) is preferably in the state where it is dispersed in water, and can be in the aqueous solution state depending on a kind of an organic compound (a).

A solvent for a mixture of an organic compound (a) and water contains water (10 to 100% by mass, preferably 50 to 100% by mass of a total solvent) as a main component and, optionally, a solvent other than water may be used. Examples of such the solvent include dimethylformamide, dimethylacetamide, and dimethyl sulfoxide.

A base includes an inorganic base and an organic base. Examples of the inorganic base include sodium hydroxide, lithium hydroxide, potassium hydroxide, sodium bicarbonate, sodium carbonate, potassium carbonate, potassium acetate, sodium acetate, and lithium acetate, preferably sodium hydroxide, sodium dicarbonate, and potassium carbonate, further preferably sodium bicarbonate, and sodium hydroxide. Examples of the organic base include ammonia, hydrazine, triethylamine, diazobicycloundecene, pyridine, 2,6-dimethylpyridine, and dimethylaminopyridine, preferably ammonia, hydrazine, triethylamine and pyrizine, further preferably ammonia and hydrazine. An amount of a base to be used is preferably 0.05 to 30.0 equivalent, more preferably 0.5 to 15.0 equivalent relative to an amount of an organic compound (α) to be used.

A reaction temperature is preferably 5° C. to 80° C., more preferably 10° C. to 60° C.

A reaction time is preferably 30 minutes to 6 hours, more preferably 1 hour to 3 hours.

Subsequently, as a (b) step, the reaction solution obtained in the (a) step and hydrazine are mixed to react them, thereby, a hydrazine derivative is produced. A ratio of addition of an organic compound (a) and hydrazine, for example as expressed by former: latter (molar ratio) is preferably 1:1 to 1:20, more preferably 1:2 to 1:10.

A reaction temperature in the (b) step is preferably 0° C. to 90° C., more preferably 0° C. to 80° C., further preferably 0° C. to 65° C. When a reaction temperature is lower than 0° C., a reaction rate is remarkably lowered, and a time necessary in synthesis becomes remarkably longer, being not economical. When synthesis is performed at a high temperature exceeding 90° C., and an amount of a byproduct is increased, being not preferable.

A reaction time in (b) step is preferably 30 minutes to 300 minutes, more preferably 30 minutes to 200 minutes, further preferably 30 minutes to 150 minutes.

A reaction scheme where cyanuric chloride is used as an organic compound (a), and sodium bicarbonate is used as a base will be shown below.

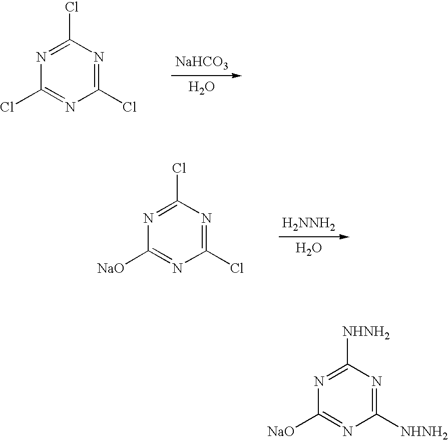

The hydrazine derivative can be reacted with an acylacetonitrile compound under the presence of an acid and an organic solvent to synthesize a 5-aminopyrazole compound.

The hydrazine derivative may be prepared by the present application, or may be prepared by a method other than the present application.

As an organic solvent, particularly, a solvent in which an intermediate obtained by addition of a hydrazine derivative and an acylacetonitrile compound (hereinafter, simply referred to as intermediate) is dissolved, and a 5-aminopyrazole compound is precipitated from a reaction system to suppress production of a reaction byproduct, is desired.

In the invention; an organic solvent is a solvent which does not cause liquid separation phenomenon at a reaction, and exhibits a uniform solution with a solvent. Examples include alcoholic organic solvents such as methanol, ethanol, propanol, isopropanol, butanol, t-butyl alcohol, and amyl alcohol, ketone-based organic solvents such as acetone, and methyl ethyl ketone, diol-based organic solvents such as ethylene glycol, diethylene glycol, triethylene glycol, propylene glycol, dipropylene glycol, and 1,3-propanediol, ether-based organic solvents such as ethylene glycol monomethyl ether, ethylene glycol monoethyl ether, and ethylene glycol diethyl ether, and tetrahydrofuran, dioxane, and acetonitrile, and these solvents may be a mixed solution of two or more kinds.

Preferable is an organic solvent having a value of a polarity parameter (ET) of 40 or more. Among these, a glycol-based solvent having two or more hydroxy groups in a solvent molecule, or an alcohol-based solvent of a carbon atom number of 3 or less, preferably an alcohol solvent of a carbon atom number of 2 or less is preferable. A mixed solvent of them is included.

As an organic solvent, among these, an organic solvent having a hydroxyl group is preferable. Examples of a more preferable alcohol include methanol, and ethanol. Alternatively, glycols such as oligo-(particularly di- or tri-) and poly-C₂-C₄-alkylene glycol are also preferable. In addition, an ethylene-based compound is also advantageous. Examples include ethylene glycol, 1,2- or 1,3-propylene glycol, diethylene glycol, butylene glycol, di-, tri- or tetraethylene glycol, di-, tri- or tetrapropylene glycol, polyethylene- or polypropylene glycol, and glycerin.

More preferable examples include ethanol, ethylene glycol, diethylene glycol, triethylene glycol, polypropylene glycol, propylene glycol, dipropylene glycol, glycerin, a 1:2 (v/v) mixed solvent of ethylene glycol and diethylene glycol, a 3:1 (v/v) mixed solvent of propylene glycol and triethylene glycol, a 1:2 to 3 (v/v) mixed solvent of methanol and ethylene glycol, and a 1:2 to 5 (v/v) mixed solvent of methanol and triethylene glycol. An amount of a solvent to be used is 1 to 100-fold mass, preferably 1 to 50-fold mass, further preferably 1 to 20-fold mass of a compound represented by the formula (I).

An acid is not particularly limited, but inorganic acids such as hydrochloric acid, phosphoric acid, sulfuric acid and nitric acid, and organic acids such as methanesulfonic acid are also effective. An amount to be used is 1 to 100-fold mass, preferably 1 to 20-fold mass, further preferably 1 to 10-fold mass of the hydrazine derivative. When an amount of an acid is small, solubility of an intermediate is deteriorated, and a reaction time becomes longer and, when an amount of an acid is too large, a byproduct is produced at a large amount, leading to a deteriorated yield in some cases.

Examples of an acyl group in an acylacetonitrile compound include an acetyl group, a pivaloyl group, an isopropylcarbonyl group, a phenethylcarbonyl group, a 2-naphthylcarbonyl group, and a 2-pyridylcarbonyl group. Particularly preferable are an acetyl group, a pivaloyl group, an isopropylcarbonyl group, and a phenethylcarbonyl group.

An acylacetonitrile compound may be added at a ratio of preferably 1 to 5, more preferably 1 to 3, letting the mole number of hydrazines of a hydrazine derivative to be 1.

A temperature for reacting a hydrazine derivative and acylacetonitrile compound is preferably 0° C. to 120° C., more preferably 0° C. to 100° C., further preferably 0° C. to 75° C.

A reaction time is preferably 1 hour to 20 hours, more preferably 1 hour to 15 hours, further preferably 1 hour to 10 hours.

A reaction scheme of a series of steps of a process for producing a hydrazine derivative, and a process for producing a 5-aminopyrazole compound using a hydrazine derivative produced by this will be shown below. The following scheme shows the case where cyanuric chloride is used as an organic compound (α) of a starting material, sodium bicarbonate is used as a base, pivaloylacetonitrile is used as an acylacetonitrile compound, hydrochloric acid is used as an acid, and a mixed solvent of methanol and ethylene glycol is used as an organic solvent, however the invention is not limited to this.

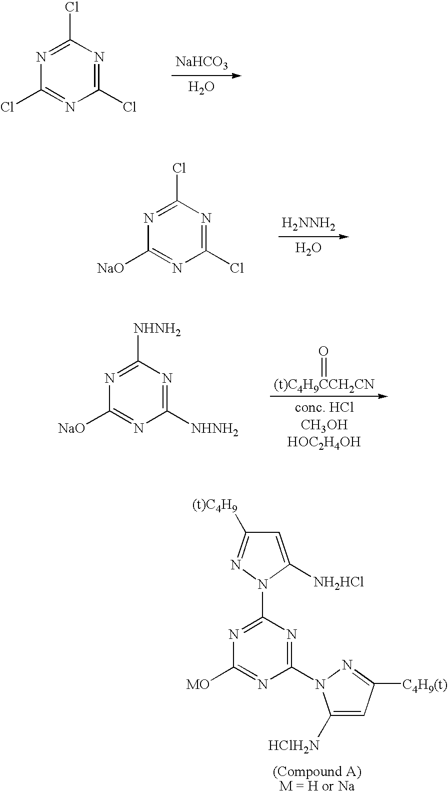

### <2>Synthesis of Diazo Component

As a diazo component (a coloring matter intermediate which derives a diazonium salt) used upon synthesis of a coloring matter represented by the formula (I), a compound represented by the following formula (5) is preferable.

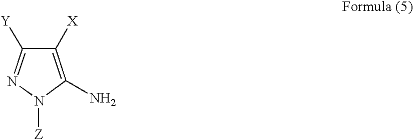

Substituents X, Y and Z in the formula (5) have the same meanings as those of X, Y and Z in the formula (I), respectively, and a preferable example is the same.

A compound represented by the formula (5) can be obtained, for example, according to the following reaction formula. In the formula, R represents a lower alkyl group, and —OW represents a leaving group.

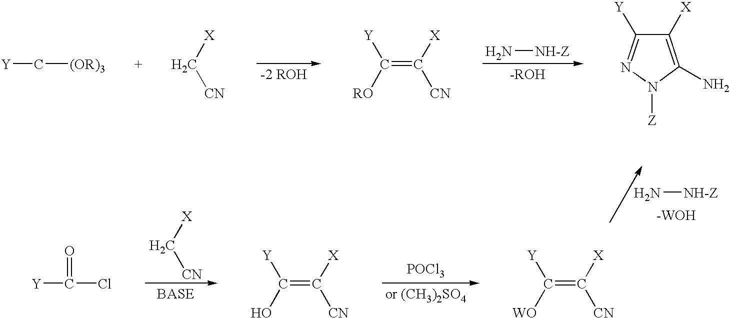

### <3>Synthesis of Coloring Matter Represented by the Formula (I)

A coloring matter of the invention can be synthesized, for example, by azo coupling-reacting a diazonium salt prepared by the known method as a diazo component of the formula (5) with a coupling component of the formula (2) or (3).

Preparation of a diazonium salt and a coupling reaction can be performed by a conventional method.

As preparation of a diazonium salt of the formula (5), for example, a conventional method of preparing a diazonium salt using a nitrosonium ion source, for example, nitrous acid, nitrite or nitrosylsulfuric acid in an acid (e.g. hydrochloric acid, sulfuric acid, phosphoric acid, acetic acid, propionic acid, methanesulfonic acid, trifluoromethanesulfonic acid etc.)-containing reaction medium can be applied.

Examples of a more preferable acid include the case where acetic acid, propionic acid, methanesulfonic acid, phosphoric acid and sulfuric acid are used alone, or in combination thereof and, among these, a system of using acetic acid and/or propionic acid and sulfuric acid is particularly preferable.

As a preferable example of a reaction medium (solvent), an organic acid or an inorganic acid is preferably used, and phosphoric acid, sulfuric acid, acetic acid, propionic acid, and methanesulfonic acid are particularly preferable and, among these, acetic acid and/or propionic acid is preferable.

As an example of a preferable nitrosonium ion source, when nitrosylsulfuric acid is used in the aforementioned preferable acid-containing reaction medium, a diazonium salt can be prepared stably and effectively.

An amount of a solvent to be used is preferably 0.5 to 50-fold mass, more preferably 1 to 20-fold mass, and particularly preferably 3 to 10-fold mass based on a diazo component of the Formula (5).

In the invention, a diazo component of the Formula (5) may be either in the state where it is dispersed in a solvent, or where it is dissolved in a solution, depending on a kind of a diazo component.

An amount of a nitrosonium ion source to be used is preferably 0.95 to 5.0 equivalent, more preferably 1.00 to 3.00 equivalent, particularly preferably 1.00 to 1.10 equivalent based on a diazo component.

A reaction temperature is preferably −15° C. to 30° C., more preferably −10° C. to 10° C., further preferably −5° C. to 5° C.

When the temperature is lower than −10° C., a reaction rate is remarkably delayed, and a time necessary for synthesis becomes remarkably longer, being not economical. On the other hand, when synthesis is performed at a high temperature exceeding 30° C., an amount of a byproduct is increased, being not preferable.

A reaction time is preferably 30 minutes to 300 minutes, more preferably 30 minutes to 200 minutes, further preferably 30 minutes to 150 minutes.

A coupling compound (azo coloring matter forming step) can be performed in an acidic reaction medium to in a basic reaction medium, it is preferable that, in the azo coloring matter of the invention, the reaction is performed in an acidic to neutral reaction medium and, particularly, when the reaction is performed in an acidic reaction medium, degradation of a diazonium salt is suppressed, and an azo coloring matter can be derivatized at a better yield.

As a preferable example of a reaction medium (solvent), an organic acid, an inorganic acid or an organic solvent can be used. Particularly, an organic solvent is preferable, and a solvent, which does not cause liquid separation phenomenon, and exhibits, a uniform solution with a solvent at a reaction is preferable. Examples include alcoholic organic solvents such as methanol, ethanol, propanol, isopropanol, butanol, t-butyl alcohol, and amyl alcohol, ketone-based organic solvents such as acetone, and methyl ethyl ketone, diol-based organic solvents such as ethylene glycol, diethylene glycol, triethylene glycol, propylene glycol, dipropylene glycol, and 1,3-propane diol, ether-based organic solvents such as ethylene glycol monomethyl ether, ethylene glycol monoethyl ether, and ethylene glycol diethyl ether, and tetrahydrofuran, dioxane and acetonitrile, and these solvents may be a mixed solution of two or more kinds.

Preferable is an organic solvent having a value of a polarity parameter (ET) of 40. Among these, a glycol-based solvent having two or more hydroxy groups in a solvent molecule, or an alcohol-based solvent of a carbon atom number of 3 or less, preferably an alcohol solvent of a carbon atom number of 2 or less (e.g. methanol, ethylene glycol) is preferable. A mixed solvent of them is also included.

An amount of a solvent to be used is preferably 1 to 100-fold mass, more preferably 1 to 50-fold mass, further preferably 2 to 10-fold mass of a coupling component represented by the formula (2) or (3).

In the invention, a coupling component of the formula (2) or (3) may be either in the state where it is dispersed in a solvent, or where it is dissolved in a solution, depending on a kind of a coupling component.

An amount of a coupling component to be used is such that a diazo component is preferably 0.95 to 5.0 equivalent, more preferably 1.00 to 3.00 equivalent, particularly preferably 1.00 to 1.50 equivalent per azo coupling site.

A reaction temperature is preferably −30° C. to 30° C., more preferably −15° C. to 10° C., further preferably −10° C. to 5° C. When the temperature is lower than −30° C., a reaction rate is remarkably delayed, and a time necessary for synthesis becomes remarkably longer, being not economical. On the other hand, when synthesis is performed at a high temperature exceeding 30° C., an amount of a byproduct is increased, being not preferable.

A reaction time is preferably 30 minutes to 300 minutes, more preferably 30 minutes to 200 minutes, further preferably 30 minutes to 150 minutes.

In a method of synthesizing an azo coloring matter of the invention, a product (azo coloring matter) obtained by the reaction is treated according to a conventional post-treatment method of an organic synthesis reaction, and may be supplied after purification, or without purification.

That is, for example, the product freed from a reaction system can be supplied without purification, or by performing procedures of purification such as recrystallization, salt formation, and column chromatography (e.g. gel permeation chromatography (SEPHADEX™ LH-20: manufactured by Pharmacia) alone, or a combination thereof.

Alternatively, after completion of the reaction, the reaction solvent is distilled off, or is not distilled off, the reaction is poured into water or an ice, neutralized or not neutralized, and the freed product may be supplied, without purification, or after procedures of purification such as recrystallization, salt formation, and column chromatography are performed alone, or in combination thereof.

Alternatively, after completion of the reaction, the reaction solvent is distilled off, or is not distilled off, the reaction is poured into water or an ice, neutralized or not neutralized, and extracted with an organic solvent/an aqueous solution, the product is not purified, or subjected to procedures of purification such as crystallization, salt formation, and column chromatography alone or in combination thereof, thereafter, the product can be supplied.

In an ink in the invention, a coloring matter represented by the formula (I) can be used alone, or a plurality of coloring matters can be used in combination.

In 100 parts by mass of an ink in the invention, a coloring matter represented by the formula (I) is contained at 0.1 parts by mass or more and 20 parts by mass or less, more preferably 0.2 parts by mass or more and 10 parts by mass or less, further preferably 0.5 to 9 parts by mass.

When a content of the coloring matter is less than 0.1 parts by mass, sufficient image fastness cannot be obtained in some cases and, when the content exceeds 20 parts by mass, ink stability and draining property become deteriorated in some cases.

In addition, in an ink for ink jet in the invention, in addition to the aforementioned compound (coloring matter) according to the invention, other known coloring matters may be used in combination as far as the effect of the invention is not deteriorated. In this case, a ratio of other coloring matter relative to a compound represented by the formula (I) is not particularly limited, but any ratio may be used.

When two or more kinds of coloring matters are used in combination, it is preferable that a total of contents of coloring matters is in the aforementioned range of a coloring matter addition amount.

An azo coloring matter represented by the formula (I) used in an ink in the invention is a novel compound. Examples of utility of such the coloring matter include an image recording material for forming an image, particularly, a color image, a representative of which is an ink in the invention, specifically, a heat-sensitive recording material, a pressure-sensitive recording material, a recording material using an electrophotography method, a transfer-type silver halide photosensitive material, a printing ink, and a recording pen including an ink jet-type recording material which will be described in detail below, preferably an ink jet-type recording material, a heat-sensitive recording material, and a recording material using an electrophotography method, further preferably an ink jet-type recording material.

Alternatively, the coloring matter can be also applied to a color filter for recording and reproducing a color image used in a solid-state image sensing device such as CCD, or a display such as LCD and PDP, or a staining liquid for staining various fibers.

A coloring matter represented by the formula (I) is used by adjusting physical properties such as solubility, dispersibility and heat transferring property suitable in the utility with a substituent. In addition, the coloring matter of the invention can be used in the dissolved state, the emulsification dispersed state, or the solid dispersed state, depending on a system for which the coloring matter is used.

(Ink Component Other than Coloring Matter Represented by the Formula (I))

An ink in the invention contains a coloring matter represented by the formula (I), and may contain a medium in addition to the coloring matter.

An ink in the invention can be prepared by dissolving and/or dispersing the coloring matter in a lipophilic medium or an aqueous medium as a medium. Preferably, an aqueous medium is used. An ink in the invention includes an ink composition except for a medium.

In an ink in the invention, other additive may be used in such a range that the effect of the invention is not adversely influenced, if necessary.

Examples of other additive which can be used include the known additives such as a drying preventing agent (wetting agent), a fading preventing agent, an emulsification stabilizer, a permeation promoter, an ultraviolet absorbing agent, an antiseptic, a mold preventing agent, a pH adjusting agent, a surface tension adjusting agent, an antifoaming agent, a viscosity adjusting agent, a dispersant, a dispersion stabilizer, a rust preventive, and a chelating agent.

These various additives are directly added to an ink liquid in the case of a water-soluble ink.

When an oil-soluble dye is used in a form of a dispersion, additives are generally added to a dispersion after preparation of a dye dispersion, and additives may be added to an oil phase or an aqueous phase at preparation.

The drying preventing agent is suitably used for the purpose of preventing choking due to drying of an ink for ink jet in an ink ejecting port of a nozzle used in an ink jet recording method.

As the drying preventing agent, a water-soluble organic solvent having a lower vapor pressure than that of water is preferable. Specific examples include polyhydric alcohols, a representative of which is ethylene glycol, propylene glycol, diethylene glycol, polyethylene glycol, polyethylene glycol, thiodiglycol, dithiodiglycol, 2-methyl-1,3-propanediol, 1,2,6-hexanetriol, acetyleneglycol derivative, glycerin, and trimethylolpropane, lower alkyl ethers of polyhydric alcohols such as ethylene glycol monomethyl (or ethyl)ether, diethylene glycol monomethyl (or ethyl)ether, and triethylene glycol monoethyl (or butyl)ether, heterocycles such as 2-pyrrolidone, N-methyl-2-pyrrolidone, 1,3-dimethyl-2-imidazolidinone, and N-ethylmorpholine, sulfur-containing compounds such as sulfolane, dimethyl sulfoxide, and 3-sulfolene, polyfunctional compounds such as diacetonealcohol, and diethanolamine, and urea derivatives. Among them, a polyhydric alcohol such as glycerin, diethylene glycol and triethylene glycol is more preferable. The drying preventing agents may be used alone, or two or more kinds may be used in combination. It is preferable that these drying preventing agents are contained at 10 to 50% by mass in an ink.

The permeation promoter is suitably used for the purpose of permeating an ink for ink jet into a paper better. As the permeation promoter, alcohols such as ethanol, isopropanol, butanol, di(tri)ethylene glycol monobutyl ether, and 1,2-hexanediol, sodium laurylsulfate, sodium oleate, and nonionic surfactants can be used. When these are contained at 5 to 30% by mass in an ink, there is usually the sufficient effect, and it is preferable that they are used in such an addition amount range that blurring of printing, and print through are not caused.

The ultraviolet absorbing agent is used for the purpose of improving retainability of an image. As the ultraviolet absorbing agent, benzotriazole-based compounds described in JP-A Nos. 58-185677, and 61-190537, and JP-A Nos. 2-782, 5-197075, and 9-34057, benzophenone-based compounds described in JP-A No. 46-2784, and JP-A No. 5-194483, and U.S. Pat. No. 3,214,463, cinnamic acid-based compounds described in JP-B Nos. 48-30492, and 56-21141, and JP-A No. 10-88106, triazine-based compounds described in JP-A Nos. 4-298503, 8-53427, 8-239368, and 10-182621, and Japanese Patent Application National Publication (Laid-Open) No. 8-501291, compounds described in Research Disclosure No. 24239, and compounds which absorb ultraviolet-ray and emit fluorescence, so-called fluorescent brightening agents, a representative of which is stilbene-based or benzoxazole-based compounds, can be used.

The fading preventing agent is used for the purpose of improving retainability of an image. As the fading preventing agent, various organic and metal complex-based fading-preventing agents can be used. Examples of the organic fading-preventing agent include hydroquinones, alkoxyphenols, dialkoxyphenols, phenols, anilines, amines, indanes, chromans, alkoxyanilines, and heterocycles, and examples of the metal complex include nickel complexes, and zinc complexes. More specifically, compounds described in patents cited in Research Disclosure No. 17643, VII, Ito J items, same No. 15162, same No. 18716 page 650 left column, same No. 36544 page 527, same No. 307105 page 872, and same No. 15162, and compounds included in the formula of a representative compound and compound examples described in JP-A No. 62-215272, pages 127-137 can be used.

Examples of the mold-preventing agent include sodium dehydroacetate, sodium benzoate, sodium pyridinethione-1-oxide, p-hydroxybenzoic acid ethyl ester, and 1,2-benzisothiazoline-3-one and a salt thereof. It is preferable that the agent is used at 0.02 to 1.00% by mass in an ink.

As the pH-adjusting agent, the aforementioned neutralizing agent (organic base, inorganic alkali) can be used. The pH-adjusting agent is added so that a pH of an ink for ink jet becomes preferably 6 to 10, more preferably 7 to 10, for the purpose of improving storage stability of the ink for ink jet.

Examples of the surface tension adjusting agent include nonionic, cationic or anionic surfactants. A surface tension of an ink for ink jet in the invention is preferably 20 to 60 mN/m, further preferably 25 to 45 mN/m. A viscosity of an ink for ink jet in the invention is adjusted to preferably 30 mPa·s or less, further preferably 20 mPa·s or less. As the surfactant, anionic surfactants such as fatty acid salt, alkylsulfate ester salt, alkylbenzenesulfonate salt, alkylnaphthalenesulfonate salt, dialkylsulfosuccinate salt, alkylphosphate ester salt, naphthalenesulfonic acid formalin condensate, and polyoxyethylene alkylsulfate ester salt, and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkylamine, glycerin fatty acid ester, and oxyethylene oxypropylene block copolymer are preferable. Alternatively, SURFYNOLS (AirProducts & Chemicals), which is an acetylene-based polyoxyethylene oxide surfactant, is also preferably used. In addition, an amine oxide-type amphoteric surfactant such as N,N-dimethyl-N-alkylamine oxide is also preferable. Further, surfactants described in JP-A No. 59-157636, page 37-38, and Research Disclosure No. 308119 (1989) can be also used.

As the antifoaming agent, a fluorine-based or silicone-based compound, and a chelating agent, a representative of which is EDTA, can be used, if necessary.

When an ink in the invention is prepared by dispersing a coloring matter represented by the formula (I) in an aqueous medium, it is preferable that a coloring fine particle containing a coloring matter and an oil-soluble polymer is dispersed in an aqueous medium as described in JP-A Nos. 11-286637, 2001-240763, 2001-262039, and 2001-247788, or a coloring matter represented by the formula (I), a representative of which is a coloring matter in the invention, dissolved in a high boiling point organic solvent is dispersed in an aqueous medium as described in JP-A Nos. 2001-262018, 2001-240763, 2001-335734 and 2002-80772. As a specific method, an oil-soluble polymer, a high boiling point organic solvent, and an additive to be used, and a use amount thereof when a coloring matter of the invention is dispersed in an aqueous medium, those described in the specification can be preferably used.

Alternatively, a coloring matter represented by the formula (I) may be dispersed as a solid into the fine particle state. When it is dispersed, a dispersant and a surfactant can be used. As a dispersing apparatus, a simple stirrer or impeller stirring method, an in-line stirring method, a mill method (e.g. colloid mill, ball mill, sand mill, attritor, roll mill, agitator mill etc.), an ultrasound method, and a high pressure emulsification and dispersing method (high pressure homogenizer; as a specific commercially available apparatus, Golin homogenizer, Microfluidizer, DeBEE2000 etc.) can be used.

Regarding a method of preparing an ink for ink jet recording, details are described in JP-A Nos. 5-148436, 5-295312, 7-97541, 7-82515, 7-118584, 11-286637, and 2001-230146 in addition to the aforementioned patents, and the method can be utilized also in preparation of an ink for ink jet recording in the invention.

The aqueous medium contains mater as a main component and, optionally, a mixture with a water-miscible organic solvent added thereto can be used. The water-miscible organic solvent include alcohols (e.g. methanol, ethanol, propanol, isopropanol, butanol, isobutanol, sec-butanol, t-butanol, pentanol, hexanol, cyclohexanol, benzyl alcohol), polyhydric alcohols (e.g. ethylene glycol, diethylene glycol, triethylene glycol, polyethylene glycol, propylene glycol, dipropylene glycol, polypropylene glycol, butylene glycol, hexanediol, pentanediol, glycerin, hexanetriol, thiodiglycol), glycol derivatives (e.g. ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, ethylene glycol monophenyl ether), amines (e.g. ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, tetramethylpropylenediamine) and other polar solvents (e.g. formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, acetone). The water-miscible organic solvents may be used in combination of two or more kinds.

An ink for ink jet recording in the invention can be used not only in formation of a mono color image, but also in formation of a full color image. For forming a full color image, a magenta tone ink, a cyan tone ink, and a yellow tone ink can be used and, for adjusting a tone, a black tone ink may be further used.

Further, in an ink for ink jet recording in the invention, another yellow dye can be used at the same time in addition to the aforementioned coloring matters in the invention. As an applicable yellow dye, an arbitrary dye can be used. For example, there are aryl or heterylazo dyes having, as a coupling component (hereinafter, referred to as coupler component), phenols, naphthols, anilines, heterocycles such as pyrazolone and pyridone, or closed-type active methylene compounds; azomethine dyes having, for example, closed-type active methylene compounds as a coupler component; methine dyes such as benzylidine dyes and monomethineoxonole dyes; quinone-based dyes such as naphthoquinone dyes and anthraquinone dyes. Examples of other dyes include quinophthalone dyes, nitro-nitroso dyes, acridine dyes, and acridinone dyes.

As an applicable magenta dye, an arbitrary dye can be used. Examples include aryl or heterylazo dyes having, as a coupler component, phenols, naphthols, or anilines; azomethine dyes having, as a coupler component, pyrazolones, or pyrazolotriazoles; methine dyes such as arylidene dyes, styryl dyes, merocyanine dyes, cyanines, and oxonole dyes; carbonium dyes such as diphenylmethane dyes, triphenylmethane dyes, and xanthene dyes; quinone dyes such as naphthoquinone, anthraquinone, and anthrapyridone; fused polycycle dyes such as dioxazine dyes.

As an applicable cyan dye, an arbitrary dye can be used. Examples include aryl or heterylazo dyes having, as a coupler component, phenols, naphthols, or anilines; azomethine dyes having, as a coupler component, phenols, naphthols, or heterocycles such as pyrolotriazole; polymethine dyes such as cyanine dyes, oxonole dyes, and merocyanine dyes; carbonium dyes such as diphenylmethane dyes, triphenylmethane dyes, and xanthene dyes; phthalocyanine dyes; anthraquinone dyes; indigo•thioindigo dyes.

The aforementioned respective dyes may be dyes which first exhibit each color of yellow, magenta and cyan by dissociation of a part of a chromophore, and a counter cation in that case may be an inorganic cation such as an alkali metal, and ammonium, an organic cation such as pyridinium and quaternary ammonium salt, or a polymer cation having them as a partial structure.

Examples of an applicable black material include a dispersion of carbon black in addition to disazo, trisazo and tetrazo dyes.

### [Ink Jet Recording Medium]

Then, an ink jet recording medium in the invention will be explained.

An ink jet recording medium in the invention comprises a water-soluble aluminum compound and a sulfoxide compound in an ink receiving layer on a support.

An ink jet recording medium in the invention, by containing a sulfoxide compound and a water-soluble aluminum compound in an ink receiving layer, has better ink absorbability and luster and, at the same time, sufficiently suppresses blurring of a recorded image for a long period of time and, by using as a set with an ink in the invention, light resistance and ozone resistance of an image are considerably improved.

A construction of an ink jet recording medium in the invention will be explained in detail below.

### <Ink Receiving Layer>

As described above, an ink receiving layer contains at least, at least one kind of a sulfoxide compound and at least one kind of a water-soluble aluminum compound.

### [Sulfoxide Compound]

It is preferable that the sulfoxide compound has one or more structures represented by the following formula (S1) in a molecule.

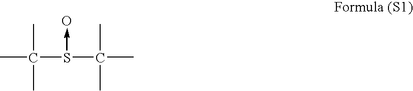

A sulfoxide compound having a structure represented by the formula (S1) may be substituted with a hydrophilic group. Examples of the hydrophilic group include a substituted or unsubstituted amino group, a substituted or unsubstituted carbamoyl group, a substituted or unsubstituted sulfamoyl group, substituted or unsubstituted ammonium, a hydroxyl group, sulfonic acid, carboxylic acid, phosphoric acid, ethyleneoxy acid, and a substituted or unsubstituted nitrogen containing heterocycle.

It is further preferable that the sulfoxide compound is a compound represented by the following formula (S2).

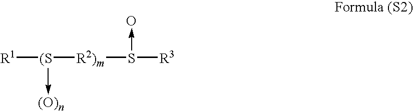

[In the formula (S2), R¹ and R³ each independently represent a substituted or unsubstituted alkyl group, a substituted or unsubstituted aryl group, a substituted or unsubstituted heterocyclic group, or a polymer residue consisting of it, R¹ and R³ may be the same or different, and may be connected to each other to form a ring, R² represents a substituted or unsubstituted di- to hexa-valent connecting group, R¹ and R², or R² and R³ may be connected to each other to form a ring, m represents an integer of 0 or 1 or more, n represents 0 or 1, and at least one of R¹, R² and R³ represents a substituted or unsubstituted amino group, a substituted or unsubstituted carbamoyl group, a substituted or unsubstituted sulfamoyl group, substituted or unsubstituted ammonium, a hydroxyl group, sulfonic acid, carboxylic acid, phosphoric acid, an ethyleneoxy group, or an alkyl group, an aryl group, a heterocyclic group or a polymer residue substituted with a hydrophilic group represented by a substituted or unsubstituted nitrogen-containing heterocycle]

In the formula (S2), the unsubstituent alkyl group represented by R¹ or R³ may be of a straight, branched or cyclic structure, and may have an unsaturated bond. For example, an alkyl group having a carbon number of 1 to 22 is preferable, and examples include a methyl group, an ethyl group, an ally group, a n-butyl group, a n-hexyl group, a n-octyl group, a benzyl group, an iso-propyl group, an iso-butyl group, a sec-butyl group, a cyclohexyl group, and a 2-ethylhexyl group. Among these, an alkyl group having a carbon number of 1 to 10 is more preferable, and a methyl group, an ethyl group, an allyl group, a n-propyl group, an iso-butyl group, a cyclohexyl group, and a 2-ethylhexyl group are particularly preferable.

As the unsubstituted aryl group represented by R¹ or R³, for example, an aryl group having a carbon number of 6 to 22 is preferable, examples include a phenyl group, a 1-naphthyl group, and a 2-naphthyl group, and among these, a phenyl group is particularly preferable.

Examples of the unsaturated heterocyclic group represented by R¹ or R³ include a thienyl group, a thiazolyl group, an oxazolyl group, a pyridyl group, a pyrazyl group, a thiadiazoyl group, a triazoyl group, a morpholyl group, a piperazyl group, a pyrimidyl group, a triazyl group, an indolyl group, a benzothiazoyl group, and a benzoxazoyl group and, among these, a thiazoyl group, an oxazoyl group, a pyridyl group, a thiadiazoyl group, a triazoyl group, a morpholyl group, a pyrimidyl group, a triazyl group, a benzothiazoyl group, and a benzoxazoyl group are particularly preferable.

When the R¹ or R³ represents a polymer residue consisting of a substituted or unsubstituted alkyl group, an aryl group, or a heterocyclic residue, examples of the polymer residue include polymers having the following unit.

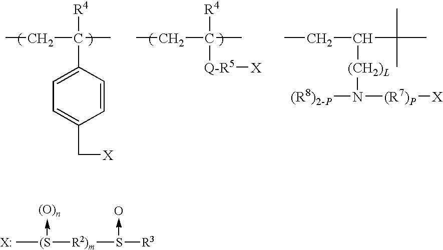

[R⁴ represents a hydrogen atom, or an alkyl group having a carbon number of 1 to R⁴, R⁵ represents an alkylene group, Q represents a connecting group, R⁷ and R⁸ represent an alkylene group, L represents 1 or 2, P represents 1 or 2, and R², R³, m and n have the same meanings as those of R², R³, m and n in the formula (S2)]

In the unit, examples of the connecting group represented by Q include the following connecting groups.

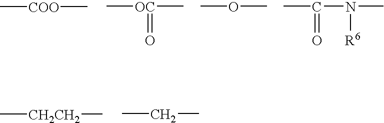

[R⁶ represents a hydrogen atom, an alkyl group or an aryl group]

Examples of a substituent when the R¹ or R³ represents an alkyl group, an aryl group or a heterocyclic resin, include a substituted or unsubstituted amino group (e.g. amino group having a carbon number of 30 or less, amino group, alkyl amino group, dialkyl amino group, aryl amino group, acyl amino group), a substituted or unsubstituted carbamoyl group (e.g. carbamoyl group having a carbon number of 30 or less, carbamoyl group, methylcarbamoyl group, dimethylcarbamoyl group, morpholinocarbamoyl group, piperidinocarbamoyl group), substituted or unsubstituted ammonium (e.g. ammonium of a carbon number of 30 or less, ammonium, trimethylammonium, triethylammonium, dimethylbenzylammonium, hydroxyethyldimethylammonium), a substituted or unsubstituted sulfamoyl group (e.g. sulfamoyl group having a carbon number of 30 or less, sulfamoyl group, methylsulfamoyl group, dimethylsulfamoyl group, morpholinosulfamoyl group, piperidionosulfamoyl group), a substituted or unsubstituted nitrogen-containing heterocycle (e.g. pyridyl group, pyrimidyl group, morpholino group, pyrrolidino group, a piperidino group, piperazyl group), a hydrophilic group represented by a hydroxyl group, sulfonic acid, carboxylic acid, phosphoric acid, and an ethyleneoxy group, a cyano group, a halogen atom (e.g. fluorine atom, chlorine atom, bromine atom), a substituted or unsubstituted alkoxycarbonyl group (e.g. alkoxycarbonyl group having a carbon number of 30 or less, methoxycarbonyl group, ethoxycarbonyl group, dimethylaminoethoxyethoxycarbonyl group, diethylaminoethoxycarbonyl group, hydroxyethoxycarbonyl group), a substituted or unsubstituted aryloxycarbonyl group (e.g. aryloxycarbonyl group having a carbon number of 30 or less, phenoxycarbonyl group), a substituted or unsubstituted alkoxy group (e.g. alkoxy group having a carbon number of 30 or less, a methoxy group, an ethoxy group, a phenoxyethoxy group, a butoxyethoxy group, a hydroxylethoxy group), a substituted or unsubstituted aryloxy group (e.g. aryloxy group-having a carbon number of 30 or less, phenoxy group), a substituted or unsubstituted acyloxy group (e.g. acyloxy group having a carbon number of 30 or less, acetyloxy group, propionyloxy group), and a substituted or unsubstituted acyl group (e.g. acyl group having a carbon number of 30 or less, acetyl group, propionyl group).

In addition, R¹ and R³ may be the same or different, and may be connected to each other to form a ring.

R² represents a substituted or unsubstituted di- to hexa-valent connecting group, and R¹ and R², or R² and R³ may be connected to each other to form a ring. Examples of a sulfur-containing heterocycle formed by mutual binding of R¹, R² and R³ include a thienyl group, a thiazoyl group, a thiazolysyl group, a dithiolan-2-yl group, a trithian-2-yl group, and a dithian-2-yl group.

Examples of the di- to hexa-valent connecting group represented by R² include connecting groups containing carbon, nitrogen, oxygen or phosphorus, and specific examples include the following connecting groups.

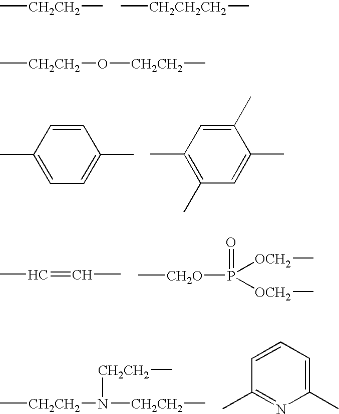

These connecting groups may contain a hetero bond such as an ether bond, an ester bond, an amino bond, an amido bond, and a urethane bond, and may further have a substituent. Alternatively, the connecting group may be a polymer in which those connecting groups are repeated. In that case, connecting groups may be the same or different.

At least any of R¹, R² and R³ represents a substituted or unsubstituted amino group, a substituted or unsubstituted carbamoyl group, a substituted or unsubstituted sulfamoyl group, substituted or unsubstituted ammonium, a hydroxyl group, sulfonic acid, carboxylic acid, phosphoric acid, an ethyleneoxy group, or an alkyl group, an aryl group, a heterocyclic group or a polymer residue substituted with a hydropholic group represented by a substituted or unsubstituted nitrogen-containing heterocycle. Examples of these hydrophilic groups include substituents described in the R¹ and R³.

Since an ink jet recording medium in the invention is used by substantially aqueous coating, the sulfoxide compound is preferably water-soluble.

In addition, a sulfoxide compound is a Lewis base, has higher water-solubility, and a large amount can be added as compared with a thioether compound.

When a sulfoxide compound according to the invention is water-soluble, it is preferably to be added to a coating solution or a basic solution containing a fine particle and a water-soluble resin described later.

In addition, when a sulfoxide compound relating the invention is oil-soluble, it is preferable that the compound is used by addition to a coating solution or a basic solution containing a fine particle and a water-soluble resin, by addition as an emulsification dispersant or an organic solvent.

In an ink jet recording medium in the invention, a content of the sulfoxide compound is preferably 0.01 to 20 g/m², more preferably 0.05 to 7 g/m² for further improving ozone resistance, image blurring resistance and luster.

In an ink jet recording medium in the invention, the sulfoxide compound generally has a higher oxidation potential as compared with the previous sulfur-containing compound (thioether, thioureas), and can exhibit higher ozone resistance and light resistance by combining with a coloring matter having a more advantageous higher oxidation potential, for the purpose of improving ozone resistance and light resistance.

The sulfoxide compound may be used alone, or two or more kinds may be used in combination.

Examples of the sulfoxide compound (exemplified compounds A-1 to A-75) will be shown below, however the invention is not limited to this.

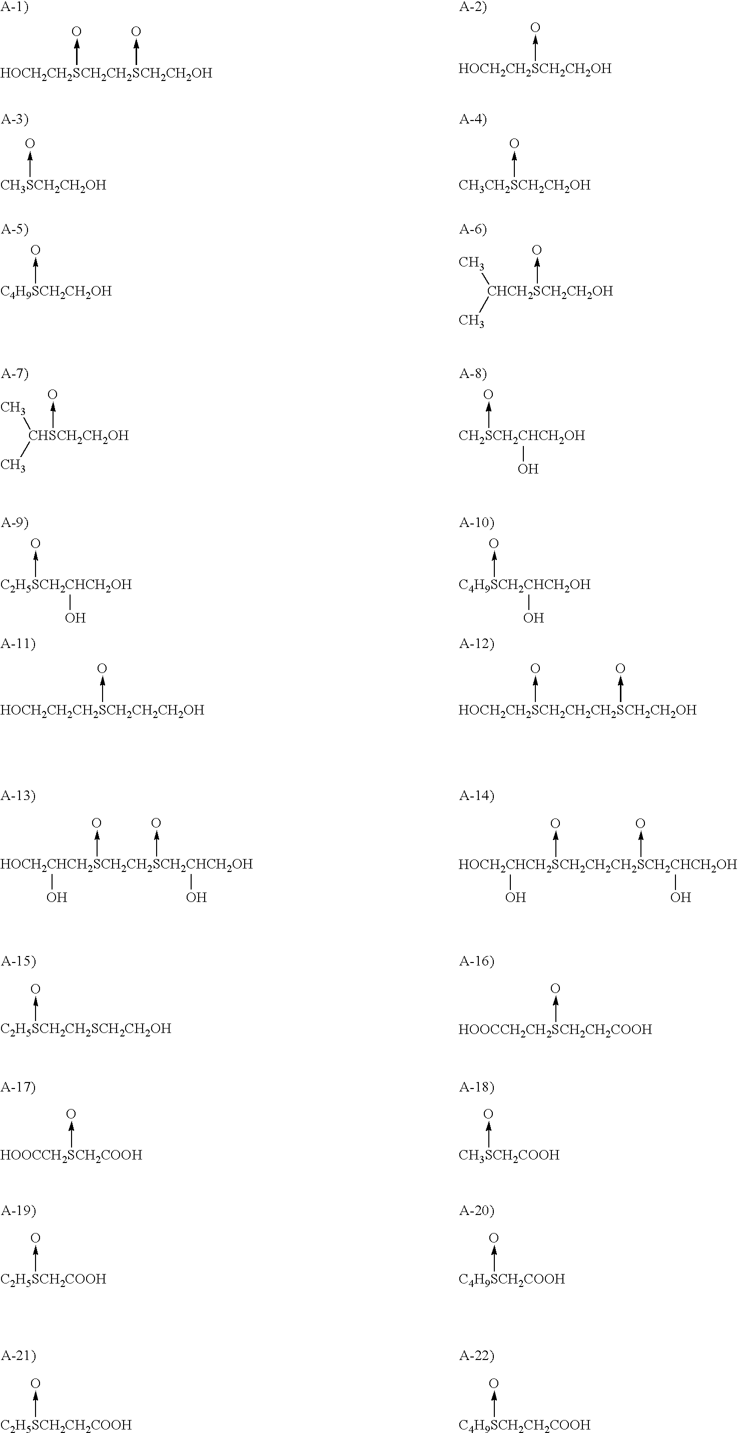

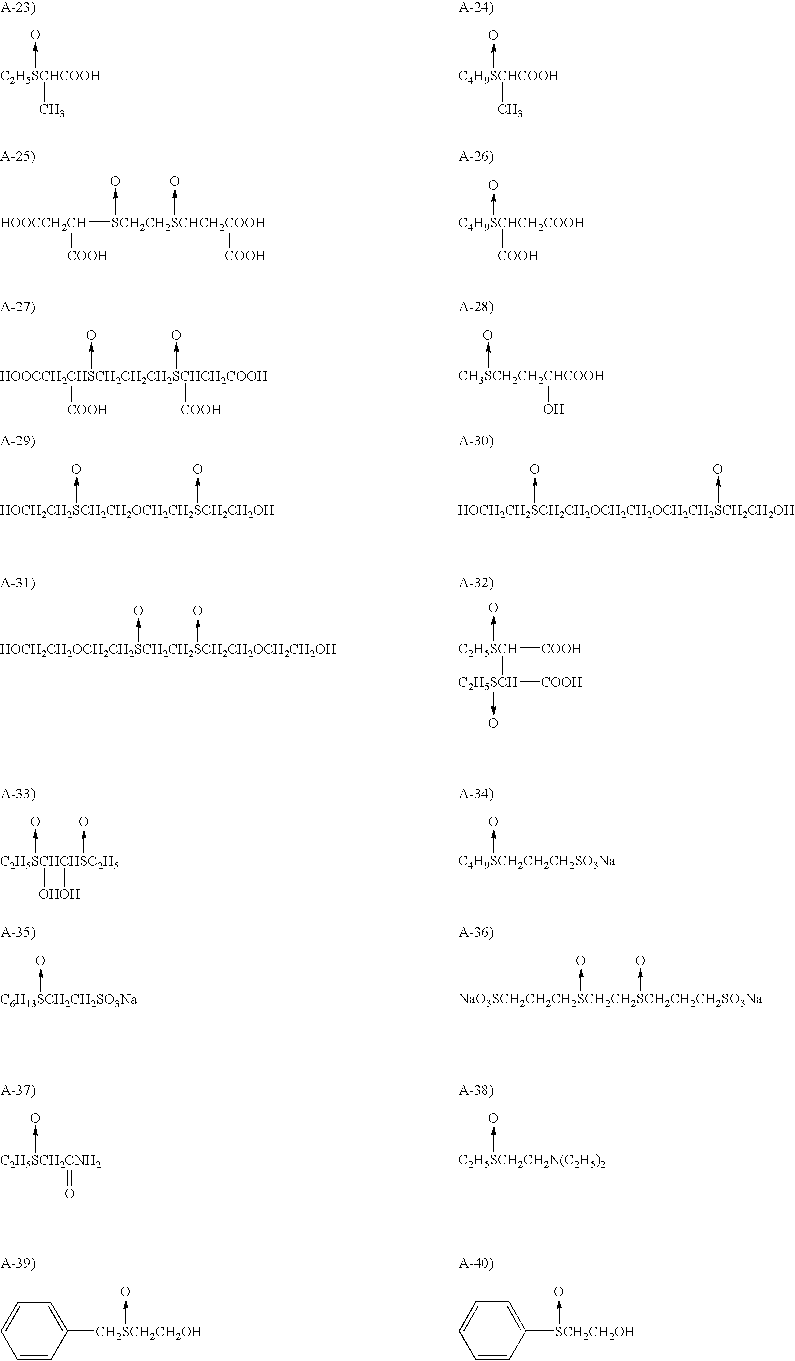

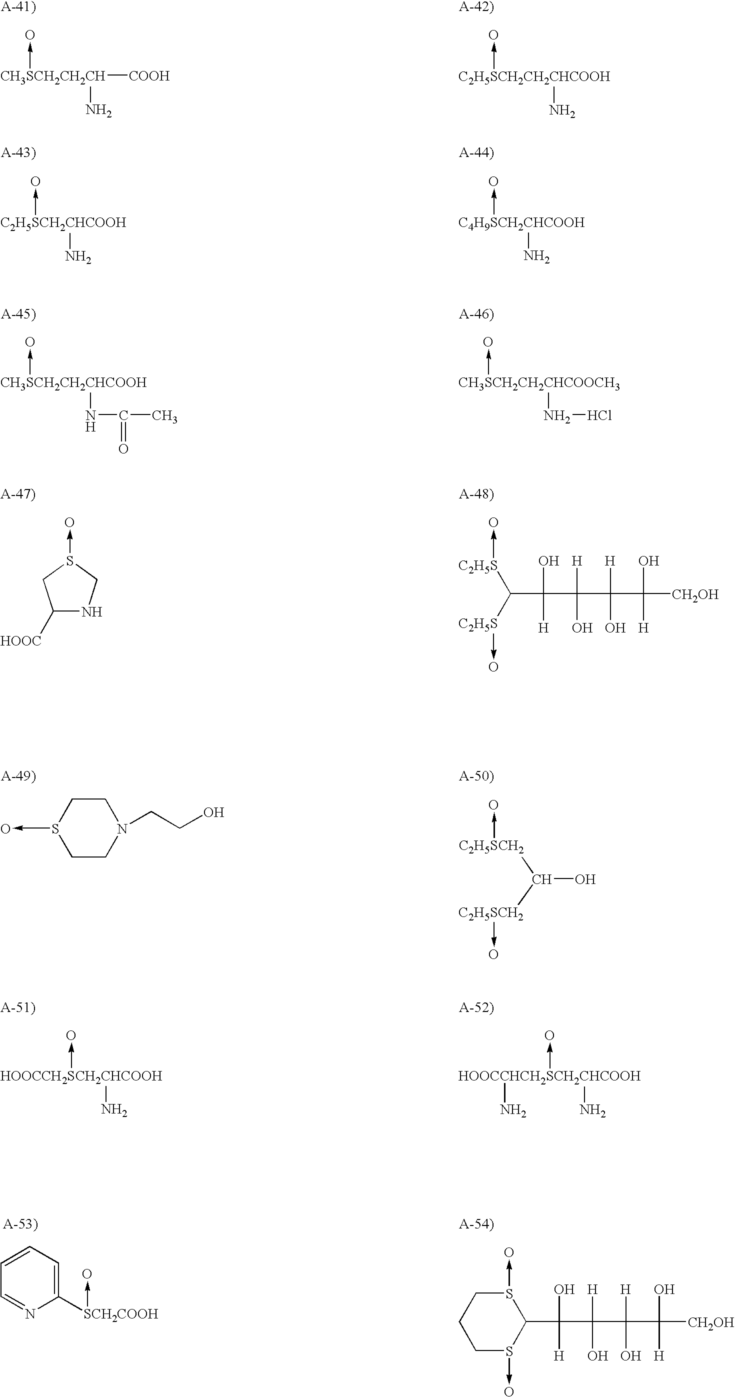

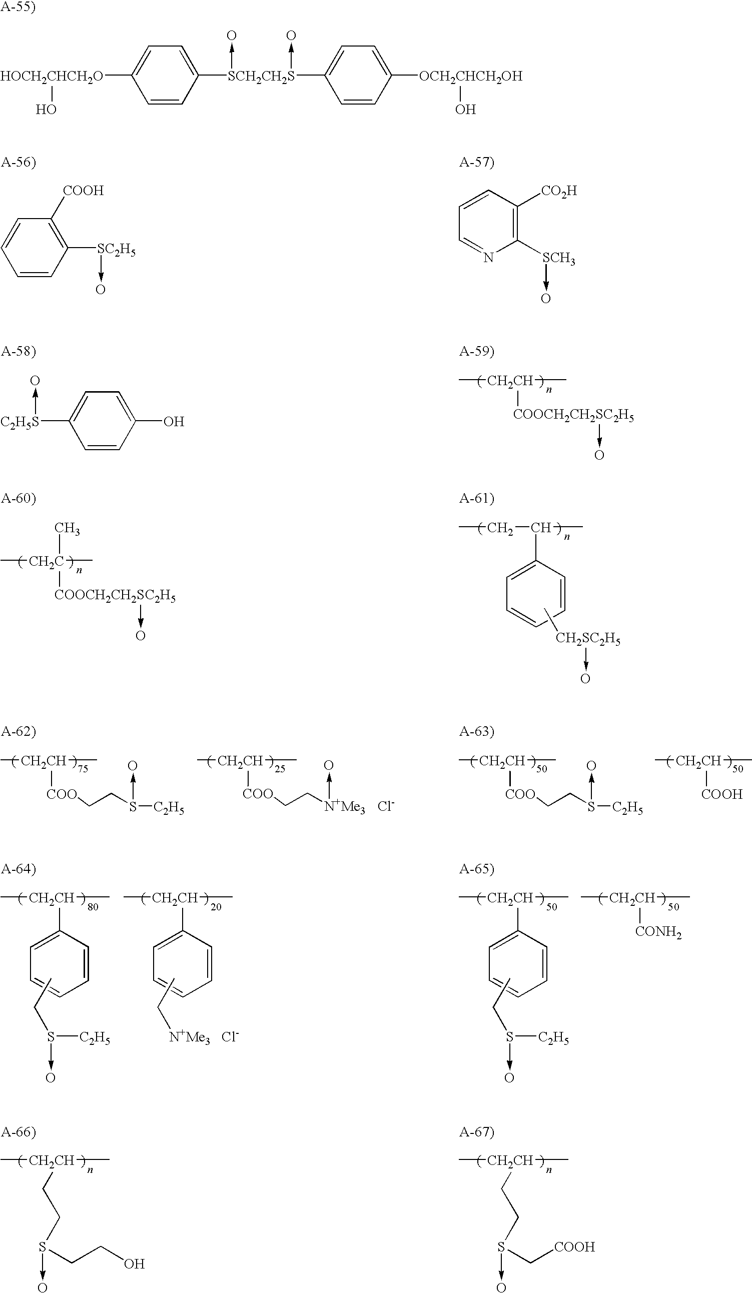

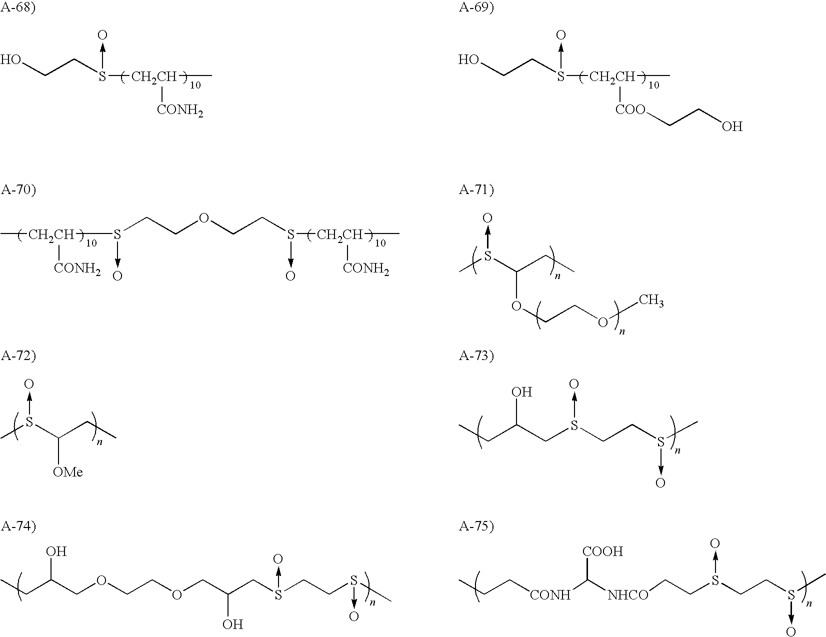

### [Water-Soluble Aluminum Compound]

Then, the water-soluble aluminum compound will be explained.

Specifically, examples of the water-soluble aluminum compound, which is used in combination with the sulfoxide compound, include the following compounds.

That is, examples include aluminum-containing compounds such as aluminum sulfate, aluminum alum, aluminum sulfite, aluminum thiosulfate, polyaluminum chloride, aluminum nitrate nanohydrate, and aluminum chloride hexahydrate. Among them, polyaluminum chloride is preferable.

A main component of the polyaluminum chloride is represented by the following formula 11, 12 or 13, and the polyaluminum chloride is water-soluble polyaluminum hydroxide stably containing a basic polymeric polynuclear fused ion such as [Al₆(OH)₁₅]³⁺, [Al₈(OH)₂₀]⁴⁺, [Al₁₃(OH)₃₄]⁵⁺, and [Al₂₁(OH)₆₀]³⁺.

[Al₂(OH)ₙCl₆₋ₙ]ₘ Formula 11

[Al(OH)₃]ₙAlCl₃ Formula 12

Alₙ(OH)ₘCl₍₃ₙ₋ₘ₎ 0<m<3n Formula 13

These are sold on the market under the name of polyaluminum chloride (PAC) from Taki Chemical Co., Ltd. as a water treatment agent, under the name of polyaluminum hydroxide (Paho) from Asada Chemical, under the name of Purachem WT from Rikengreen Co., Ltd, and under the name of Alphain 83 from TAIMEI Chemical Co., Ltd, and from other manufacturers, and various grades of products can be easily obtained. In the invention, these commercially availably products can be used as they are. However, some products have an unsuitable pH and, in that case, they may be used by appropriately adjusting a pH.

In an ink jet recording medium in the invention, a content of the water-soluble aluminum compound is preferably contained at a larger amount for the purpose of further improving ozone resistance, image blurring and luster, and is preferably 0.1 to 20 g/m², more preferably 0.4 to 10 g/m², further preferably 0.8 to 5 g/m².

When a content of the water-soluble aluminum compound is less than 0.1 g/m², it is difficult to obtain desired ozone resistance, and image blurring is caused in some cases, and desired luster is not obtained in some cases, being not preferable.

On the other hand, when the content exceeds 20 g/m², an ink absorption capacity becomes insufficient, being not preferable.

The water-soluble aluminum compound according to the invention may be used alone, or two or more kinds may be used in combination.

An ink jet recording medium in the invention may contain other water-soluble polyvalent metal salt other than the water-soluble aluminum compound in such a range that the effect of the invention is not deteriorated.

Specific examples of other water-soluble polyvalent metal salt include the following:

That is, examples include calcium acetate, calcium chloride, calcium formate, calcium sulfate, barium acetate, barium sulfate, barium phosphate, manganese chloride, manganese acetate, manganese formate dihydrate, manganese sulfate ammonium hexahydrate, cupric chloride, ammonium chloride copper (II) dihydrate, copper sulfate, cobalt chloride, cobalt thiocyanate, cobalt sulfate, nickel sulfate hexahydrate, nickel chloride hexahydrate, nickel acetate teterahydrate, nickel sulfate ammonium hexahydrate, nickel amidosulfate teterahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconium carbonate ammonium, zirconyl stearate, zirconyl octanate, zirconyl nitrate, zirconium oxychloride, zirconium hydroxychloride, chromium acetate, chromium sulfate, magnesium sulfate, magnesium chloride hexahydrate, magnesium citrate nanohydrate, sodium phosphotungstate, sodium tungsten citrate, 12 tungstophosphoric acid n-hydrate, 12 tungstosilicic acid 26-hydrate, molybdenum chloride, 12 molybdophosphoric acid n-hydrate, gallium nitrate, germanium nitrate, strontium nitrate, yttrium acetate, yttrium chloride, yttrium nitrate, indium nitrate, lanthanum acetate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate.

The water-soluble multivalent metal salts may be used alone, or two or more kinds may be used in combination.

A content of these water-soluble multivalent metal salts may be in a range of the content of the water-soluble aluminum compound.

### (Water-Soluble Resin)

It is preferable that an ink jet recording medium in the invention contains a water-soluble resin from a viewpoint of a film strength and ink absorbability.

Examples of a water-soluble resin used in the invention include a polyvinyl alcohol-based resin which is a resin having a hydroxyl group as a hydrophilic structural unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal etc.], a cellulose-based resin [methylcellulose (MC), ethylcellulose (EC), hydroxyethylcellulose (HEC), carboxymethylcellulose (CMC), hydroxypropylcellulose (HPC), hydroxyethylmethylcellulose, hydroxypropylmethylcellulose etc.], chitins, chitosans, starch, a resin having an ether bond [polyethylene oxide (PEO), polypropylene oxide (PPO), polyethylene glycol (PEG), polyvinyl ether (PVE) etc.], and a resin having a carbamoyl group [polyacrylamide (PAAM), polyvinylpyrrolidone (PVP), polyacrylic acid hydrazide etc.].

In addition, examples include a polyacrylic acid salt having a carboxyl group as a dissociating group, a maleic acid resin, an alginic acid salt, and gelatins.

As a water-soluble resin in the invention, among the aforementioned resins, polyvinyl alcohol (PVA) is particularly preferable.

A saponification degree of polyvinyl alcohol (PVA) used in the invention is preferably 75 to 95 mole %, more preferably 77 to 90 mole %, particularly preferably 80 to 90 mole % from a viewpoint of a coloring concentration. In addition, a polymerization degree of polyvinyl alcohol (PVA) is preferably 1,400 to 5,000, more preferably 2,300 to 4,000 from a viewpoint that a sufficient film strength is obtained. In addition, polyvinyl alcohol having a polymerization degree of less than 1,400 and polyvinyl alcohol having a polymerization degree of more than 1,400 may be used in combination.

A content of the water-soluble resin in an ink receiving layer is preferably 5 to 40% by mass, more preferably 10 to 30% by mass based on a mass of a total solid content contained in an ink receiving layer from a viewpoint that reduction in a film strength and cracking at drying due to a smaller content are prevented, and easy choking of voids with a resin, and reduction in ink absorbability due to a reduced void ratio are prevented.

A fine particle described later and a water-soluble resin mainly constituting an ink receiving layer may be a single material, respectively, or may be a mixed system of a plurality of materials.

The polyvinyl alcohol includes, in addition to no-modified polyvinyl alcohol (PVA), cation-modified PVA, anion-modified PVA, silanol-modified PVA and other polyvinyl alcohol derivative. Polyvinyl alcohol may be used alone, or two or more kinds may be used in combination.

The PVA has a hydroxyl group in its structural unit, and this hydroxyl group and a silanol group on a silica fine particle surface to form a hydrogen bond, thereby, a three-dimensional network structure containing a secondary particle of a silica fine particle as a chain unit is easily formed. It is thought that, by formation of such the three-dimensional network structure, an ink receiving layer of a porous structure having a high void ratio can be formed.

In an ink jet recording medium obtained by the invention, a porous ink receiving layer obtained as described above rapidly absorbs an ink by capillary phenomenon, and a dot which has no ink blurring and is better in true circularity can be formed.

### (Fine Particle)

It is preferable that an ink receiving layer in the ink jet recording medium contains a fine particle. Examples of a fine particle in the invention include at least one kind fine particle selected from an organic fine particle, a silica fine particle, an alumina fine particle, and a pseudoboemite-type aluminum hydroxide fine particle. As a fine particle in the invention, a silica fine particle, an alumina fine particle, and a pseudoboemite-type aluminum hydroxide fine particle are preferable.

An average primary particle diameter of a fine particle in the invention is preferably 50 nm or less, more preferably 30 nm or less, particularly preferably 15 nm or less. When an average primary particle diameter of a fine particle is 15 nm or less, the ink absorbing property can be effectively improved and, at the same time, luster of an ink receiving layer surface can be also enhanced. In addition, a lower limit of an average primary particle diameter of the fine particle is not particularly limited, but is preferably not less than 1 nm.

Among the aforementioned fine particles, since vapor phase method silica or vapor phase method alumina produced by a vapor phase method has a particularly large surface area, absorbability and an efficiency of retaining of an ink are high and, since a refractive index is low, when dispersing is performed to an appropriately fine particle diameter, transparency can be imparted to an ink receiving layer, and there is an advantage that a high color concentration and better coloring property are obtained. Like this, transparency of a receiving layer is important from a viewpoint of obtaining a high color concentration and better coloring property and luster not only in utility requiring transparency such as OHP, but also when applied to a recording sheet such as a photoluster paper.

Particularly, since a silica fine particle has a silanol group on its surface, and particles are easily adhered with a hydrogen bond of the silanol group, and due to the effect of adhesion of particles via the silanol group and a water-soluble resin, a void ratio of an ink receiving layer is large when an average primary particle diameter is 15 nm or less as described above, a structure having high transparency can be formed, and the ink absorption property can be effectively improved.

Generally, a silica fine particle is usually roughly classified into a wet method (precipitation method) particle and a dry method (vapor phase method) particle. In the wet method, a method of producing active silica by acid degradation of silicate, and polymerizing this to an appropriate degree, aggregating and settling this to obtain hydrous silica is a mainstream. On the other hand, as a vapor phase method, a method of obtaining anhydrous silica by a method by high temperature vapor hydrolysis of halogenated silica (flame hydrolysis method), or a method of heating-reducing to vaporize silica sand and a coke with an arc in an electric furnace, and oxidizing this with the air (arc method) is a mainstream, and the “vapor phase method silica” refers to anhydrous silica fine particle obtained by the vapor phase method.

Vapor phase method silica has a difference in a density of a silanol group on a surface, and the presence or the absence of a pore from the anhydrous silica, exhibits a different nature, and is suitable in forming a three-dimensional structure having a high void ratio. This reason is not clear, but in the case of hydrous silica, a density of a silanol group on a fine particle surface is many as 5 to 8/nm², and silica fine particles are easily aggregated densely and, on the other hand, in the case of vapor phase method silica, a density of a silanol group on a fine particle surface is small as 2 to 3/nm² and, therefore, it is presumed that a loose soft flocculate is formed and, as a result, a structure having a high void ratio is obtained.

It is preferable that a fine particle in the invention is amorphous silica or alumina synthesized by a precipitation method or a vapor phase method. Particularly, it is preferable that vapor phase method silica or vapor phase method alumina having an average primary particle diameter of 30 nm or less is used and, when the vapor phase method silica or the vapor phase method alumina is used at 50% by mass or more (preferably 70% by mass or more, more preferably 90% by mass or more) of a total fine particle, the remarkable effect is obtained. In addition, in the case of vapor phase method silica, a silica fine particle having a density of a silanol group on a fine particle surface of 2 to 3/nm² is preferable.

In the invention, vapor phase method alumina has the characteristic that it has a higher coloring concentration and a higher luster as compared with vapor phase method silica. This is thought because a refractive index of vapor phase method alumina is higher than a refractive index of vapor phase method silica and reflection of light on a surface is high. In addition, vapor phase method alumina has the characteristic that a particle is spherical and ink absorbing property is excellent as compared with alumina hydrate like pseudoboemite and, by combining with the invention, it becomes possible to further improve ink absorbing property. In addition, although the reason is not clear, vapor phase method alumina has the characteristic that fine cracking of an ink receiving layer is hardly caused as compared with vapor phase method silica. Such the fine cracking is caused due to various factors of a manufacturing process and, by combining with vapor phase method alumina, for example, it becomes possible to remarkably improve a fine fissure caused by contraction of a coated film in a dry process.

In addition, there is a tendency that, when a vapor alumina method is used, a strength of a coated film is improved as compared with use of vapor phase method silica, and a disorder such as a scratch is hardly produced. Further, since it becomes possible to increase a solid content of a pigment dispersion as compared with vapor phase method silica, it becomes possible to increase a solid content of a final coating solution, and vapor phase method alumina has also an advantage that a drying load is small, and it can be produced by a process having high productivity. When an aqueous dispersion of vapor phase method alumina is prepared, a dispersion solid content can be further enhanced by using a small amount of an acidic component. As such the acidic component, it is particularly preferable to add a small amount of boric acid at dispersing of a pigment.

In addition, in order to increase a pigment dispersing concentration, it is preferable to use the known dispersant. It is preferable to use, as these dispersants, a cationic polymer having a secondary or tertiary amino group, or a quaternary ammonium base, a nonionic or cationic surfactant, and polyvinyl alcohol of a low molecular weight in combination. In addition, by using a high boiling solvent which can be used in the invention at dispersing of a pigment, a dispersing concentration can be further improved.

When vapor phase method alumina is used, an amount thereof is preferable 4 parts by mass to 12 parts by mass, further preferably 5 parts by mass to 10 parts by mass, particularly preferably 6 parts by mass to 9 parts by mass based on 1 part by mass of a water-soluble binder, and it becomes possible to obtain a sufficient film strength at a smaller binder amount than that when vapor silica is used.

In addition, when an ink receiving layer of a multilayer structure is formed, it is preferable that vapor phase method alumina is contained in an outermost layer for extracting the characteristic of the vapor phase method alumina.

In the invention, a fine particle may be used alone, or two or more kinds may be used in combination. When two or more kinds of fine particles are used in combination, an aspect of arbitrary using precipitation method silica, vapor phase method silica and vapor phase method alumina is preferable.

When an organic fine particle is used as a fine particle in the invention, the particle must be present in the particulate state when an ink receiving layer is formed, examples of the organic fine particle include polymer particles obtained by emulsion polymerization, microemulsion system polymerization, soap free polymerization, seed polymerization, dispersion polymerization or suspension polymerization, and specific examples include powders of polyethylene, polypropylene, polystyrene, polyacrylate, polyamide, silicone resin, phenol resin, and natural polymer, and latex or emulsion-like polymer fine particles. It is preferable that a surface of an organic fine particle is cationized. Tg of an organic fine particle is not particularly limited, but when the particle is used alone, Tg is preferably 40° C. or higher, further preferably 80° C. or higher.

When colloidal silica, which is outside a range of a fine particle in the invention, is used as a fine particle, since colloidal silica itself has the small void forming ability, the effect of the invention is not obtained. However, for example, when precipitation method silica or vapor phase method silica which is a fine particle in the invention, and colloidal silica are used in combination in the same layer, and when a colloidal silica-containing layer is provided by layer overlaying separately from a layer containing a fine particle in the invention, the effect of the invention can be sufficiently exerted.

—Ratio of Fine Particle and Water-Soluble Resin to be Contained—

In the invention, a ratio of a fine particle (preferably silica fine particle: x) and a water-soluble resin (y) to be contained [PB ratio (x/y), a mass of a fine particle relative to 1 part by mass of a water-soluble resin] largely influences also on a film structure of an ink receiving layer. That is, when a PB ratio grows larger, a void ratio, a pore volume, and a surface area (per unit mass) become larger. Specifically, the PB ratio (x/y) is preferably 1.5/1 to 10/1 from a viewpoint that reduction in a film strength and cracking at drying due to a too large PB ratio are prevented, and easy choking of a void with a resin due to a too small PB ratio, and reduction in ink absorbability due to reduction in a void ratio are prevented.

When a recording medium is passed through a conveying system of an ink jet printer, since a stress is applied to the recording medium in some cases, it is necessary that an ink receiving layer has a sufficient film strength. When further cut and processed into a sheet, in order to prevent cracking and peeling of an ink receiving layer, an ink receiving layer needs a sufficient film strength. From such the point of view, the PB ratio (x/y) is preferably 6/1 or less and, from a viewpoint that high-speed ink absorbability is maintained with an ink jet printer, the PB ratio is preferably 3/1 or more.

For example, when a coating solution in which an anhydrous silica fine particle having an average primary particle diameter of 20 nm or less and a water-soluble resin are completely dispersed into an aqueous solution at a PB ratio (x/y) of 3/1 to 6/1 is coated on a support, and the coating layer is dried, a three-dimensional network structure having a secondary particle of a silica fine particle as a chain unit is formed, and a translucent porous film having an average pour diameter of 30 nm or less, a void ratio of 50% to 80%, a pore specific volume of 0.5 ml/g or more, and a specific surface area of 100 m²/g or more can be easily formed.

### (Cationic Polymer)

The ink jet recording medium preferably contains a cationic polymer from a viewpoint of prevention of blurring over time.

As a cationic polymer in the invention, a polymer mordant having a primary to tertiary amino group, or a quaternary ammonium base as a cationic group is preferably used, and a cationic non-polymer mordant can be also used.

As the cationic polymer, a homopolymer of a monomer (mordant monomer) of a primary to tertiary amino group or a salt thereof, or a quaternary ammonium salt, and a copolymer or a fused polymer of the mordant monomer and other monomer (hereinafter, referred to as “non-mordant monomer”) are preferable. In addition, these polymers can be used in any form of a water-soluble polymer and a water-dispersible latex polymer.

Examples of the monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride; trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate; N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, N,N-diethylaminopropyl (meth)acrylamide's methylchloride, ethylchloride, methylbromide, ethylbromide, methyliodide or ethyliodide-quaternized compound, or sulfonate salt, alkylsulfonate salt, acetate salt or alkylcarbonate salt in which an anion thereof is substituted.

Specific examples include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethyl ammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloyl amino)propylammonium chloride, triethyl-3-(acryloylamino)propylammonium chloride; N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, trimethyl-3-(acryloylamino)propylammonium acetate.

In addition, examples of a copolymerizable monomer include N-vinylimidazole, and N-vinyl-2-methylimidazol.

In addition, allyamine, diallyamine and a derivative and a salt thereof can be also utilized. Examples of such the compound include allylamine, allylamine hydrochloride, allylamine acetate, allylamine sulfate, diallylamine, diallylamine hydrochloride, diallylamine acetate, diallylamine sulfate, diallylmethylamine and a salt thereof (the salt is for example hydrochloride, acetate, sulfate etc.), diallylethylamine and a salt thereof (the salt is for example hydrochloride, acetate, sulfate etc.), diallyldimethylammonium salt (a counter anion of the salt is chloride, acetate ion, sulfate ion etc.). Since these allylamines and diallylamine derivatives are inferior in polymerizability in the case of an amine form, it is generally to polymerize them in a form of a salt and, if necessary, desalt polymers.

Alternatively, a unit of N-vinylacetamide or N-vinylformamide is used and, after a polymerization, a vinylamine unit is obtained by hydrolysis, this and a salt obtained by converting this may be also utilized.

The non-mordant monomer refers to a monomer which does not contain a basic or a cationic part such as a primary to tertiary amino group and a salt thereof, or a quaternary ammonium base, and does not exhibit interaction with a dye in an ink jet ink, or has substantially small interaction therewith.

Examples of the non-mordant monomer include (meth)acrylic acid alkyl ester; (meth)acrylic acid cycloalkyl ester group such as cyclohexyl (meth)acrylate; (meth)acrylic acid aryl ester such as phenyl (meth)acrylate; aralkyl ester such as benzyl (meth)acrylate; aromatic vinyls such as styrene, vinyltoluene, and α-methylstyrene; vinyl esters such as vinyl acetate, vinyl propionate, and vinyl versatate; allylesters such as allyl acetate; halogen-containing monomers such as vinylidene chloride, and vinyl chloride; vinyl cyanate such as (meth)acrylonitrile; olefins such as ethylene, and propylene.

As the (meth)acrylic acid alkyl ester, (meth)acrylic acid alkyl ester in which a carbon number of an alkyl part is 1 to 18 is preferable, and examples include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, and stearyl (meth)acrylate.

Among these, methyl acrylate, ethyl acrylate, methyl methacrylate, ethyl methacrylate, and hydroxyethyl methacrylate are preferable.

The non-mordant monomer can be used alone, or two or more kinds may be used in a combination thereof.

Further, preferable examples of the cationic polymer include polydiallyldimethylammonium chloride, polymethacryloyloxyethyl-β-hydroxyethyldimethylammonium chloride, polyethyleneimine, polyallylamine and a derivative thereof, polyamide-polyamine resin, cationized starch, dicyan-based cationic resins, a representative of which is a dicyandiamide formalin condensate, a dimethyl-2-hydroxypropylammonium salt polymer, polyamidine, polyvinylamine, and dicyandiamide-formalin polycondensate, polyamine-based cation resins, a representative of which is a dicyanamide-diethylenetriamine polycondensate, and epichlorohydrin-dimethylamine addition polymer, a dimethyldiallylammonium chloride-SO₂ copolymer, a diallylamine salt-SO₂ copolymer, a (meth)acrylate-containing polymer having a quaternary ammonium base-substituted alkyl group on an ester part, and a styryl-type polymer having a quaternary ammonium base-substituted alkyl group.

Specific examples of the cationic polymer include those described in JP-A Nos. 48-28325, 54-74430, 54-124726, 55-22766, 55-142339, 60-23850, 60-23851, 60-23852, 60-23853, 60-57836, 60-64643, 60-118834, 60-122940, 60-122941, 60-122942, 60-235134, and 1-161236, U.S. Pat. Nos. 2,484,430, 2,548,564, 3,148,061, 3,309,690, 4,115,124, 4,124,386, 4,193,800, 4,273,853, 4,282,305, 4,450,224, JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314, JP-B Nos. 5-35162, 5-35163, 5-35164, and 5-88846, JP-A No. 7-118333, and 2000-344990, and Japanese Patent Nos. 2648847, and 2661677. Among these, a diallyldimethylammonium chloride-type polymer, or a (meth)acrylate-containing polymer having a quaternary ammonium base on an ester part is preferable.

As a cationic polymer in the invention, particularly, from a viewpoint of prevention of blurring over time, a cationic polymer having a weight average molecular weight of 200,000 or less and an I/O value of 3.0 or less is preferable.

The cationic polymer may be used alone, or two or more kinds may be used in combination. Alternatively, the cationic polymer and other organic mordant and/or inorganic mordant may be used in combination.

A content of the cationic polymer contained in an ink receiving layer formed in the invention is preferably smaller from a viewpoint of ozone resistance, and is preferably 1 to 30% by mass, more preferably 2 to 15% by mass, further preferably 3 to 10% by mass based on a mass of a total solid content in an ion receiving layer.

### (Latex)

It is preferable that an ink receiving layer formed by the invention further contains a latex having a volume average particle diameter of 0.1 μm or smaller.

Herein, a latex in the invention means a colloid dispersion, or an emulsion-like liquid in which a water-insoluble polymer is emulsified or dispersed in water. In addition, when a particle size is 0.1 μm or more, this is called emulsion and, when the size is less than 0.1 μm, this is called colloid dispersion. A lower limit of a volume average particle diameter of the latex is not particularly limited, but is preferably 1 nm or more.

In the invention, by using latex together with the cationic polymer, the effect of prevention of occurrence of a flaw on a receiving image surface when an ink jet recording medium manufactured by the invention is printed with a printer, and prevention of wet heat blurring after printing can be improved.

A volume average particle diameter of a latex in water is a colloid dispersion of preferably less than 0.1 μm, further preferably in a range of 1 to 100 nm.

As a latex or an aqueous dispersion of a polymer, for example, polystyrene-based, styrene-butadiene copolymer-based, acrylonitrile-butadiene-based, acryl-based, styrene-acryl-based, urethane-based, methacrylic acid-based, vinyl chloride-based, vinyl acetate-based, and ethylene-vinyl acetate-based latexes are preferably used. Among them, styrene-based, acrylic acid-based, methacrylic acid-based, and urethane-based latexes are preferable and, particularly, a urethane-based latex is preferable from a viewpoint of the effect of preventing blurring after image printing.

As a latex in the invention, a latex synthesized by the known polymerization method described in Motoharu Nakakura, “Advanced Application Technique of Latex•Emulsion”, Chunichisya, 1991 can be used. Particularly, as a latex used in the invention, from a viewpoint of improvement in a film strength, a latex obtained by a method of synthesis without using a surfactant is preferable.

When a latex is used in an ink receiving layer coating solution containing a fine particle having an average primary particle diameter of 30 nm or less and a water-soluble resin, a viscosity of a coating solution is increased, deterioration in the state of a coated surface is caused, and luster is reduced in some cases. However, in the invention, due to inclusion of the specified high boiling point organic solvent in an ink receiving layer coating solution, even when a latex is used, the effect of stabilizing a viscosity of a coating solution is exerted, and the better state of a coated surface can be obtained.

Tg of a latex is not particularly limited, but from a viewpoint of the effect of improving a hardness of a film, is preferably 40° C. or higher and, conversely, from a viewpoint of the effect of improving brittleness, is preferably 40° C. or lower. It is preferable that a cation-modified polyurethane resin latex is not in the particulate state, but is formed into a film after coating and drying. By formation of a film, a haze of an ink receiving layer is reduced, and it becomes possible to obtain a high coloring concentration.

As a latex in the invention, a cation-modified polymer latex in which a volume average particle diameter of dispersion is 0.1 μm or less (preferably 200 nm or less) is preferable, and a cation-modified polyurethane resin latex is most preferable.

A cation-modified polymer latex will be explained below.

Examples of the “cation-modified polymer” in the invention include a polymerization addition-based or polycondensation-based polymer compound having a cationic group such as a primary to tertiary amino group, and a quaternary ammonium group.

Examples of a vinyl polymerization-based polymer effective as the cation-modified polymer include polymers obtained by polymerizing the following vinyl monomer. That is, acrylic acid esters or methacrylic acid esters (an ester group is an alkyl group, or an aryl group optionally having a substituent, for example, a methyl group, an ethyl group, a n-propyl group, an isopropyl group, a n-butyl group, a sec-butyl group, a tert-butyl group, a hexyl group, 2-ethylhexyl group, tert-octyl group, 2-chloroethyl group, cyanoethyl group, 2-acetoxyethyl group, tetrahydrofurfuryl group, 5-hydroxypentel group, cyclohexyl group, benzyl group, hydroxyethyl group, 3-methoxybutyl group, 2-(2-methoxyethoxy)ethyl group, 2,2,2-tetrafluoroethyl group, 1H,1H,2H, 2H-perfluorodecyl group, phenyl group, 2,4,5-tetramethylphenyl group, 4-chlorophenyl group etc.); vinyl esters, specifically, an aliphatic carboxylic acid vinyl ester optionally having a substituent (e.g. vinyl acetate, vinyl propionate, vinyl butyrate, vinyl isobutyrate, vinyl caproate, vinyl chloroacetate, etc.), an aromatic carboxylic acid vinyl ester optionally having a substituent (e.g. vinyl benzoate, vinyl 4-methylbenzoate, vinyl salicylate etc.); acrylamides, specifically, acrylamide, N-monosubstituted acrylamide, N-disubstituted acrylamide (a substituent is an alkyl group, an aryl group or a silyl group optionally having a substituent, for example, methyl group, n-propyl group, isopropyl group, n-butyl group, tert-butyl group, tert-octyl group, cyclohexyl group, benzyl group, hydroxymethyl group, alkoxymethyl group, phenyl group, 2,4,5-trimethylphenyl group, 4-chlorophenyl group, trimethylsilyl group etc.); methacrylamides, specifically, methacrylamide, N-monosubstituted methacrylamide, N-disubstituted methacrylamide (a substituent is an alkyl group, an aryl group or a silyl group optionally having a substituent, for example, methyl group, n-propyl group, isopropyl group, n-butyl group, tert-butyl group, tert-octyl group, cyclohexyl group, benzyl group, hydroxymethyl group, alkoxymethyl group, phenyl group, 2,4,5-trimethylphenyl group, 4-chlorophenyl group, trimethylsilyl group etc.); olefins (e.g. ethylene, propylene, 1-pentene, vinyl chloride, vinylidene chloride, isoprene, chloroprene, butadiene etc.), styrenes (e.g. styrene, methylstyrene, isopropylstyrene, methoxystyrene, acetoxystyrene, chlorostyrene etc.), vinyl ethers (e.g. methyl vinyl ether, butyl vinyl ether, hexyl vinyl ether, methoxyethyl vinyl ether etc.).

Examples of other vinyl monomer include crotonic acid ester, itaconic acid ester, maleic acid diester, fumaric acid diester, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethylphosphate, diphenyl-2-methacryloyloxyethyl phosphate, dibutyl-2-acryloyloxyethyl phosphate, and dioctyl-2-methacryloyloxyethyl phosphate.

Examples of the monomer having a cationic group include a monomer having a tertiary amino group such as dialkylaminoethyl methacrylate, and dialkylaminoethyl acrylate.

Examples of polyurethane, which can be applied to the cation-modified polymer, include polyurethanes synthesized by a polyaddition reaction by variously combining the following diol compounds and diisocyanate compounds.

Examples of the diol compound include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethylol-1,3-pentanediol, 1,4-cyclohexanedimethanol, hydroquinone, diethylene glycol, triethylene glycol, dipropylene glycol, tripropylene glycol, polyethylene glycol (average molecular weight: 200, 300, 400, 600, 1,000, 1,500, 4,000), polypropylene glycol (average molecular weight: 200, 400, 1,000), polyester polyol, 4,4′-dihydroxy-diphenyl-2,2-propane, 4,4′-dihydroxyphenylsulfone, and polycarbonate polyol.

Examples of the diisocyanate compound include methylene diisocyanate, ethylene diisocyanate, isophorone diisocyanate, hexamethylene diisocyanate, 1,4-cyclohexane diisocyanate, 2,4-toluene diisocyanate, 2,6-tluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, and methylenebis(4-cyclohexyl isocyanate).

Examples of a cationic group possessed by polyurethane having a cationic group include cationic groups such as a primary to tertiary amine, and a quaternary ammonium salt.

As a polymer which is used in a latex in the invention, a urethane resin having a cationic group such as a tertiary amine and a quaternary ammonium salt is preferable.

Polyurethane having a cationic group is obtained by using the aforementioned diol in which a cationic group has been introduced, upon synthesis of polyurethane. In addition, in the case of a quaternary ammonium salt, polyurethane containing a tertiary amino group may be quaterized with a quaterizing agent.

The diol compound and the diisocyanate compound which can be used in a synthesis of polyurethane may be used alone, respectively, or two or more kinds may be used at an arbitrary ratio, depending on various purposes (for example, adjustment of a glass transition temperature (Tg) of a polymer, impartation of compatibility with a binder, improvement in stability of a dispersion etc.).

Further, examples of polyester, which can be applied to the cation-modified polymer, include polyesters synthesized by a polycondensation reaction by variously combining the following diol compounds and dicarboxylic acid compounds.

Examples of the dicarboxylic acid compound include oxalic acid, malonic acid, succinic acid, glutaric acid, dimethylmalonic acid, adipic acid, pimelic acid, α,α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethylene terephthalate)dicarboxylic acid, 1,2-cyclohexanedicarboxylic acid, 1,4-cyclohexanedicarboxylic acid, ω-poly(ethylene oxide)dicarboxylic acid, and p-xylilenedicarboxylic acid.

The dicarboxylic acid compound, when a polycondensation reaction is performed with a diol compound, may be used in a form of alkyl ester (e.g. dimethyl ester) of dicarboxylic acid or acid chloride of dicarboxylic acid, or may be used in a form of an anhydride such as maleic anhydride, succinic anhydride and phthalic anhydride.

As the diol compound, the same compounds as diols exemplified in the polyurethane can be used.

Polyester having a cationic group is obtained by synthesis using a dicarboxylic acid compound having a cationic group such as primary, secondary or tertiary amine, and a quaternary ammonium salt.

The diol compounds, dicarboxylic acids and hydroxycarboxylic acid ester compounds used in synthesis of polyester may be used alone, respectively, or two or more kinds may be used by mixing them at an arbitrary ratio, respectively, depending on various purposes (e.g. adjustment of a glass transition temperature (Tg) and solubility of a polymer, compatibility with a dye, stability of a dispersion).

A content of a cationic group in the cation-modified polymer is preferably 0.1 to 5 mmol/g, more preferably 0.2 to 3 mmol/g. When a content of the cationic group is too small, dispersing stability of a polymer is reduced and, when the content is too large, compatibility with a binder is reduced.

As the cation-modified polymer, a polymer having a cationic group such as a tertiary amino group and a quaternary ammonium base is preferable and, particularly, the aforementioned urethane resin having a cationic group is most preferable.

When a cation-modified polymer is used in an ink receiving layer, particularly important is a glass transition temperature thereof. In order to suppress blurring over time of an image over a long period of time after formation of an image by ink jet recording, it is preferable that a glass transition temperature of the cation-modified polymer is lower than 50° C. Further, a glass transition temperature of the cation-modified polymer of 30° C. or lower is more preferable and, particularly, a glass transition temperature of 15° C. or lwer is most preferable. When the glass transition temperature is 50° C. or higher, dimensional stability (curl) is deteriorated in some cases. A lower limit of the glass transition temperature is not particularly limited, but is around −30° C. in conventional utility and, when the glass transition temperature is below this, preparation suitability upon preparation of an aqueous dispersion is reduced in some cases.

A mass average molecular weight (Mw) of a cation-modified polymer used in the invention is usually preferably 1,000 to 1,000,000, more preferably 300,000 to 700,000. When the molecular weight is less than 1,000, there is a tendency that it is difficult to obtain a stable aqueous dispersion and, on the other hand, when the molecular weight exceeds 1,000,000, there is a tendency that solubility is deteriorated, a liquid viscosity is increased, and it becomes difficult to make an average particle diameter of an aqueous dispersion smaller, particularly, control the average particle diameter at 0.05 μm or less.

In an ink receiving layer, a content of a latex or an aqueous dispersion of a polymer which is the cation-modified polymer is preferably 0.1 to 30% by mass, more preferably 0.3 to 20% by mass and, particularly, most preferably 0.5 to 15% by mass based on a total solid content constituting an ink receiving layer. When the content is less than 0.1% by mass, there is a tendency that the effect of improving blurring over time becomes insufficient and, on the other hand, when the content exceeds 30% by mass, there is a tendency that a ratio of a fine particle and a binder component becomes small, and ink absorbability onto a high image quality recording paper is reduced.

Then, process for preparing a latex of the cation-modified polymer will be explained.

An aqueous dispersion having an average particle diameter of 0.05 μm can be obtained by mixing the cation-modified polymer with an aqueous solvent, mixing an additive therein if necessary, and finely dividing the mixed solution using a dispersing machine. As the dispersing machine for obtaining an aqueous dispersion, the conventionally known various dispersing machines such as a high speed rotation dispersing machine, a medium stirring-type dispersing machine (ball mill, sand mill, beads mill etc.), an ultrasound dispersing machine, a colloid mill dispersing machine, and a high pressure dispersing machine can be used and, from a viewpoint that a formed lumpy particle is effectively dispersed, a medium stirring-type dispersing machine, a colloid mill dispersing machine or a high pressure dispersing machine is preferable.

A detailed mechanism of a high pressure-dispersing machine (homogenizer) is described in U.S. Pat. No. 4,533,254, and JP-A No. 6-47264 and, as a commercially available apparatus, Gaulin homogenizer (A.P.V GAULIN INC.), Microfluidizer (MICROFLUIDEX INC.), Altimizer (SUGINO MACHINE LIMITED) can be used. In addition, in recent years, a high pressure homogenizer equipped with a mechanism which finely divides the mixed solution in an ultrahigh pressure jet stream, described in U.S. Pat. No. 5,720,551 is particularly effective in emulsification and dispersing in the invention. Examples of an emulsifying apparatus using this ultrahigh pressure jet stream include DeBEE2000 (BEE INTERNATIONAL LTD.). Among them, particularly, a high pressure jet-type dispersing machine is preferable since monodispersity of a fine particle in the invention is easily obtained, a haze of an ink receiving layer can be reduced, and a high void ratio can be obtained.

As an aqueous solvent in the dispersing step, water, an organic solvent, or a mixed solvent thereof can be used. Examples of the organic solvent which can be used in this dispersing include alcohols such as methanol, ethanol, n-propanol, i-propanol, and methoxypropanol, ketones such as acetone, and methyl ethyl ketone, tetrahydrofuran, acetonitrile, ethyl acetate, and toluene.

The cation-modified polymer of the invention can be naturally itself a stable emulsified dispersion and, in order to rapidly or more stabilize the emulsification and dispersing, a small amount of a dispersant (surfactant) may be used. As a surfactant used for such the purpose, for example, anionic surfactants such as fatty acid salt, alkylsulfate ester salt, alkylbenzene sulfonate salt, alkylnaphthalenesulfonate salt, dialkylsulfosuccinate salt, alkylphosphate ester salt, naphthalenesulfonate formalin condensate, and polyoxyethylenealkylsulfate ester salt, and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkylamine, glycerin fatty acid ester, and oxyethlene oxypropylene block copolymer are preferable. In addition, SURFYNOLS (Air Products & Chemicals), which is an acetylene-based polyoxyethylene oxide surfactant, is preferably used. In addition, an amine oxide type amphoteric surfactant such as N,N-dimethyl-N-alkylamine oxide is also preferable. Further, exemplified surfactants described in JP-A No. 59-157636, page 37-38, and Research Disclosure No. 308119 (1989) can be also used.

For the purpose of stabilization immediately after emulsification, a water-soluble polymer may be added together with the surfactant. As the water-soluble polymer, polyvinyl alcohol, polyvinylpyrrolidone, polyethylene oxide, polyacrylic acid, polyacrylamide or a copolymer thereof is preferably used. Alternatively, natural water-soluble polymers such as polysaccharides, casein and gelatin are also preferably used.

When the cation-modified polymer of the invention is dispersed in an aqueous medium by the aforementioned emulsification and dispersing method, particularly important is control of a particle size thereof. In order to enhance a color purity and a color concentration upon formation of an image with ink jet, it is necessary to reduce an average particle diameter of a cation-modified polymer in the aqueous dispersion.

### (Crosslinking Agent)

A preferable aspect of an ink receiving layer formed in the invention is that a layer containing an inorganic fine particle and a water-soluble resin is a porous layer which further contains a crosslinking agent capable of crosslinking the water-soluble resin, and is hardened by a reaction of crosslinking the water-soluble resin with the crosslinking agent.

As the crosslinking agent, a crosslinking agent suitable in connection with a water-soluble resin contained in an ink receiving layer is appropriately selected and, among these, a boron compound is preferable in that a crosslinking reaction is rapid, and examples include borax, boric acid, borate (e.g. orthoborate, InBO₃, ScBO₃, YBO₃, LaBO₃, Mg₃(BO₃)₂, CO₃(BO₃)₂), diborate (e.g. Mg₂B₂O₅, CO₂B₂O₅), metaborate (e.g. LiBO₂, Ca(BO₂)₂, NaBO₂, KBO₂), tetraborate (e.g. Na₂B₄O₇.10H₂O), pentaborate (e.g. KB₅O₈.4H₂O, CsB₅O₅), and Ca₂B₆O₁₁.7H₂O. Among these, borax, boric acid and borate are preferable, and boric acid is particularly preferable in that a crosslinking agent can be caused rapidly, and it is most preferable to use it in combination with polyvinyl alcohol which is a water-soluble resin.

In the invention, the crosslinking agent is contained at 0.05 to 0.50 parts by mass, more preferably 0.08 to 0.30 parts by mass based on 1.0 part by mass of the water-soluble resin. When a content of a crosslinking agent is in the aforementioned range, a water-soluble resin is effectively crosslinked, and cracking can be prevented.

When gelatin is used as the water-soluble resin, the following compounds other than a boron compound can be also used as a crosslinking agent.

Examples include aldehyde-based compounds such as formaldehyde, glyoxal, and glutaraldehyde; ketone-based compounds such as diacetyl, and cyclopentanedione; active halogen compounds such as bis(2-chloroethylurea)-2-hydroxy-4,6-dichloro-1,3,5-triazine, and 2,4-dichloro-6-S-triazine•sodium salt; active vinyl compounds such as divinylsulfonic acid, 1,3-vinylsulfonyl-2-propanol, N,N′-ethylenebis(vinylsulfonylacetamide), and 1,3,5-triacryloyl-hexahydro-5-triazine; N-methylol compounds such as dimethylolurea, and methyloldimethylhydantoin; melamine resin (e.g. methylolmelamine, alkylated methylolmelamine); epoxy resin; isocyanate-based compounds such as 1,6-hexamethylene diisocyanate; aziridine-based compounds described in U.S. Pat. Nos. 3,017,280, and 2983611; carboxylmide-based compounds described in U.S. Pat. No. 3,100,704; epoxy-based compounds such as glycerol triglycidyl ether; ethyleneimino-based compounds such as 1,6-hexamethylene-N,N′-bisethyleneurea; halogenated carboxyaldehyde-based compounds such as mucochloric acid, and mucophenoxychloric acid; dioxane-based compounds such as 2,3-dihydroxydioxane; metal-containing compounds such as titanium lactate, aluminum sulfate, chromium alum, potassium alum, zirconyl acetate, and chromium acetate; polyamine compounds such as tetraethylenepentamine; hydrazide compounds such as adipic acid dihydrazide; low-molecular molecules or polymers containing two or more oxazoline groups. The aforementioned crosslinking agents may be used alone, or may be used in combination of two or more kinds.

In the invention, the crosslinking agent, upon formation of an ink receiving layer, may be added to an ink receiving layer coating solution and/or a coating solution for forming an adjacent layer of an ink receiving layer, or the crosslinking agent can be supplied to an ink receiving layer by coating the ink receiving layer coating solution on a support on which a coating solution containing a crosslinking agent has been coated in advance, or coating an ink receiving layer coating solution not containing a crosslinking agent, and a overcoating crosslinking agent solution after drying. Preferably, from a viewpoint of a production efficiency, it is preferable that a crosslinking agent is added to an ink receiving layer coating solution or a coating solution for forming an adjacent layer thereof, and a crosslinking agent is supplied at the same time with formation of an ink receiving layer. Particularly, from a viewpoint of improvement in a printed image concentration of an image and luster feeling, it is preferable that a crosslinking agent is contained in an ink receiving layer coating solution. In addition, a concentration of a crosslinking agent in an ink receiving layer coating solution is preferably 0.05 to 10% by mass, more preferably 0.1 to 7% by mass.

For example, a crosslinking agent can be suitably imparted as follows. Herein, an example of a boron compound will be explained. That is, when an ink receiving layer is a layer obtained by crosslinking-curing a coating layer from coating of an ink receiving layer coating solution (first coating solution), the crosslinking-curing is performed by imparting a basic solution (second coating solution) having a pH of 7.1 or more to a coating layer at any time of (1) at the same time with formation of a coating layer by coating the coating solution, and (2) during drying of a coating layer formed by coating the coating solution and before the coating layer exhibits a drying falling rate. A boron compound, which is a crosslinking agent, may be contained in any of the first coating solution and the second coating solution, or may be contained in both of the first coating solution and the second coating solution.

### (Mordant)

It is preferable that an ink receiving layer formed in the invention contains a mordant in order to improve water resistance and blurring over time resistance of a formed image. As the mordant, any of an organic mordant and an inorganic mordant may be used. As the organic mordant, the cationic polymer may have also the function as a cationic mordant. In addition, it is preferable that, as the inorganic mordant, the water-soluble aluminum compound and the water-soluble polyvalent metal salt also have the function as a mordant.

### (Specified High Boiling Point Organic Solvent)

It is preferable that an ink receiving layer formed in the invention contains a specified high boiling point organic solvent. The specified high boiling point organic solvent is an organic solvent having a boiling point of 230° C. or higher.

It is necessary that the specified high boiling point organic solvent has a boiling point of 230° C. or higher from a viewpoint that a force of forming a void in an ink receiving layer is improved, and the boiling point is preferably 240° C. or higher, and further preferably 245° C. or higher. When a boiling point is lower than 230° C., the effect of improving a void forming force is not obtained. An upper limit of a boiling point is not particularly limited, but is around 400° C.

The specified high boiling point organic solvent has water solubility of preferably 0.1% or more, further preferably 0.5 to 50%, particularly preferably 1 to 20%.

When water solubility of the specified high boiling point organic solvent is in the aforementioned preferable range, the wet heat blurring preventing effect is more improved. In addition, since the aggregation preventing effect of a fine particle-dispersed coating solution is enhanced, the better state of a coated surface and luster can be obtained.

Herein, water solubility of the specified high boiling point organic solvent takes a criterion that the organic solvent is dissolved in water at 0.1% by mass or more under a normal temperature and a normal pressure.

A content of the specified high boiling point organic solvent in an ink receiving layer, from a viewpoint of improvement in forming property of a void formed in an ink receiving layer, and the effect of improving curl of an ink jet recording medium, is necessarily less than 100% by mass, preferably 50% by mass or less, particularly preferably 10% by mass or less based on a fine particle described in detail later. A lower limit value is around 0.5% by mass. When a content of the specified high boiling point organic solvent is 100% by mass or more based on a fine particle, a coloring concentration is reduced, and a volume of a void formed in an ink receiving layer is reduced.

Examples of the specified high boiling point organic solvent which is applied to the invention include triethylene glycol monobutyl ether, tetraethylene glycol monobutyl ether, pentaethylene glycol monobutyl ether, diethylene glycol monobutyl ether acetate, and diethylene glycol monohexyl ether and, among them, an acetate-based compound is particularly preferable. Alternatively, as the specified high boiling point organic solvent, a commercially available product can be also applied, and examples include Butycenol 20 (manufactured by KYOWA HAKKO KOGYO Co., Ltd.), Butycenol 20 acetate (manufactured by KYOWA HAKKO KOGYO Co., Ltd.), Butycenol 30 (manufactured by KYOWA HAKKO KOGYO Co., Ltd.), Butycenol 40 (manufactured by KYOWA HAKKO KOGYO Co., Ltd.), and Kyowanol HX20 (manufactured by KYOWA HAKKO KOGYO Co., Ltd.).

Examples of an aspect that the specified high boiling point organic solvent is contained upon preparation of an ink receiving layer coating solution include (1) an aspect that, after a high boiling point organic solvent and a fine particle are mixed, stirred or dispersed, this is mixed with a water-soluble resin to prepare the coating solution, and (2) an aspect that, after a specified high boiling point organic solvent and a water-soluble resin are mixed and dissolved in advance, this is mixed with a fine particle dispersion in which a fine particle is dispersed to prepare the coating solution. From a viewpoint that a viscosity of an ink receiving layer coating solution is controlled, it is preferable to prepare the coating solution by (1) aspect.

### (Other Components)

An ink receiving layer formed in the invention is constructed by containing the following components, if necessary.

That is, for the purpose of suppressing deterioration of an ink coloring material, various ultraviolet absorbing agents, antioxidants, and fading preventing agents such as a singlet oxygen quencher may be contained.

Examples of the ultraviolet absorbing agent include cinnamic acid derivatives, benzophenone derivatives, and benzotriazolylphenol derivatives. Examples include butyl α-cyano-phenylcinnamate, o-benzotriazolephenol, o-benzotriazole-p-chlorophenol, o-benzotriazole-2,4-di-t-butylphenol, and o-benzotriazole-2,4-di-t-octylphenol. A hindered phenol compound may be also used as an ultraviolet absorbing agent and, specifically, a phenol derivative in which one or more places among at least 2-position and 6-position are substituted with a branched alkyl group is preferable.

Alternatively, a benzotriazole-based ultraviolet absorbing agent, a salicylic acid-based ultraviolet absorbing agent, a cyanoacrylate-based ultraviolet absorbing agent, and oxalic acid anilide-based ultraviolet absorbing agent can be also used. They are described, for example, in JP-A Nos. 47-10537, 58-111942, 58-212844, 59-19945, 59-46646, 59-109055, and 63-53544, JP-B Nos. 36-10466, 42-26187, 48-30492, 48-31256, 48-41572, 48-54965, and 50-10726, and U.S. Pat. Nos. 2,719,086, 3,707,375, 3,754,919, and 4,220,711.

A fluorescent brightening agent can be also used as an ultraviolet absorbing agent, and examples include a chmarin-based fluorescent brightening agent. Specifically, the fluorescent brightening agent is described in JP-B No. 45-4699, and 54-5324.

Examples of the antioxidant include antioxidants described in EPA Nos. 223739, 309401, 309402, 310551, 310552, and 459-416, German Laid-Open Patent No. 3435443, JP-A Nos. 54-48535, 60-107384, 60-107383, 60-125470, 60-125471, 60-125472, 60-287485, 60-287486, 60-287484, 60-287488, 61-160287, 61-185483, 61-211079, 62-146678, 62-146680, 62-146679, 62-282885, 62-262047, 63-051174, 63-89877, 63-88380, 63-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, and 5-170361, JP-B Nos. 48-43295, and 48-33212, and U.S. Pat. Nos. 4,814,262, and 4,980,275.

Specifically, examples include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindol.

These fading preventing agents may be used alone, or two or more kinds may be used in combination. The fading preventing agent may be converted into water-soluble, or dispersed or emulsified, or may be contained in a microcapsule. An addition amount of the fading preventing agent is preferably 0.01 to 10% by mass of an ink receiving layer coating solution.

An ink receiving layer formed in the invention may contain other high boiling point organic solvent other than the specified high boiling point organic solvent for preventing curl. As other high boiling point organic solvent, a water-soluble solvent is preferable, and examples of the water-soluble high boiling point organic solvent include alcohols such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol (weight average molecular weight is 400 or less). Preferable is diethylene glycol monobutyl ether (DEGMBE).

A content of other high boiling point organic solvent in an ink receiving layer coating solution is preferably 0.05 to 1% by mass, particularly preferably 0.1 to 0.6% by mass.

In addition, for the purpose of enhancing dispersity of an inorganic pigment fine particle, various inorganic salts, and acids and alkalis as a pH-adjusting agent may be contained.

Further, for the purpose of suppressing friction electrification and peeling electrification of a surface, a metal oxide fine particle having electron conductivity may be contained and, for the purpose of reducing friction property of a surface, various matting agents may be contained.

### (Preparation of Ink Jet Recording Medium)

In an ink jet recording medium in the invention, an ink receiving layer on a support is formed by coating and drying, on the support, an ink receiving layer coating solution containing at least the water-soluble aluminum and the sulfoxide compound.

In the invention, an aspect that an ink receiving layer is formed on a support by a WOW method described later is preferable.

It is preferable that an ink receiving layer of an ink jet recording medium in the invention is formed, for example, by a method (referred to as “Wet on Wet method” or “WOW method”) of coating, on a support, a coating solution (first coating solution) containing at least a sulfoxide compound and the water-soluble aluminum and, preferably, further containing a fine particle, a cationic polymer, a water-soluble resin and a high boiling point organic solvent, to form a coating layer, further adding a crosslinking agent to the coating solution (first coating solution) and/or a basic solution (second coating solution) having a pH of 7.1 or higher, and imparting the basic solution (second coating solution) to the coating layer at any time of (1) at the same time with formation of a coating layer by coating the coating solution (first coating solution), and (2) during drying of a coating layer formed by coating the coating solution (first coating solution) and before the coating layer exhibits a drying falling rate, and crosslinking-curing the coating layer.

It is preferable that a crosslinking agent, which can crosslink the aforementioned water-soluble resin, is contained in at least one of the first coating solution and the second coating solution. An ink receiving layer obtained by imparting a basic solution (second coating solution) to a first coating solution (1) at the same time or (2) during drying, and crosslinking-curing this has an advantage of ink absorbability and prevention of cracking of a film and, additionally, is particularly preferable in that appearance such as repellency disorder is improved.

When the latex is contained in an ink receiving layer, the latex is used by adding to at least one of the first coating solution and the second coating solution (basic solution), however from a viewpoint that a fine particle and a water-soluble resin in a first coating solution are sufficiently mixed, and blurring over time can be effectively prevented over a long period of time, an aspect that the latex is contained in a first coating solution (coating solution containing fine particle and water-soluble resin) is preferable. Thereupon, it is not necessary that all of the latexes are necessarily contained in a first coating solution, but it is also effective that at least a part of the latex is contained in a second coating solution, thereby, blurring over time can be effectively prevented. Alternatively, an aspect that at least of a part of the latex is contained in both of a first coating solution and a second coating solution is also preferable.

In addition, in a preferable aspect, a mordant is present so that a thickness of a part where a mordant is present from an ink receiving layer surface is 10 to 60% relative to a total thickness of an ink receiving layer. For example, the aspect can be formed by an arbitrary method such as by (1) a method of forming a coating layer containing a fine particle, a water-soluble resin and a crosslinking agent, and coating a mordant-containing solution thereon, and (2) a method of a coating solution containing a fine particle and a water-soluble resin and a mordant-containing solution multiply. Alternatively, an inorganic fine particle, a water-soluble resin, and a crosslinking agent may be contained in a mordant-containing solution. By the aforementioned construction, since a mordant is present at a large amount in a required part of an ink receiving layer, an ink coloring material of ink jet is sufficiently mordanted, and a coloring consideration, blurring over time, a printed image part luster, water resistance of a letter and an image after printing, and ozone resistance are further improved, being preferable. A part of a mordant may be contained in a layer which is to be provided on a support first and, in that case, a mordant which is imparted later may be the same or different.

In the invention, when a coating solution containing a fine particle, a water-soluble resin and a boron compound (crosslinking agent) is prepared as a first coating solution, for example, the first coating solution can be prepared as follows.

That is, the first coating solution can be prepared by adding a silica fine particle having an average primary particle diameter of 20 nm or less to water (e.g. 10 to 20% by mass), dispersing this over 20 minutes (preferably, 10 to 30 minutes) using a high speed rotation wet colloid mill (e.g. “Crea Mix” manufactured by M Technique), for example, under the high speed rotation condition of a rotation number of 10,000 rpm (preferably 5,000 to 20,000 rpm), adding a boron compound (e.g. 0.5 to 20% by mass of silica), dispersing this under the same condition as that described above, adding a polyvinyl alcohol aqueous solution (for example, so that PVA having a mass around ⅓ a mass of silica is obtained), and further dispersing this under the same rotation condition as that described above. The resulting coating solution is a uniform sol and, by coating this on a support by the following coating method to form a layer, an ink receiving layer of a porous structure having a three-dimensional network structure can be obtained.

If necessary, a pH adjusting agent, a dispersant, a surfactant, an antifoaming agent, and an antistatic agent may be further added to the first coating solution.

In the invention, in order to impart wettability to a support, it is preferable that a surfactant is used. As the surfactant, an arbitrary surfactant among anionic, cationic and nonionic surfactants can be used. Of these, from a viewpoint that aggregation of a fine particle is prevented, and stability of an image after ink jet recording is not adversely influenced, it is preferable to use a nonionic surfactant. As a nonionic surfactant, a surfactant having a HLB value of 11 or more is preferable, and polyoxyethylene lauryl ether, polyoxyethylene isodecyl ether, polyoxyethylene isotridecyl ether, and polyoxyethylene alkylene branched decyl ether are preferable. Among them, polyoxyethylene isodecyl ether is particularly preferable. Examples of these surfactants include Noigen SD70, and Noigen XL100 sold from Dai-ichi Kogyo Seiyaku Co., Ltd.

As a dispersing machine used in the aforementioned dispersing, the conventionally known various dispersing machines such as a high speed rotation dispersing machine, a medium stirring⁻type dispersing machine (ball mill, sand mill etc.), an ultrasound dispersing machine, a colloid mill dispersing machine, and a high pressure dispersing machine can be used, but in order to effectively perform dispersing of a produced lumpy fine particle, a medium stirring-type dispersing machine, a colloid mill dispersing machine and a high pressure dispersing machine are preferable.

In addition, as a solvent used in preparing each coating solution, water, an organic solvent, or a mixed solvent thereof can be used. Examples of an organic solvent, which can be used in this coating solution, include alcohols such as methanol, ethanol, n-propanol, i-propanol, and methoxypropanol, ketones such as acetone, and methyl ethyl ketone, tetrahydrofuran, acetonitrile, ethyl acetate, and toluene.

In addition, a second coating solution (basic solution) containing a surfactant can be prepared, for example, as follows. That is, a mordant (e.g. 0.1 to 5.0% by mass) and surfactants (e.g. a total amount is 0.01 to 1.0% by mass) and, if necessary, a crosslinking agent (0 to 5.0% by mass) are added to ion-exchanged water, and this is sufficiently stirred. A pH of a second coating solution is preferably 8.0 or higher, and a pH can be appropriately adjusted to 8.0 or higher using aqueous ammonia, sodium hydroxide, calcium hydroxide, or an amino group-containing compound (ethylamine, ethanolamine, diethanolamine, polyallylamine etc.).

Coating of a first coating solution (ink receiving layer coating solution) can be performed by the known coating method such as an extrusion die porter, an air doctor coater, a blade coater, a rod coater, a knife coater, a squeeze coater, a reverse roll coater and a bar coater.

At the same time with coating of a first coating solution (ink receiving layer coating solution) or after coating of the first coating solution, a second coating solution (basic solution) is applied to the coating layer, and the second coating solution may be applied before a coating layer after coating exhibits drying falling rate. That is, after coating of an ink receiving layer coating solution, by introducing a basic solution while this coating layer exhibits constant rate drying, a layer is suitably prepared. This second coating solution may contain a mordant.

Herein, the “before a coating layer exhibits drying falling rate” usually refers to a process for a few minutes immediately after coating of an ink receiving layer coating solution and, during this process, “constant rate drying” phenomenon is manifested where a content of a solvent (dispersing medium) in a coating layer is decreased in proportionate to a time. A time during which this “constant rate drying” is manifested is described, for example, “Chemical Technology Handbook” (pages 707-712, published by Maruzen Co., Ltd., on October 25 in 1980).

As described above, after coating of a first coating solution, drying is performed until the coating layer exhibits drying falling rate, and this drying is performed generally at a temperature of 50 to 180° C. for 0.5 to 10 minutes (preferably 0.5 to 5 minutes). This drying time is naturally different depending on a coating amount, and the aforementioned range is usually suitable.

Examples of a method of imparting a second coating solution before a drying falling rate is exhibited include (1) a method of further coating a second coating solution on a coating layer, (2) a method of spraying by a method such as spraying, and (3) a method of immersing a support with the coating layer formed thereon in a second coating solution.

In the aforementioned method (1), as a coating method of coating a second coating solution, the known coating method such as a curtain flow coater, an extrusion die coater, an air doctor coater, a blade coater, a rod coater, a knife coater, a squeeze coater, a reverse roll coater, and a bar coater can be utilized. However, it is preferable to utilize a method in which a coater is not directly contacted with the already formed first coating layer, such as an extrusion die coater, a curtain flow coater, and a bar coater.

A coating amount of a second coating solution is generally 5 to 50 g/m², preferably 10 to 30 g/m².

After application of a second coating solution, the coating solution is generally heated at a temperature of 40 to 180° C. for 0.5 to 30 minutes, and drying and curing are performed. Among these, it is preferable to heat the coating solution to a temperature of 40 to 150° C. for 1 to 20 minutes. For example, when a crosslinking agent contained in a first coating solution is borax or boric acid, it is preferable to perform heating at a temperature of 60 to 100° C. for 5 to 20 minutes.

In addition, when the basic solution (second coating solution) is applied at the same time with coating of an ink receiving layer coating solution (first coating solution), a first coating solution and a second coating solution are coated at the same time (overlaying coating) on a support so that a first coating solution is contacted with a support and, thereafter, this is dried and cured, thereby, an ink receiving layer can be formed.

The aforementioned simultaneous coating (overlaying coating) can be performed, for example, by a coating method using an extrusion die porter, or a curtain flow coater. After simultaneous coating, a formed coating layer is dried and, in this case, drying is performed by heating a coating layer to at a temperature of 40 to 150° C. for 0.5 to 10 minutes, preferably at a temperature of 40 to 100° C. for 0.5 to 5 minutes.

When the simultaneous coating (overlaying coating) is performed, for example, with an extrusion die coater, two kinds of coating solutions which are extruded at the same time are overlaying-formed near an extrusion port of an extrusion die coater, that is, before transference onto a support and, in that state, are overlaying-coated on a support. Since a bilayered coating solution overlaid before coating already easily causes a crosslinking reaction at an interface of two solutions, near an extrusion port of an extrusion die coater, extruded two solutions are mixed, and a viscosity is easily increased, leading to a disorder of coating procedure in some cases. Therefore, when simultaneous coating is performed as described above, it is preferable to perform simultaneous trilayer coating by intervening a barrier layer solution (intermediate layer solution) between the two solutions together with a first coating solution and a second coating solution.

The barrier layer solution can be selected without any limitation. Examples include an aqueous solution containing a minor amount of a water-soluble resin, and water. The water-soluble resin is used for the purpose of a viscosity increasing agent in view of coating property, and examples include polymers such as a cellulose-based resin (e.g. hydroxypropylmethylcellulose, methylcellulose, hydroxyethylmethylcellulose etc.), polyvinylpyrrolidone, and gelatin. Herein, the barrier layer solution may contain the mordant.

Surface smoothness, luster, transparency and a coated film strength of an ink receiving layer can be improved by forming an ink receiving layer on a support and, thereafter, performing calendaring treatment by passing the layer between roll nips under heating and pressure using, for example, a super calendar, or a gloss calendar. However, since the calendaring treatment becomes a factor for reducing a void ratio in some cases (that is, since ink absorbability is reduced in some times), it is necessary to perform the calendaring treatment by setting the condition under which reduction in a void ratio is small.

A roll temperature when the calendaring treatment is performed is preferably 30 to 150° C., more preferably 40 to 100° C. In addition, a linear pressure between rolls at calendaring treatment is preferably 50 to 400 kg/cm, more preferably 100 to 200 kg/cm.

A thickness of an ink receiving layer formed in the invention must be determined in connection with a void ratio in a layer since an absorption capacity for absorption of all liquid droplets must be possessed in the case of ink jet recording. For example, when an ink amount is 8 mL/mm², and a void ratio is 60%, a film having a thickness of about 15 μm or more becomes necessary. In view of this, in the case of ink jet recording, a thickness of an ink receiving layer is preferably 10 to 50 μm.

A pore diameter of an ink receiving layer, as expressed by a median diameter, is preferably 0.005 to 0.030 μm, more preferably 0.01 to 0.025 μm. A void ratio and a pore median diameter can be measured using a mercury porosimeter “Pore Sizer 9320-PC2” manufactured by Shimadzu Corporation.

From a viewpoint of prevention of yellowing of an ink receiving layer, an ink receiving layer formed in the invention has a pH of a film surface in a range of preferably 3 to 6, more preferably 3 to 5.

As a method of adjusting a pH of a film surface of an ink receiving layer, there are a method of adding the known acid (hydrochloric acid, acetic acid, nitric acid etc.), base (NaOH, ammonia etc.), or a salt thereof (ammonium carbonate, etc.) to a coating solution in advance, and a method of performing sequential overcoating after formation of an ink receiving layer. In addition, in the invention, a pH of a film surface of an ink receiving layer can be obtained by adding dropwise 50 μl of pure water having a pH of 6.2 to 7.2 to an ink receiving layer and measuring a pH after 30 to 40 seconds according to a method of measuring a pH of a surface of a paper prescribed in J.TAPPI 49.

An ink absorption capacity (void capacity) of an ink receiving layer is preferably 18 to 40 ml/cm², more preferably 20 to 30 ml/cm².

In addition, it is preferable that an ink receiving layer is excellent in transparency and, as a criterion thereof, a haze value when an ink receiving layer is formed on a transparent film support is preferably 30% or less, more preferably 20% or less. The haze value can be measured using a hazemeter “HGM-2DP” manufactured by Suga Test Instrument Co., Ltd.

### [Support etc.]

As a support, any of a transparent support consisting of a transparent material such as a plastic, and an opaque support consisting of an opaque material such as a paper can be used. In order to utilize transparency of an ink receiving layer, it is preferably to use a transparent support or an opaque support having high luster.

As a material which can be used in the transparent support, a material which is transparent and has a nature of being resistance to radiant heat when used in OHP or back light display is preferable. Examples of such the material include polyesters such as polyethylene terephthalate (PET); polysulfone, polyphenylene oxide, polyimide, polycarbonate, and polyamide. Among these, polyesters are preferable and, particularly, polyethylene terephthalate is preferable.

A thickness of the transparent support is not particularly limited, but from a viewpoint of easy handling, 50 to 200 μm is preferable.

As the opaque support having high luster, a support having a surface on which an ink receiving layer is provided, having luster of 40% or more is preferable. The luster is a value obtained according to the method described in JIS P-8142 (paper and board 75 degree specula luster test method). Specifically, examples include the following supports.

Examples include high luster paper supports such as an art paper, a coated paper, a cast coated paper, and a baryta paper which is used in a support for silver salt photography; high luster films obtained by making plastic films such as polyesters such as polyethylene terephthalate (PET), cellulose esters such as nitrocellulose, cellulose acetate, cellulose acetate butyrate, polysulfone, polyphenylene oxide, polyimide, polycarbonate, and polyamide opaque by inclusion of a white pigment (which have been optionally substituted to surface calendaring treatment); supports of the aforementioned various paper supports, the aforementioned transparent supports or high luster films containing a white pigment having a surface on which a covering layer of polyolefin containing or not containing a white pigment is provided.

Preferable examples also include a white pigment-containing foamed polyester film (e.g. foamed PET containing a polyolefin fine particle, in which a void is formed by stretching). Further, a resin coated paper used in a photographic paper for silver salt photography is also preferable.

A thickness of the opaque support is not particularly limited, but from a viewpoint of easy handling, 50 to 300 μm is preferable.

In addition, in order to improve wetting property and adherability, it is preferable to use a surface of the support which has been subjected to corona discharge treatment, glow discharge treatment, flame treatment, or ultraviolet irradiation treatment.

Then, a raw paper used in a paper support such as a resin-coated paper will be described.

The raw paper is made using a timber pulp as a main raw material and, if necessary, in addition to the timber pulp, using a synthetic pulp such as polypropylene, or a synthetic fiber such as nylon and polyester. As the timber pulp, any of LBKP, LBSP, NBKP, NBSP, LDP, NDP, LUKP, and NUKP can be used, and it is preferable that a large amount of LBKP, NBSP, LBSP, NDP or LDP having a large amount of short fibers is used. In this respect, a ratio of LBSP and/or LDP is preferably 10% by mass or 70% by mass.

As the pulp, a chemical pulp (sulfate pulp or sulfite pulp) having a little amount of impurities is suitably used, and a pulp, which was bleaching-treated to improve whiteness, is also useful.

A sizing agent such as higher fatty acid and alkylketene dimer, a white pigment such as calcium carbonate, talc and titanium oxide, a paper strengthening agent such as starch, polyacrylamide, and polyvinyl alcohol, a fluorescent brightening agent, a water retaining agent such as polyethylene glycols, a dispersant, and a softening agent such as quaternary ammonium can be appropriately added to a raw paper.

A water filtration degree of a pulp used in paper making is preferably 200 to 500 ml according to the provision of CSF, and a fiber length after beating is preferably 30 to 70% as expressed by a sum of 24 mesh remaining % by mass and 42 mesh remaining % by mass prescribed in JIS P-8207. It is preferable that a 4 mesh remaining is 20% by mass or less.

A basis weight of a raw paper is preferably 30 to 250 g, particularly preferably 50 to 200 g. A thickness of a raw paper is preferably 40 to 250 μm. A raw paper may be subjected to calendaring treatment at a stage of paper making or after paper making to impart high smoothness. A raw paper density is generally 0.7 to 1.2 g/m² (JIS P-8118). Further, a raw paper stiffness is preferably 20 to 200 g under the condition prescribed in JIS P-8143.

A surface sizing agent may be coated on a raw paper surface and, as a surface sizing agent, the same sizing agent as a size which can be added to a raw paper can be used.

A pH of a raw paper, when measured by a hot water extraction method prescribed in JIS P-8113, is preferably 5 to 9.

Polyethylene covering a surface and a back of a raw paper is mainly low-density polyethylene (LDPE) and/or high-density polyethylene (HDPE), and other LLDPE and polypropylene can be partially used.

Particularly, as a polyethylene layer on a side on which an ink receiving layer is formed, as widely performed in a photographic paper for photography, an polyethylene layer having opaqueness, whiteness and a hue improved by adding rutile or anatase-type titanium oxide, a fluorescent brightening agent and ultramarine to polyethylene is preferable. Herein, a content of titanium oxide is preferably approximately 3 to 20% by mass, more preferably 4 to 13% by mass based on polyethylene. A thickness of a polyethylene layer is not particularly limited, but 10 to 50 μm is suitable in both of surface and back layers. Further, in order to impart adherability with an ink receiving layer, an undercoating layer may be provided on a polyethylene layer. As the undercoating layer, aqueous polyester, gelatin, and PVA are preferable. A thickness of the undercoating layer is preferably 0.01 to 5 μm.

A polyethylene covered paper can be used as a luster paper, or a paper on which a mat surface or a silk-like surface like that obtained in a conventional photographic paper by performing so-called embossing treatment when polyethylene is melt-extruded on a raw paper surface to perform coating, can be also used.

A back coating layer may be provided on a support, and examples of a component, which can be added to this back coating layer, include a white pigment, an aqueous binder, and other component.

Examples of the white pigment contained in a back coating layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, alumina, lithopone, zeolite, hydrated halloysite, magnesium carbonate, and magnesium hydroxide, and organic pigments such as styrene-based plastic pigment, acryl-based plastic pigment, polyethylene, microcapsule, urea resin, and melamine resin.

Examples of the aqueous binder used in a back coating layer include water-soluble polymers such as styrene/maleic acid salt copolymer, styrene/acrylate salt copolymer, polyvinyl alcohol, silanol-modified polyvinyl alcohol, starch, cationized starch, casein, gelatin, carboxymethylcellulose, hydroxyethylcellulose, and polyvinylpyrrolidone, and water-dispersible polymers such as styrene butadiene latex, and acryl emulsion.

Examples of other component contained in a back coating layer include an antifoaming agent, a foam-suppressor, a dye, a fluorescent brightening agent, an antiseptic, and waterproof agent.

As described above, according to the invention, an ink jet recording medium which improves ink absorbability, and is excellent in the state of a coated surface can be obtained. Moreover, when an ink receiving layer contains vapor phase method silica and has a three-dimensional network structure having a void ratio of 50 to 80%, better ink absorbability is more improved, a high concentration image can be formed at high resolution at the same time, blurring over time under the high temperature and high humidity condition is suppressed, and a formed image exhibits high light resistance and water resistance, thus, the excellent ink receiving performance can be maintained at the same time.

In addition, an ink jet recording medium obtained by the invention can exhibit a luster of 30% or more at 60° C. The luster can be measured with a digital varied-angle luster-meter (UGV-50DP, manufactured by Suga Test Instrument Co., Ltd.).

### [Ink Jet Recording Method]

An ink jet recording method of the invention comprises forming an image using the aforementioned set for ink jet recording.

A recorded matter on which an image is formed by an ink jet recording method of the invention using the set for ink jet recording of the invention (the ink jet recording medium and the ink) becomes a recorded matter having significantly better ozone resistance. A recorded matter refers to an ink jet recording medium on which an image or a letter is recorded.

In an ink jet recording method of the invention, a recording method of ink jet is not particularly limited, the known method, such as a charge controlling method of discharging an ink utilizing an electrostatic attracting force, a drop on demand method of utilizing a vibration pressure of a piezo element (pressure pulse method), an acoustic ink jet method of converting an electric signal into an acoustic beam, irradiating an ink with the beam, and discharging an ink utilizing an irradiation pressure, and a thermal ink jet method of heating an ink to form a bubble, and utilizing a generated pressure is used. An ink jet recording method includes a method of ejecting a number of inks of a small volume, having a low concentration called photo ink, a method of using a plurality of inks having substantially the same hue and different concentrations to improve image quality, and a method of using a colorless transparent ink.

### EXAMPLES

The invention will be explained specifically below by way of Examples, however the invention is limited by these Examples. In the Examples, as one example of an ink jet recording medium, an ink jet recording sheet is prepared, and “part” and “%” in Examples represent a mass standard unless otherwise specified.

[Preparation of Ink Jet Recording Medium 1]

### (Preparation of Support)

50 parts of LBKB consisting of acacia and 50 parts of LBKP consisting of aspen were beaten to a Canadian freeness of 300 ml using a disk refiner, respectively, to prepare a pulp slurry.

Then, 1.3% of cationic starch (CAT0304L manufactured by Japan NSC), 0.15% of anionic polyacrylamide (Polyacrone ST-13 manufactured by Seiko PMC Corporation), 0.29% of alkylketene dimer (Size Pine K manufactured by Arakawa Chemical Industries, Ltd.), 0.29% of epoxylated behenic amide, and 0.32% of polyamide polyamine epichlorohydrin (Arafix100 manufactured by Arakawa Chemical Industries, Ltd.) were added to the pulp slurry obtained described above as expressed by an amount per pulp, and 0.12% of an antifoaming agent was added.

The pulp slurry prepared as described above was made into a paper with a wire paper machine, the paper was dried by setting a tensile force of a drier canvas at 1.6 kg/cm in a step of drying by pushing a felt side of a web against a drum drier cylinder via a drier canvas, 1 g/m² of polyvinyl alcohol (KL-118, manufactured by Kuraray Co., Ltd.) on both sides of a raw paper with a size press, and dried, and subjected to calendaring treatment. A paper was made at a basis weight of a raw paper of 166 g/m² to obtain a raw paper (base paper) having a thickness of 160 μm.

A wire side (back surface) of the resulting base paper was subjected to corona discharge treatment, and high-density polyethylene was coated at a thickness of 25 μm using a melt extruder to form a thermoplastic resin layer having a mat side (hereinafter, this thermoplastic resin layer side is referred to as “back surface”). A thermoplastic resin layer on this back surface side was further subjected to corona discharge treatment and, thereafter, as an antistatic agent, a dispersion obtained by dispersing aluminum oxide (“Alumina Sol 100” manufactured by Nissan Chemical Industries, Ltd.) and silicon dioxide (“Snowtex O” manufactured by Nissan Chemical Industries, Ltd.) at a mass ratio of 1:2 in water was coated at a dry mass of 0.2 g/m². Subsequently, a surface was subjected to corona treatment, and polyethylene of a density of 0.93 g/m² having 10% by mass of titanium oxide was coated to 24 g/m² using a melt extruder.

### <Preparation of Silica Dispersion>

(1) A vapor phase method silica fine particle, (2) ion-exchanged water, (3) “Sharol DC-902P”, and (4) “ZA-30” having the following formulation were mixed, and dispersed using a beads mill (e.g. KD-P, manufactured by Genmal Enterprise), and the dispersion was heated to 45° C., and retained for 20 hours to obtain a silica dispersion.

| | |
|---|---|
| (1) Vapor phase method silica fine particle | 15.0 parts |
| AEROSIL300 SF75, manufactured by Nippon | |
| Aerosil Co., Ltd. | |
| (2) Ion-exchanged water | 82.9 parts |
| (3) “Sharol DC-902P” (51.5% aqueous solution) | 1.31 parts |
| Dispersant, manufactured by Dai-ichi Kogyo | |
| Seiyaku Co., Ltd.) | |
| (4) “ZA-30” (zirconyl acetate) manufactured by | 0.8 parts |
| Daiich Kigenso Kagaku Kogyo Co., ltd. | |

### <Preparation of Ink Receiving Layer Coating Solution a (First Solution)>

The following substances were added to 59.5 parts of the silica dispersion at 30° C. to prepare an ink receiving layer coating solution A (first solution).

### <Composition of Ink Receiving Layer Coating Solution A>

| | |
|---|---|
| The silica dispersion | 59.5 parts |
| (5) Diethylene glycol monobutyl ether | 0.15 parts |
| (Butisenol 20P, manufactured by Kyowa Hakko | |
| Chemicak Co., Ltd.) | |
| (6) Boric acid (crosslinking agent) 0.3 parts | |
| (7) Dimethylamine•epichlorohydrin.polyalkylenepolyamine | 0.2 parts |
| polycondensate (SC-505 (manufactured by Hymo)) | |
| (50% aqueous solution) | |
| (8) Polyvinyl alcohol (water-soluble resin) dissolving | 26.0 parts |
| solution (Composition of dissolving solution) | |
| “PVA235”, saponification degree 88%, polymerization | 1.8 parts |
| degree 3500, manufactured by Kuraray Co., Ltd. | |
| Emulgen 109P | 0.06 parts |
| (Polyoxyethylene lauryl ether (surfactant) manufactured | |
| by Kao Corporation) | |
| Ion-exchanged water | 23.8 parts |
| (9) “Superflex 600” (manufactured by | 1.1 parts |
| Dai-ichi Kogyo Seiyaku Co., Ltd.) | |
| (10) Synthetic alcohol AP-7 (manufactured by Japan | 2.3 parts |
| Alcohol) | |
| (11) Ion-exchanged water | 10.45 parts |

### (Preparation of Ink Jet Recording Medium 1)

A surface of the support was subjected to corona discharge treatment, a 5-fold diluted polyaluminum chloride aqueous solution (polyaluminum chloride is Arfine 83 (manufactured by Taimei Chemicals Co., ltd.)) was in-line mixed into a first solution which had been flown at a coating amount of 173 ml/m², at a rate of 10.8 ml/m², and coating was performed. Thereafter, this was dried at 80° C. (air speed 3-8 m/sec) with a hot air drier until a solid content concentration of a coating layer became 20%. This coating layer exhibited constant rate drying during this. And, before drying falling rate was exhibited, the support was immersed in a basic solution B (second solution) having the following composition for 2 seconds to attach 13 g/m² of it on the coating layer, and this was further dried at 80° C. for 10 minutes (curing step). Thereby, an ink jet recording medium 1 on which an ink receiving layer having a dry film thickness of 35 μm was provided, was prepared.

### <Composition of Basic Solution B>

| | |
|---|---|
| (1) Boric acid | 0.65 parts |
| (2) Zirconium ammonium carbonate | 0.18 parts |
| Zircosole AC-7 (28% aqueous solution), manufactured by | |
| Daiich Kigenso Kagaku Kogyo Co., ltd.) | |
| (3) Ammonium carbonate (Extra pure: manufactured | 5.0 parts |
| by Kanto Kagaku) | |
| (4) Ion-exchanged water | 63.17 parts |
| (5) Polyoxyethylene lauryl ether (surfactant) | 30.0 parts |
| Emulgen 109P (2% aqueous solution), manufactured | |
| by Kao Corporation) | |

[Preparation of Ink Jet Recording Medium 2]

According to the same manner as that of the ink jet recording medium 1 except that 1 part equivalent of ion-exchanged water of an ink receiving layer coating solution A was substituted with a sulfoxide compound 1 (exemplified compound A-41) in the ink jet recording medium 1, an ink jet recording medium 2 was prepared.

[Preparation of Ink Jet Recording Medium 3]

According to the same manner as that of the ink jet recording medium 1 except that, in “preparation of silica dispersion”, each amount of “(3) Sharol DC-902P” and “(2) ion-exchanged water” was changed to 0.87 parts and 83.3 parts, further in “preparation of ink receiving layer coating solution A”, an amount of a silica dispersion was changed to 58.7 parts, 1 part of the sulfoxide compound 1 (exemplified compound A-41) was added, (9) Superflex 600 was not added, and an amount of (11) ion-exchanged water was changed to 11.35 parts and, further in “composition of basic aqueous solution B”, (2) zirconium ammonium carbonate was omitted, and an amount of ion-exchanged water was changed to 64.35 parts in the ink jet recording medium 1, an ink jet recording medium 3 was prepared.

[Preparation of Yellow Ink Solution 1]

Respective components having the following compositions were stirred and dissolved for 1 hour while they were heated at 30 to 40° C. Thereafter, the solution was filtered under reduced pressure with a microfilter having an average pore diameter of 0.2 μm, and water was added to 500 parts to prepare a yellow ink solution 1.

### <Composition of Yellow Ink Solution 1>

| | | |
|---|---|---|
| Dye Y1 | 25 | parts |
| Glycerin | 59 | parts |
| Triethylene glycol | 48 | parts |
| Triethylene glycol monobutyl ether | 51 | parts |
| Urea | 10 | parts |
| Triethanol amine | 0.5 | parts |
| Proxel XLII (anti-mold agent, manufactured by Avecia Limited) | 0.5 | parts |
| Orfin E1010 (surfactant, manufactured by Nisshin Chemicals Co., Ltd.) | 5 | parts |

Dye Y1

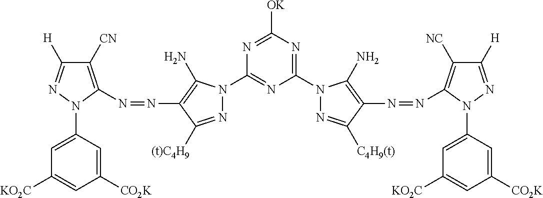

[Preparation of Yellow Ink Solution 2]

According to the same manner except that the dye Y1 was changed to a mixture of 2.1 parts/dye 2, 2.1 parts/dye 3 and 2.1 parts/dye 4 in a process for preparing the yellow ink solution 1, a yellow ink solution 2 was prepared.

Dye 2: C.I. Direct Yellow 132

Dye 3: C.I. Direct Yellow 86

Dye 4: C.I. Direct Yellow 58

[Preparation of Yellow Ink Solutions 3-9]

According to the same manner except that the dye Y1 was changed to each of dyes described in Table 1 in a process for preparing the yellow ink solution 1, yellow ink solutions 3-9 were prepared.

### Comparative Example 1

Using an ink jet printer (“PM A-700”, manufactured by Seiko Epson Corporation) equipped with a yellow ink solution 1 and an ink jet recording medium 1 described in Table 1, a reflection concentration at photographic printing was adjusted to 1.0 to prepare a recorded matter 1.

### Examples 1 to 2, 3 to 9 and Comparative Examples 2 to 4

According to the same manner as that of Comparative Example 1 except that the yellow ink solution 1 and the ink jet recording medium 1 were changed to each of yellow ink solutions and each of ink jet recording media described in Table 1 in Comparative Example 1, recorded matters 2 to 13 were made, respectively.

[Assessment]

### <Ozone Resistance>

Recorded matters obtained above were stored for 168 hours under the atmosphere of 23° C., 60% RH, dark chamber, and an ozone concentration of 5 ppm, and ozone resistance was assessed by a residual ratio of a yellow concentration after storage relative to before storage based on the following assessment criteria.

### (Yellow Concentration Residual Ratio)

A: 90% or more
B: 85% or more and less than 90%
C: 80% or more and less than 85%
D: 75% or more and less than 80%
E: 70% or more and less than 75%
F: Less than 70%

TABLE 1

| | | | Yellow | | |
|---|---|---|---|---|---|
| | | Recording | ink | | Residual |
| | Sample | medium | solution | Dye used | ratio |
| Comparative | Recorded | 1 | 1 | Dye 1 | D |
| Example 1 | matter 1 | | | | |
| Example 1 | Recorded | 2 | 1 | Dye 1 | B |
| | matter 2 | | | | |
| Example 2 | Recorded | 3 | 1 | Dye 1 | A |
| | matter 3 | | | | |
| Comparative | Recorded | 1 | 2 | Dyes 2, 3, 4 | F |
| Example 2 | matter 4 | | | | |
| Comparative | Recorded | 2 | 2 | Dyes 2, 3, 4 | E |
| Example 3 | matter 5 | | | | |
| Comparative | Recorded | 3 | 2 | Dyes 2, 3, 4 | E |
| Example 4 | matter 6 | | | | |
| Example 3 | Recorded | 3 | 3 | DYE-8 | A |
| | matter 7 | | | (Li salt) | |
| Example 4 | Recorded | 3 | 4 | DYE-9 | A |
| | matter 8 | | | (Li salt) | |
| Example 5 | Recorded | 3 | 5 | DYE-10 | A |
| | matter 9 | | | (K salt) | |
| Example 6 | Recorded | 3 | 6 | DYE-12 | A |
| | matter 10 | | | (K salt) | |
| Example 7 | Recorded | 3 | 7 | DYE-13 | A |
| | matter 11 | | | (K salt) | |
| Example 8 | Recorded | 3 | 8 | DYE-14 | A |
| | matter 12 | | | (K salt) | |
| Example 9 | Recorded | 3 | 9 | DYE-15 | A |
| | matter 13 | | | (Li salt) | |

As apparent from Table 1, it was seen that a yellow concentration residual ratio of Examples 1 and 2 using both of the yellow ink solution 1 and the recorded medium in the invention is maintained at 85% or more, and ozone resistance is better. On the other hand, in all of Comparative Examples, a yellow concentration residual ratio is less than 80%, and ozone resistance is inferior.

[Preparation of Magenta Ink Solution 1]

According to the same manner except that the composition of the yellow ink solution 1 was changed to the following composition of a magenta ink solution 1 in a process for preparing the yellow ink solution 1, a magenta ink solution 1 was prepared.

### <Composition of Magenta Ink Solution 1>

| | | |
|---|---|---|
| Dye-M1 | 17.5 | parts |
| Glycerin | 51 | parts |
| Triethylene glycol | 9.5 | parts |
| Triethylene glycol monobutyl ether | 52 | parts |
| 1,2-Hexanediol | 6 | parts |
| 2-Pyrrolidone | 5.5 | parts |
| Urea | 12 | parts |
| Triethanolamine | 1 | part |
| Procel XLII (anti-mold agent, manufactured by Avecia | 0.5 | parts |
| Limited) | | |
| Additive 1 | 8.8 | parts |

Additive 1 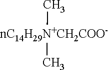
Dye-M1

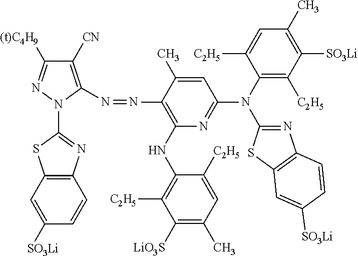

[Preparation of Magenta Ink Solutions 2 to 5]

According to the same manner except that the dye-M1 was changed to each of a dye-M2 to a dye-M5 in a process for preparing the magenta ink solution 1, magenta ink solutions 2 to 5 were prepared.

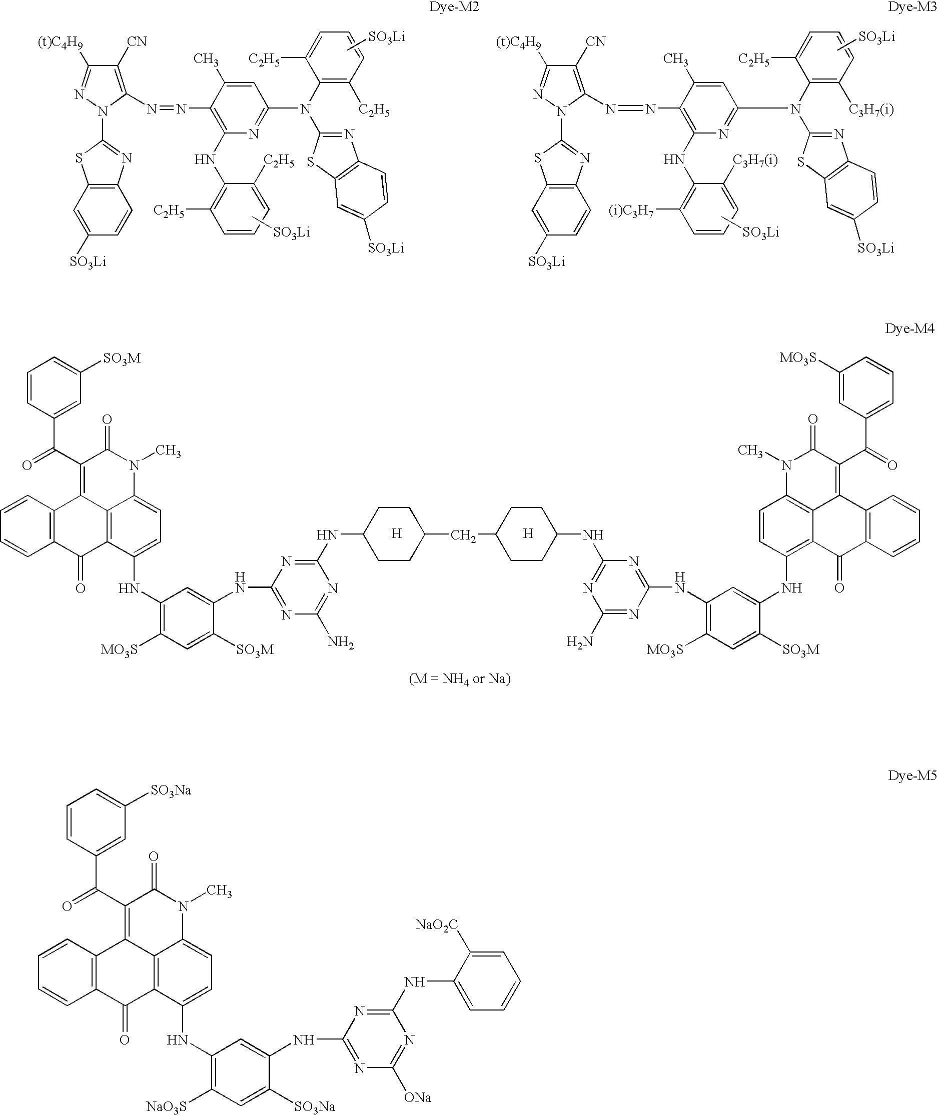

[Preparation of Cyan Ink Solution 1]

According to the same manner except that the composition of the yellow ink solution 1 was changed to the following composition of a cyan ink solution 1, and water was added to a total amount of 100 parts instead of 500 parts in a process for preparing the yellow ink solution 1, a cyan ink solution 1 was prepared.

### <Composition of Cyan Ink Solution 1>

| | | |
|---|---|---|
| Dye-C1 | 4.7 | parts |
| Urea | 2.4 | parts |
| Triethylene glycol | 10.7 | parts |
| Triethylene glycol monobutyl ether | 9.1 | parts |
| 1,2-Hexanediol | 2.4 | parts |
| 2-Pyrrolidone | 3.5 | parts |
| Glycerin | 11.8 | parts |
| Triethanolamine | 0.5 | parts |
| Proxel HLII (anti-mold agent, manufactured by Avecia | 1.0 | part |
| Limited) | | |
| Orfin E1010 (surfactant, manufactured by Nisshin | 1.0 | part |
| Chemicals Co., Ltd.) | | |

Dye-C1

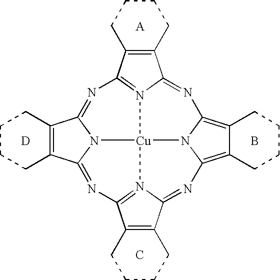

One of rings A to D is

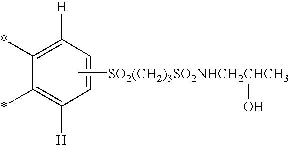

Remaining three are

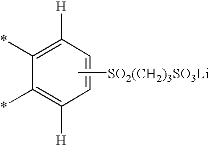

* is a binding position of phthalocyanine ring.

[Preparation of Cyan Ink Solutions 2 to 4]

According to the same manner except that dye-C1 was changed to each of the following dyes-C2, C3 and C4 in a process for preparing the cyan ink solution 1, cyan ink solutions 2 to 4 were prepared.

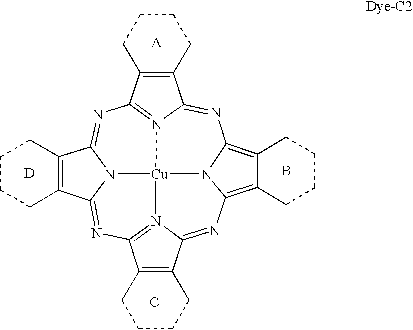

Two of rings A to D are

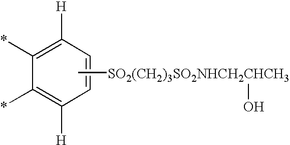

### Remaining two are

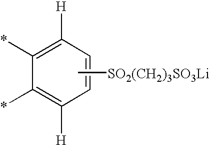

* is a binding position of phthalocyanine ring.

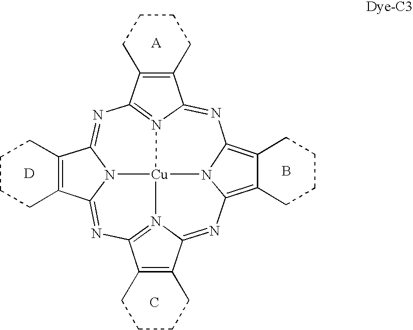

One of rings A to D is

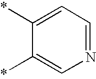

Remaining three are

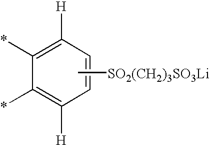

* is a binding position of phthalocyanine ring.

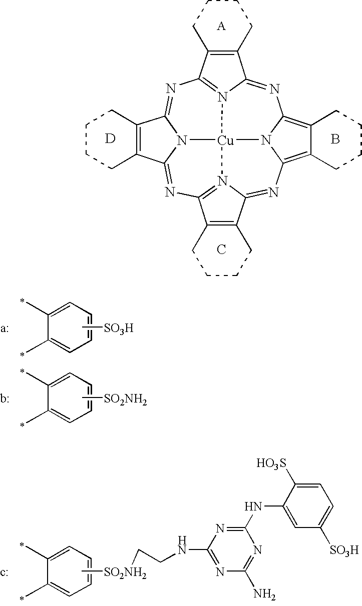

* is a binding position of phthalocyanine ring.

A mixture of the following compounds I to III
I. c=0, a+b=4
II. c=1, a+b=3
III. c=2, a+b=2

[Preparation of Cyan Ink Solution 5]

According to the same manner except that a dye-C1 was changed to C. I. Direct Blue-199 in a process for preparing the cyan ink solution 1, a cyan ink solution 5 was prepared.

[Preparation of Black Ink Solution 1]

According to the same manner except that the composition of the yellow ink solution 1 was changed to the following composition of a black ink solution 1 in a process for preparing the yellow ink solution 1, a black ink solution 1 was prepared.

### <Composition of Black Ink Solution 1>

| | | |
|---|---|---|
| Dye-Bk1 | 30 | parts |
| Dye-Bk2 | 7.5 | parts |
| Urea | 45.0 | parts |
| Triethylene glycol | 11.5 | parts |
| Triethylene glycol monobutyl ether | 40.0 | parts |
| 1,2-Hexanediol | 17.0 | parts |
| 2-Pyrrolidone | 17.0 | parts |
| Glycerin | 50.0 | parts |
| Triethanolamine | 2.0 | parts |
| Proxel XLII (anti-mold agent, manufactured by Avecia Limited) | 2.0 | parts |
| Orfin E1010 (surfactant, manufactured by Nisshin Chemicals Co., Ltd.) | 5.0 | parts |

Dye-Bk1 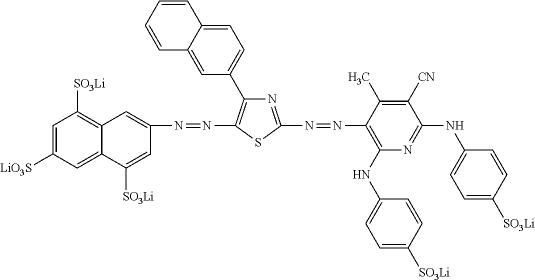
Dye-Bk2

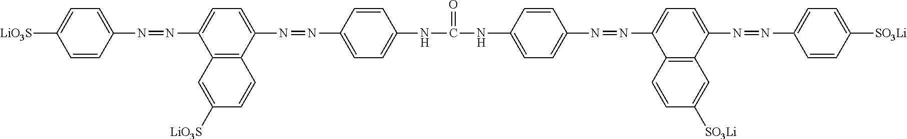

[Preparation of Black Ink Solutions 2 to 4]

According to the same manner except that the Dye-Bk1 was changed to the each following dye-Bk3 to dye-Bk5 in a process for preparing the black ink solution 1, black ink solutions 2 to 4 were prepared.

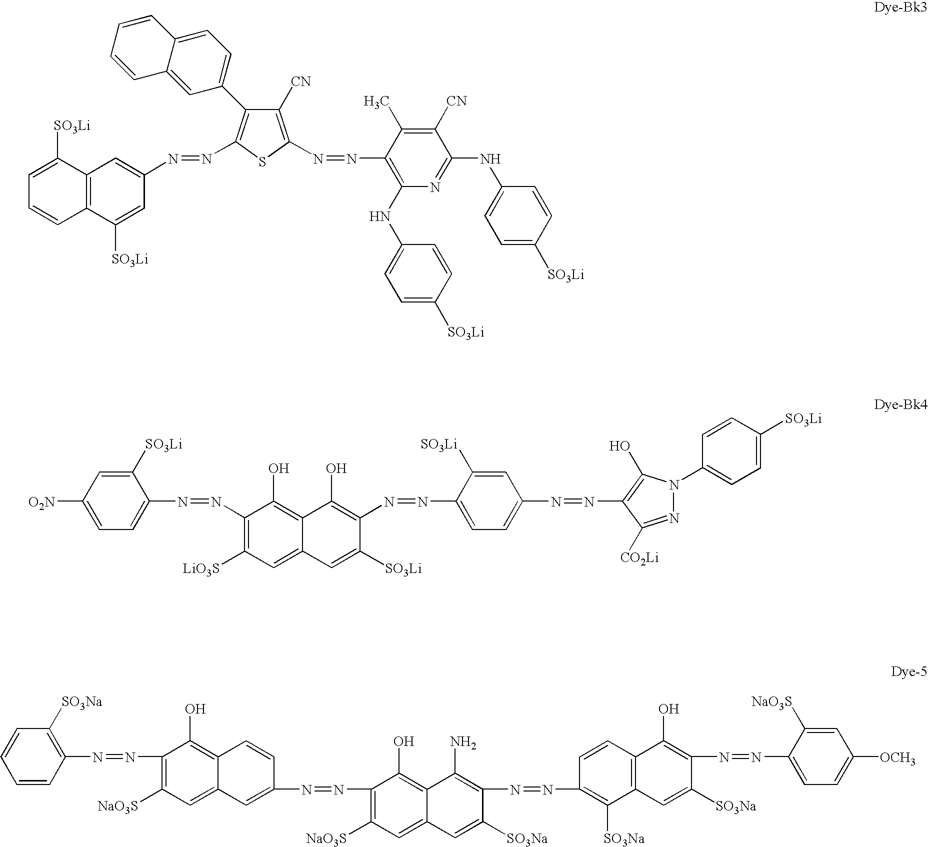

[Preparation of Black Ink Solution 5]

According to the same manner except that the dye-Bk1 was changed to the following dye-Bk6, and the dye Bk-2 was changed to Bk-7 in a process for preparing the black ink solution 1, a black ink solution 5 was prepared.

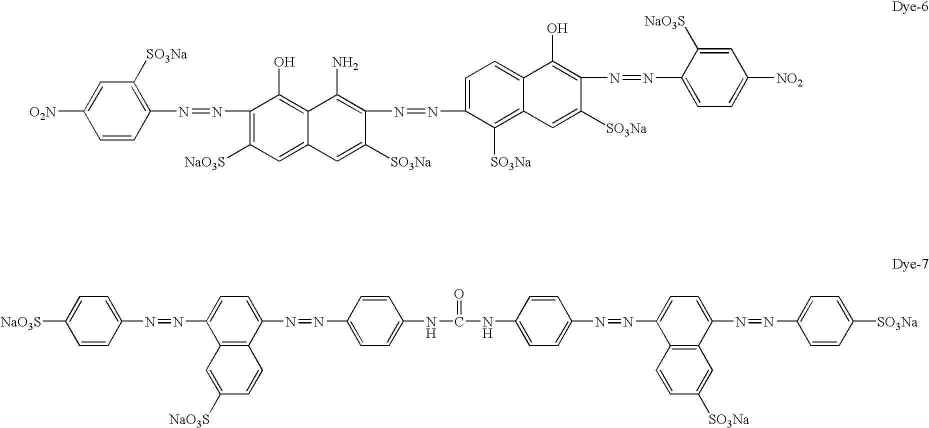

### Comparative Examples 5 to 6, Examples 10 to 14

Using a set for ink jet recording described in Table 2 consisting of a combination of each ink solution of yellow ink solutions 1 to 2, magenta ink solutions 1 to 5, cyan ink solutions 1 to 5, and black ink solutions 1 to 5 prepared above, and each of recording media 1 and 3 prepared above, as in Comparative Example 1, full color ink jet recorded matters were prepared, and assessed similarly. Results are shown below.

TABLE 2

| | | | | | | | Yellow |
|---|---|---|---|---|---|---|---|
| | | | Yellow | Magenta | Cyan | Black | concentration |
| | | Recording | ink | ink | ink | ink | residual |
| | Sample | medium | solution | solution | solution | solution | ratio |
| Comparative | Recorded | 1 | 1 | 1 | 1 | 1 | D |
| Example 5 | matter 14 | | | | | | |
| Example 10 | Recorded | 3 | 1 | 1 | 1 | 1 | A |
| | matter 15 | | | | | | |
| Comparative | Recorded | 3 | 2 | 1 | 1 | 1 | F |
| Example 6 | matter 16 | | | | | | |
| Example 11 | Recorded | 3 | 1 | 2 | 2 | 2 | A |
| | matter 17 | | | | | | |
| Example 12 | Recorded | 3 | 1 | 3 | 3 | 3 | A |
| | matter 18 | | | | | | |
| Example 13 | Recorded | 3 | 1 | 4 | 4 | 4 | A |
| | matter 19 | | | | | | |
| Example 14 | Recorded | 3 | 1 | 5 | 5 | 5 | A |
| | matter 20 | | | | | | |

As apparent from Table 2, also in a full color image which was printed by combining the magenta, cyan and black ink solutions, and a yellow ink solution in the invention, ozone resistance of a yellow printed part was not reduced, and was good.

All publications, patent applications, and technical standards mentioned in this specification are herein incorporated by reference to the same extent as if each individual publication, patent application, or technical standard was specifically and individually indicated to be incorporated by reference.

### INDUSTRIAL APPLICABILITY

The invention can be applied to a set for forming an ink jet image and an ink jet recording method which are suitable for forming an image by an ink jet method, and form an image excellent in ozone resistance.

1. A set for ink jet recording comprising an ink jet recording medium containing a water-soluble aluminum compound and a sulfoxide compound in an ink receiving layer on a support, and an ink containing a coloring matter represented by the following formula (I): 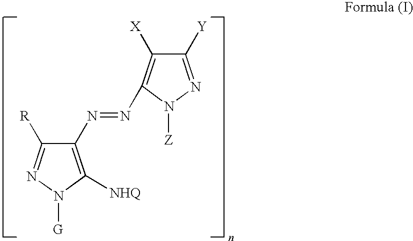
wherein G represents a heterocyclic group; n represents an integer of 1 to 3; when n is 1, R, X, Y, Z, Q and G each represent a monovalent group; when n is 2, R, X, Y, Z, Q and G each represent a monovalent or divalent substituent, and at least one of them represents a divalent substituent; and, when n is 3, R, X, Y, Z, Q and G each represent a monovalent, divalent or trivalent substituent, and at least two of them represent a divalent substituent, or at least one of them represents a trivalent substituent.

2. The set for ink jet recording of claim 1, wherein n of the coloring matter represented by the formula (I) is 2.

3. The set for ink jet recording of claim 1, wherein X of a coloring matter represented by the formula (I) is a cyano group, or an alkylsulfonyl group having a carbon number of 1 to 12.

4. The set for ink jet recording of claim 1, wherein the coloring matter represented by the formula (I) is a coloring matter represented by the following formula (I): 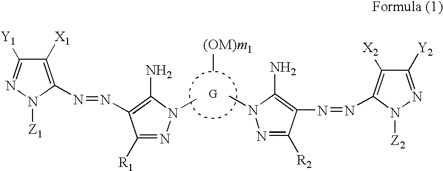
wherein R₁, R₂, X₁, X₂, Y¹, Y₂, Zᵢ and Z₂ each represent a monovalent group; G represents an atom group constituting a 5- to 8-membered nitrogen-containing heterocycle; M represents a hydrogen atom or a cation; and m₁ represents an integer of 0 to 3.

5. The set for ink jet recording of claim 4, wherein the coloring matter represented by the formula (1) is a coloring matter represented by the following formula (1-1): 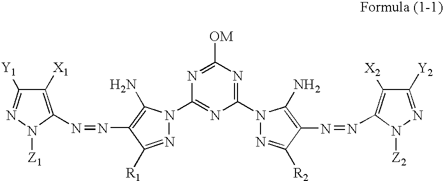
wherein R₁, R₂, Y₁ and Y₂ represent a monovalent group; Xᵢ and X₂ each independently represent an electron-withdrawing group having a Hammett σp value of 0.20 or more; Z₁ and Z₂ each independently represent a hydrogen atom, a substituted or unsubstituted alkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group; and M represents a hydrogen atom or a cation.

6. The set for ink jet recording of claim 1, wherein the water-soluble aluminum compound is polyaluminum chloride.

7. The set for ink jet recording of claim 1, wherein the content of the water-soluble aluminum compound is from 0.1 to 20 g/m².

8. The set for ink jet recording of claim 1, wherein the sulfoxide compound has one or more structures represented by the following formula (S1) in a molecule:

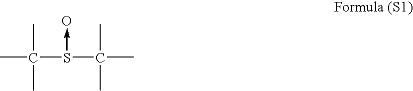

9. The set for ink jet recording of claim 1, wherein the sulfoxide compound has one or more structures represented by the formula (S2) in a molecule: 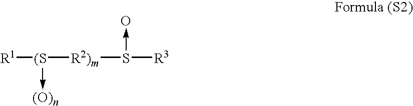
wherein, in the formula (S2), R¹ and R³ each independently represent a substituted or unsubstituted alkyl group, a substituted or unsubstituted aryl group, a substituted or unsubstituted heterocyclic group, or a polymer residue consisting thereof; R¹ and R³ may be the same or different, and may be connected to each other to form a ring; R² represents a substituted or unsubstituted di- to hexavalent connecting group; R¹ and R², or R² and R³ may be connected to each other to form a ring, m represents an integer of 0 or 1 or more; and n represents 0 or 1.

10. The set for ink jet recording of claim 1, wherein the content of the sulfoxide compound is from 0.01 to 20 g/m².

11. The set for ink jet recording of claim 1, wherein the ink receiving layer further contains a water-soluble resin.

12. The set for ink jet recording of claim 1, wherein the ink receiving layer further contains fine particles selected from organic fine particles, silica fine particles, alumina fine particles, and pseudoboehmite aluminum hydroxide fine particles.

13. The set for ink jet recording of claim 1, wherein the ink receiving layer further contains a cationic polymer.

14. The set for ink jet recording of claim 1, wherein the ink receiving layer further contains a latex having a volume average particle diameter of 0.1 μm or less.

15. The set for ink jet recording of claim 1, wherein the ink receiving layer further contains a mordant.

16. The set for ink jet recording of claim 1, wherein the ink receiving layer further contains an organic solvent having a boiling point of 230° C. or higher.

17. The set for ink jet recording of claim 1, wherein the ink receiving layer has a pore diameter of from 0.005 to 0.30 μm as expressed by a median diameter.

18. The set for ink jet recording of claim 1, wherein the ink receiving layer has a pore diameter of from 18 to 40 ml/cm².

19. An ink jet recording method, comprising forming an image using the set for ink jet recording as defined in claim 1.
